(19) United States
(12) Patent Application Publication
(10) Pub. No.: US 2014/0013724 A1
(43) Pub. Date: Jan. 16, 2014

(54) ELECTROMAGNETIC THRUSTER

(71) Applicant: Guido P. Fetta, Doylestown, PA (US)

(72) Inventor: Guido P. Fetta, Doylestown, PA (US)

(73) Assignee: Cannae LLC, Doylestown, PA (US)

(21) Appl. No.: 14/001,232

(22) PCT Filed: Mar. 22, 2012
(86) PCT No.: PCT/US12/30100

§ 371 Date: Sep. 27, 2013

Related U.S. Application Data
(60) Provisional application No. 61/457,438, filed on Mar. 25, 2011.

(51) Int. Cl. F02K 9/00

(52) U.S. Cl. CPC F02K 9/00
USPC 60/203.1; 60/204

(57) ABSTRACT

Systems and methods for electromagnetic thrusting are disclosed. An electromagnetic thrusting system includes an axially-asymmetric resonant cavity including a conductive inner surface, the resonant cavity adapted to support a standing electromagnetic (EM) wave therein, the standing EM wave having an oscillating electric field vector defining a z-axis of the resonant cavity. The resonating cavity lacks 2nd-axis axial symmetry. The standing EM wave induces a net unidirectional force on the resonant cavity.

The present invention concerns propulsion systems and methods. In particular, these systems and methods use interactions between resonating electromagnetic waves and resonating cavities to achieve thrust.

### FIELD OF THE INVENTION

The present invention concerns propulsion systems and methods. In particular, these systems and methods use interactions between resonating electromagnetic waves and resonating cavities to achieve thrust.

### BACKGROUND OF THE INVENTION

One issue facing space exploration programs is the development of an efficient, low-mass propulsion system. The necessity of including reaction mass, as well as the mass on the engine itself, in traditional propulsion systems imposes practical limits to the range and lifetime of these propulsion systems. A number of approaches to this problem have been explored. One example of such a system is the Emdrive system.

The Emdrive system is a space propulsion system that uses the differences in radiation pressure exerted on two ends of a resonating cavity to generate thrust and, thus avoids the issue of reaction mass. The Emdrive is a resonating bottle full of microwaves. In the case of the prototype Emdrive, the closed resonating cavity is wider at one end than the other. Mathematical analysis by the designers of the Emdrive indicates that the group velocity of the resonating microwave may be higher at the wide end than the narrow end and that consequently, there may be a net excess force exerted on the wide end. Furthermore, the net excess force exerted is proportional to the Q of the Emdrive resonator, or the effectiveness that the cavity shows as a resonator. Thus, the Emdrive appears capable of developing thrust without the use of reaction mass.

Exemplary embodiments of the present invention may also be used to generate thrust without the use of reaction mass or ejected EM energy to create thrust, but does so in a manner distinct from the method of the Emdrive. In addition to space-based applications, embodiments of the present invention may also be used to generate thrust in Earth-based and other applications.

### SUMMARY OF THE INVENTION

An exemplary embodiment of the present invention is an electromagnetic thruster, including: an axially asymmetric resonant cavity including a conductive inner surface; and a frequency generator electrically coupled to the resonant cavity. The resonant cavity is adapted to support a standing electromagnetic (EM) wave with an oscillating electric-field vector pointing in a direction substantially normal to a transverse plane of the cavity. The frequency generator is used to generate the standing EM wave in the resonant cavity. EM interactions between the standing EM wave and the conductive inner surface of the axially-asymmetric resonant cavity create a net-unbalanced force in the direction substantially normal to the transverse plane.

Another exemplary embodiment of the present invention is an electromagnetic thruster, including: an axially asymmetric resonant cavity including a conductive inner surface; and a frequency generator electrically coupled to the resonant cavity. The resonant cavity is adapted to support a standing electromagnetic (EM) wave with an oscillating electric field vector pointing in a direction substantially normal to a transverse plane of the cavity. The frequency generator is used to generate the standing EM wave in the resonant cavity. EM interactions between the standing EM wave and the conductive inner surface of the axially-asymmetric resonant cavity create a net unbalanced force in the direction substantially parallel to the transverse plane.

Another exemplary embodiment of the present invention is an electromagnetic thruster, including: An axially-symmetric resonant cavity including a conductive inner surface; and a frequency generator electrically coupled to the resonant cavity. The resonant cavity is adapted to support a standing electromagnetic (EM) wave with an oscillating electric field vector pointing in a direction substantially normal to a transverse plane of the cavity. The frequency generator is used to generate the standing EM wave in the resonant cavity. The axially symmetric resonant cavity includes at least one signal port. Interactions between the EM wave and the resonant cavity and the signal port(s) create a net unbalanced force on the resonant cavity. Said net unbalanced force can be substantially parallel to the z-axis, or said unbalanced force can be substantially parallel to the x-y plane of the resonant cavity.

A further exemplary embodiment of the present invention is a method of generating an unbalanced force using a resonant cavity. A standing EM wave that has an oscillating electric field vector pointing in a direction substantially normal to a transverse plane is generated in the resonant cavity. The standing EM wave interacts with the electric charges and electric currents on the walls and/or signal port(s) of the resonant cavity to produce unidirectional forces that can be in the direction substantially normal to the transverse plane or in a direction that is substantially parallel to the transverse plane of the resonant cavity.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawing are the following figures:

FIG. 1 is a cross-sectional side-view and top-view schematic drawing illustrating an exemplary thruster system according to the present invention;

FIG. 2 is a cross-sectional side-view, side-view, perspective-view, and bottom-view schematic drawing illustrating the top plate of the resonating cavity of the exemplary thruster system of the FIG. 1;

FIG. 3 is a cross-sectional side-view, side-view, and top-view schematic drawing illustrating the bottom plate of the resonating cavity of the exemplary thruster system of FIG. 1;

FIG. 4 is a system diagram illustrating the system configuration of the exemplary thruster system of FIG. 1;

FIG. 5 is a sectional side-view, top-view, side-view and detail-view schematic drawing of the top plate of a proof-of-concept embodiment of the present invention;

FIG. 6 is a sectional side-view, bottom-view, side-view and two detail-view schematic drawing of the bottom plate of a proof-of-concept embodiment of the present invention;

FIG. 7 is a cross-sectional side-view and top-view schematic drawing of the proof-of-concept embodiment of FIGS. 5 and 6;

FIG. 8 is a sectional-view, a side-view and 2 detail-views of the AAC of FIGS. 5,6, and 7, and attached piping;

FIG. 9 is a cross-sectional side-view and top-view of the Dewar used to test the proof-of-concept embodiment of FIGS. 5,6,7, and 8;

FIG. 10 is a side-view, cross-sectional side-view, and top-view of the Dewar of FIG. 9, and the proof-of-concept embodiment of FIGS. 5,6,7, and 8;

FIG. 11 is a detail-view of the top of the Dewar depicted in FIG. 10;

FIG. 12 is a schematic diagram of the phase lock loop used to test the proof-of-concept embodiment depicted in FIGS. 5,6,7, and 8;

FIG. 13 is an Excel File of the output of the load cell circuit used to test the proof-of-concept embodiment and Dewar of FIGS. 5,6,7,8,9,10, 11, and 12;

FIG. 14 is an Excel File of the output of the load cell circuit used to test the proof-of-concept embodiment and Dewar of FIGS. 5,6,7,8,9,10, 11, and 12;

FIG. 15 is an Excel File of the output of the load cell circuit used to test the proof-of-concept embodiment and Dewar of FIGS. 5,6,7,8,9,10, 11, and 12;

FIG. 16 is screen shot of a mesh from numerical method software. The mesh is of 1/144 of the proof-of-concept embodiment depicted in FIGS. 5,6,7, and 8;

FIG. 17 is a close-up screen-shot view of the mesh depicted in FIG. 16;

FIG. 18 is an Excel plot of the data points from a numerical analysis of one slot of the proof-of-concept embodiment depicted in FIGS. 5,6,7, and 8;

FIG. 19 is a screen-shot of the numerical method depiction of a magnetic field around a slot at a cross-sectional plane of the proof-of-concept embodiment depicted in FIGS. 5,6,7, and 8;

FIG. 20 is a screen-shot of the numerical method depiction of a magnetic field around a ½ slot at a cross-sectional plane of the proof-of-concept embodiment depicted in FIGS. 5,6,7, and 8;

FIG. 21 is a chart of the BCS resistance of the proof-of-concept embodiment depicted in FIGS. 5,6,7, and 8;

FIG. 22 is a chart of the predicted Q as a function of Cavity resistance and geometry factor for the proof-of-concept embodiment depicted in FIGS. 5,6,7, and 8;

FIG. 23 is a surface plot of the predicted magnetic field strength over the slots of the top plate of FIG. 5 vs. cavity Q and input power for the proof-of-concept embodiment depicted in FIGS. 5,6,7, and 8;

FIG. 24 is the spreadsheet used to generate the surface plot of FIG. 23;

FIG. 25 is a sectional side-view, and a top-view schematic diagram of a bottom plate of an exemplary resonating cavity of an embodiment of the present invention;

FIG. 26 is a sectional side-view, and a top-view schematic diagram of a top plate of an exemplary resonating cavity of an embodiment of the present invention;

FIG. 27 is a cross-sectional side-view schematic diagram of a resonating cavity of an embodiment of the present invention that is comprised of the top plate of FIG. 26 and the bottom plate of FIG. 25;

FIG. 28 is a sectional side-view and top-view schematic diagram of a blank plate used in exemplary resonating cavities of the present invention;

FIG. 29 is a cross-sectional side-view schematic diagram of a resonating cavity of an embodiment of the present invention that is comprised of the top plate of FIG. 26 and the blank plate of FIG. 28;

FIG. 30 is a cross-sectional side-view schematic diagram of a resonating cavity of an embodiment of the present invention that is comprised of the bottom plate of FIG. 25 and the blank plate of FIG. 28;

FIG. 31 is a diagram of a propagating electromagnetic wave interacting with an electron;

FIG. 32 is a diagram of a resonating electromagnetic wave;

FIG. 33 is a detail-view of one section of the bottom plate of FIG. 25, and a detail view of one section of the blank plate of FIG. 28;

FIG. 34 is a detail-view of one section of the bottom plate of FIG. 25, and a detail view of one section of the blank plate of FIG. 28;

FIG. 35 is a detail-view of an alternative asymmetric feature of the bottom plate of FIG. 25, and a detail view of one section of the blank plate of FIG. 28;

FIG. 36 is a detail-view of alternative asymmetric features of the bottom plate of FIG. 25, and a detail view of one section of the blank plate of FIG. 28;

FIG. 37 is a detail-view of one section of the top plate of FIG. 26, and a detail view of one section of the blank plate of FIG. 28;

FIG. 38 is a detail-view of one section of the top plate of FIG. 26, and a detail view of one section of the blank plate of FIG. 28;

FIG. 39 is a diagram of an embodiment of the present invention that incorporates a gimbal;

FIG. 40 is a diagram of an embodiment of the present invention that incorporates three resonating cavities to achieve 6-axis motion control;

FIG. 41 is a cross-sectional side-view schematic diagram of an embodiment of the present invention that uses a higher EM operating mode;

FIG. 42 is a diagram of the steps of an exemplary method of the present invention;

FIG. 43 is a cross-sectional side-view and an isometric cross-sectional view of a pillbox type resonating cavity;

FIG. 44 is a diagram of the electric fields at maximum value in the cavity of FIG. 43;

FIG. 45 is a diagram of the magnetic fields at maximum value in the cavity of FIG. 43;

FIG. 46 is a diagram of the Poynting Vectors inside the resonating cavity of FIG. 43;

FIG. 47 is a chart of the Poynting vectors of a propagating electromagnetic wave and a resonating electromagnetic wave;

FIG. 48 is a depiction of the force vectors exerted by the electric field of a TM₀₁₀ EM wave in the cavity of FIG. 43;

FIG. 49 is a depiction of the force vectors exerted by the magnetic field of a TM₀₁₀ EM wave in the cavity of FIG. 43;

FIG. 50 is a diagram of the cross-sectional shape of an axially-symmetric, equatorially-asymmetric resonating cavity;

FIG. 51 is a diagram of the electric fields generated by a TM₀₁₀ EM wave operated in the cavity of FIG. 50;

FIG. 52 is a diagram of the magnetic fields generated by a TM₀₁₀ EM wave operated in the cavity of FIG. 50;

FIG. 53 is a side-view, a sectional side-view, a top view and a bottom view diagram of an axially-asymmetric, equatorially-symmetric resonating cavity with 2^{nd} axis symmetry;

FIG. 54 is a side-view with three sectional-views of the resonating cavity of an embodiment of the present invention that is axially asymmetric and equatorially asymmetric;

FIG. 55 is a side-view, a bottom-view, and two sectional-views of the resonating cavity of an embodiment of the present invention that is axially asymmetric and equatorially symmetric;

FIG. 56 is a side-view, a bottom-view, and two sectional-views of the resonating cavity of an embodiment of the present invention that is axially asymmetric and equatorially symmetric;

FIG. 57 is two detail-views from the embodiment of FIG. 56;

FIG. 58 is a top-view, a side-view and a sectional side-view of an axially-asymmetric and equatorially-symmetric resonating cavity;

FIG. 59 is a top-view, a side-view and two sectional-views of an axially asymmetric and equatorially asymmetric resonating cavity of an embodiment of the present invention;

FIG. 60 is a front-view, a top-view and a sectional-view of one plate of an embodiment of the present invention;

FIG. 61 is a front-view, and 2 sectional-views of an axially asymmetric and equatorially asymmetric resonating cavity;

FIG. 62 is a front-view, a top-view, 2 sectional-views, and two detail-views of an axially asymmetric and equatorially asymmetric resonating cavity;

FIG. 63 is a front-view, a top-view, and 2 sectional-views of an axially asymmetric and equatorially asymmetric resonating cavity;

FIG. 64 is a front-view, a side-view, and a sectional side-view of an axially symmetric, equatorially-symmetric resonating cavity;

FIG. 65 is a front-view, a top-view, a bottom-view, and two sectional views of an embodiment of the present invention that uses a quarter wavelength resonator that is axially and equatorially asymmetric;

FIG. 66 is a front view, a top view, and 2 sectional views of an embodiment of the present invention that uses an axially-asymmetric and equatorially-asymmetric resonant cavity with asymmetric features that are convex protrusions into the resonant cavity;

FIG. 67 is a detail-view of one section of the bottom plate of FIG. 25 with an alternate bridge geometry, and a detail view of one section of the blank plate of FIG. 28;

FIG. 68 is a detail-view of one section of the bottom plate of FIG. 25 with an alternate bridge geometry, and a detail view of one section of the blank plate of FIG. 28;

### REFERENCE NUMERALS IN DRAWINGS

100 AAC
101 Bottom Plate
102 Top Plate
103 Asymmetric features
104 Asymmetric Features
105 Asymmetric Features
106 Signal Port
107 Signal Port
400 Housing
401 Power Unit
402 Central Control Unit
403 Signal Unit
405 Cooling Unit
500 Top Plate
501 Signal Port A
502 Signal Port B
508 Bridge
600 Bottom Plate
700 Resonating Cavity (also AAC 700)
801 Signal Cable
802 Pickup Cable
803 Adjustable Feedthrough
804 Vacuum Pipe
806 Opening
900 Dewar
901 Vacuum Valve
902 N2 Port
903 N2 Port
904 Helium Vessel
905 Jacket
1001 Vacuum Pump
1101 Support Arm
1102 Support Bracket
1103 Bolt A
1104 Bolt B
1105 Platform A
1106 Platform B
1107 Vacuum Valve
1108 Bellows
1200 PLL
1201 Sig Gen
1202 Pow Div
1203 Attenuator
1204 Attenuator
1205 Amplifier
1206 Coupler
1207 Power Meter
1208 Power Meter
1210 Pow Div
1211 Spectrum Analyzer
1212 Amplifier
1213 Pow Div
1214 Oscilloscope
1215 Trombone
1216 Phase Shifter
1217 Amplifier
1218 Mixer
1219 Attenuator
2500 Bottom Plate
2501 Magnetic Field Line
2502 Magnetic Field Line
2503 Slot
2506 Arrow
2507 Bridge
2508 Cut Plane
2600 Top Plate
2601 Slot
2602 Slot
2603 Bridge
2700 Resonating Cavity
2701 Field Line
2800 Blank Plate
2801 Signal Port A
2801 Signal Port B
3000 Pillbox Cavity
3001 Axis
3002 Arrow
3003 Arrow
3301 Wall C
3302 Wall D
3601 Asymmetric Features
3701 Wall A
3702 Wall B
3900 AAC
3901 Gimbals
4000 Housing
4001 AAC
4002 AAC
4003 AAC
4100 AAC
4101 Bottom Plate
4102 Top Plate Asymmetric Features
4103 Bottom Plate Asymmetric Features
4104 Electric Field
4105 Top Plate
4200 Configuration of Resonating Cavity
4201 Powering of EM Wave into Resonating Cavity
4202 Unbalanced Force is Generated
4203 Unidirectional Thrust is Modulated
4300 Pillbox Cavity
5000 Resonating Cavity
5300 AAC
5301 Signal Port
5302 Signal Port
5400 AAC
5401 Signal Port
5402 Signal Port
5403 Slot
5500 AAC
5501 Signal Port
5502 Signal Port
5503 Slot
5600 AAC
5601 Signal Port
5602 Signal Port
5603 Slot
5800 AAC
5801 Signal Port
5802 Signal Port
5900 AAC
5901 Signal Port
6000 Bottom Plate
6001 Signal Port
6100 AAC
6101 Signal Port
6102 Signal Port
6103 Asymmetrical Features
6200 AAC
6201 Signal Port
6202 Signal Port
6300 AAC
6301 Signal Port
6302 Signal Port
6303 Slots
6400 Resonating Cavity
6401 Signal Port
6402 Signal Port
6500 AAC
6501 Signal Port
6502 Signal Port
6503 Slots
6600 Resonating Cavity
6601 Signal Port
6602 Signal Port
6603 Asymmetric Features
6701 Bridge
6702 Substrate Layer
6801 Bridge

### DETAILED DESCRIPTION OF THE INVENTION

### Overview of System Operation

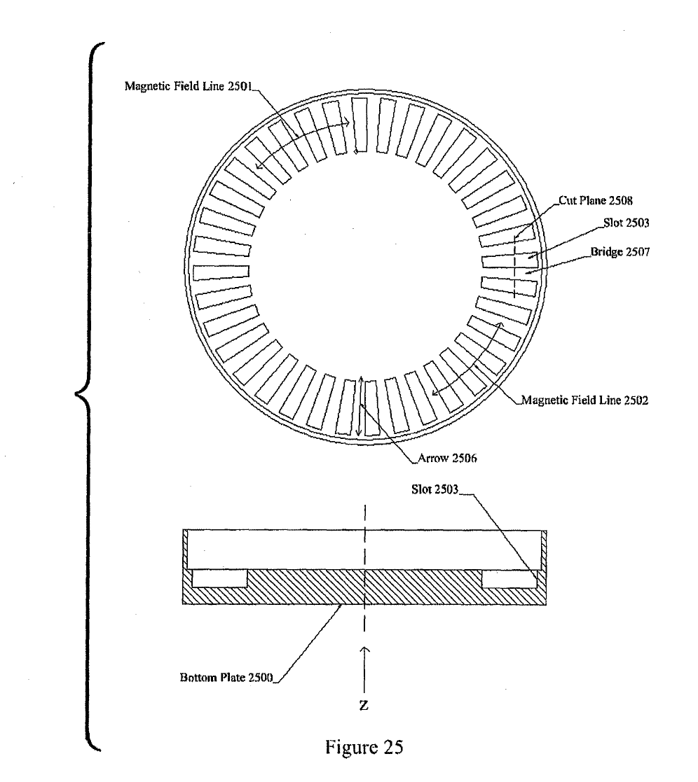

FIGS. 25, 26, and 27 represent one exemplary embodiment of the present invention. A basic overview of system operation is described below.

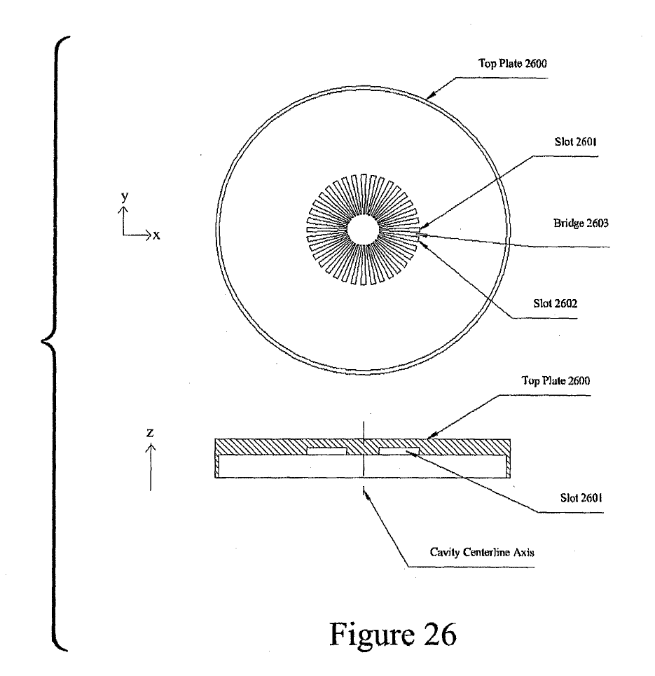

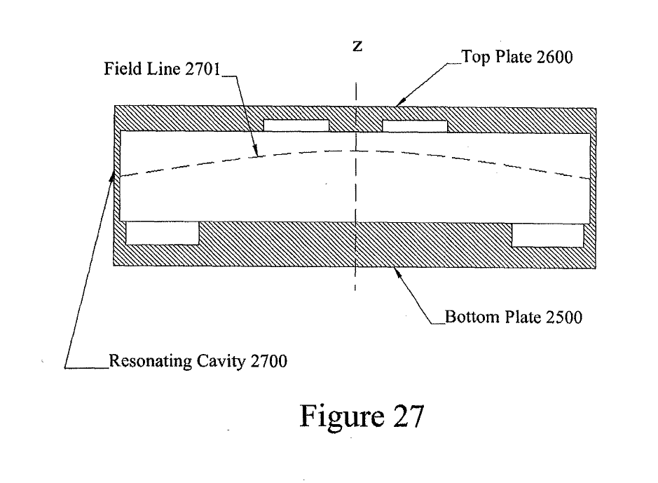

Exemplary axially-asymmetric Resonating Cavity 2700 is depicted in FIG. 27. Resonating Cavity 2700 is created by combining Top Plate 2600, depicted in FIG. 26, and Bottom Plate 2500, depicted in FIG. 25. Resonating Cavity 2700 is an axially-asymmetric resonant cavity.

A fundamental or first harmonic, resonating electromagnetic (EM) wave (i.e. a standing EM wave) may be generated within Resonating Cavity 2700. The dashed line Field Line 2701 of FIG. 27 represents one electric field maxima for the electric field of the first harmonic standing EM wave operating within Resonating Cavity 2700.

Magnetic Field Line 2501 and Magnetic Field Line 2502 of FIG. 25 represent the magnetic field direction of the first harmonic EM wave during 360 degrees of wave cycle within Resonating Cavity 2700. The magnetic field of the EM wave reverses polarity (direction) every 180 degrees of wave cycle. The bi-directional arrows of Magnetic Field Line 2501 and Magnetic. Field Line 2502 represent the two directions of the magnetic field lines of the EM wave during 360 degrees of EM wave cycle. The magnetic field direction of the EM wave operating within Resonating Cavity 2700 has a vector component parallel to the z-axis in the area near the slots of Bottom Plate 2500. The z-component of the EM magnetic field direction of the EM wave is not depicted in FIG. 25.

In FIG. 27, as the electric field of the EM wave increases to a maximum magnitude in the positive z-direction, free electrons (and/or Cooper pairs) are driven onto the center section (near the z-axis) of the conductive wall of Top Plate 2600. The maximum concentration of surplus electrons occurs in the area on the inner cavity wall of Cavity 2700 where the z-axis runs through the center of Top Plate 2600. The maximum concentration of surplus electrons on Top Plate 2600 occurs at the time in the EM wave cycle when the electric field of the EM wave is at maximum magnitude in the positive z-direction.

During the period of the EM wave cycle where a surplus of negative charges (electron charges) exist on Top Plate 2600, a surplus of positive electric charges (proton charges) exist on Bottom Plate 2500 in the area where the Cavity 2700 central axis intersects the inner surface of Bottom Plate 2500. The electric field of the EM wave exerts a force on the negative electric charges located on Top Plate 2600. The direction of said forces is normal to the section of surface which contains the surplus of electrons and the direction of said force points inwards and towards the electric field of the EM wave. The electric field of the EM wave exerts a force on the surplus positive electric charges located on Bottom Plate 2500. The direction of said forces is normal to the section of surface which contains the surplus of positive electric charges on Bottom Plate 2500 and towards the area of the resonating EM wave within Resonating Cavity 2700.

During the period of the EM wave cycle when the electric field of the EM wave points in the positive z-direction, the net z-directed force exerted by the EM wave on all negative and positive electric charges located on Top Plate 2600 and Bottom Plate 2500 is in the positive z-direction. This time-averaged force on Resonating Cavity 2700 is calculated as the time (over 180 degrees of EM wave cycle) and surface integral over the entire conductive inner surface of Resonating Cavity 2700 of the z-component of the force vector exerted by the EM electric field on the surplus electric surface charges located on the walls of Resonating Cavity 2700.

$$\overline{F} = - \frac{1}{2} {\int }_{S}^{ } {ɛ}_{0} {E}_{max}^{2} d a \qquad Equation 1 )$$

where: ∈₀ is the permittivity constant
Eₘₐₓ is the maximum surface electric field

As the electric field of the EM wave increases to a maximum value in the negative z-direction, free electrons (and/or Cooper pairs) are driven onto the center section of the conductive wall of Bottom Plate 2500. The maximum concentration of surplus electrons occurs at the central axis of Bottom Plate 2500 and at the time in the wave cycle when the electric field of the EM wave is at maximum value in the negative z-direction.

During the period of the EM wave cycle where a surplus of negative electric charges (electron charges) exist on the inner surface of Bottom Plate 2500, a surplus of positive electric charges (proton charges) exist on the inner surface of Top Plate 2600. The electric field of the EM wave exerts a force on the positive and negative electric charges located on the inner surfaces of Top Plate 2600 and Bottom Plate 2500. The direction of said forces is normal to the section of surface which contains the surplus of electric charges and towards the area of the resonating EM wave inside of Resonating Cavity 2700.

During the period of the EM wave cycle when the electric field of the EM wave points in the negative z-direction, the net z-directed force exerted by the EM wave on all surplus negative and surplus positive electric charges located on Top Plate 2600 and Bottom Plate 2500 is in the positive z-direction. This time-averaged force is calculated as the time (over 180 degrees of EM wave cycle) and surface integral over the entire conductive inner surface of Resonating Cavity 2700 of the z-component of the force vector exerted by the EM wave electric field on the surplus electric surface charges located on the cavity walls of Resonating cavity 2700.

The time-averaged net-forces due to EM wave electric field interactions with surplus electric surface charge are identical between the 1^{st} 180 degrees of EM wave cycle and the 2^{nd} 180 degrees of EM wave cycle.

During periods where the EM wave within Resonating Cavity 2700 has a non-zero magnetic field value, electric currents are induced on the cavity walls of Resonating Cavity 2700. The AC electric currents are created as free electrons (and/or Cooper pairs) move on the conductive surfaces of the inner walls of Resonating Cavity 2700.

As electrons move across the conductive surfaces of Resonating Cavity 2700, the magnetic field of the EM wave exerts a force on the moving electrons. The direction of said force is perpendicular to the cavity surface where the AC electric current exists and the direction of said force is outward and away from the area of the magnetic field of the EM wave.

The net force of the magnetic fields of the EM wave on the AC electric currents that exist on the inner walls of Resonant Cavity 2700 is calculated as the time (over 180 degrees of wave cycle) and surface integral over the entire conductive inner surface of Resonating Cavity 2700 of the z-component of the force vector exerted by the EM magnetic fields on the AC electric currents located on the inner cavity walls of Resonating Cavity 2700.

The time-averaged net z-directed force on Resonating Cavity 2700 due to EM wave magnetic field interactions with AC electric surface current is calculated over 180 degrees of EM wave cycle. The time-averaged net forces due to EM wave magnetic field interactions with AC electric surface current are identical between the 1^{st} 180 degrees of EM wave cycle and the 2^{nd} 180 degrees of EM wave cycle.

The net force exerted by the electric fields and magnetic fields of the EM wave on the surplus electric charges and AC electric currents located on the walls of Resonating Cavity 2700 constructively combine to create a time-averaged-net positive z-directed force on Resonating Cavity 2700. This time-averaged-net z-directed force is an unbalanced force.

Signal port(s) are not depicted on Resonating Cavity 2700. When calculating the surface and time integral of the interactions between the electric and magnetic fields of the EM wave interacting with the AC electric currents and surplus electric charges, the surfaces of the signal port(s) are included in the integration.

The time-averaged net unbalanced z-directed force generated by the operation of a first harmonic EM wave within Resonating Cavity 2700 creates thrust. In an isolated environment, bodies are propelled by the operation of the exemplary embodiment of the present invention, Resonating Cavity 2700. The propulsion created by the exemplary embodiment of the present invention creates thrust without the use of reaction mass and changes the momentum of the isolated system of the embodiment. Said unbalanced force generated by the exemplary embodiment of the present invention can change the net kinetic energy of the embodiment (with respect to an initial reference frame) when the exemplary embodiment is operated at steady state for more than 180 degrees of the TM₀₁₀ EM fundamental operating wave of Resonating Cavity 2700.

The embodiment of the present invention, Resonating Cavity 2700 can also produce unbalanced angular forces on a body when the net unbalanced force vector generated by the embodiment is not coincident with the center of mass of a body propelled by the embodiment. The unbalanced angular forces generated by the embodiment cause the embodiment to change the net angular momentum of the isolated system of the embodiment.

### DEFINITIONS USED THROUGHOUT THE APPLICATION

Resonant cavity: is a hollow shape comprised of conducting material which can support a standing electromagnetic wave.

z-axis: An axis that runs through the central antinode of the electric field of a resonating EM wave operating within a resonating cavity. The z-axis is coincident with the electric field line of the EM wave at the electric field antinode.

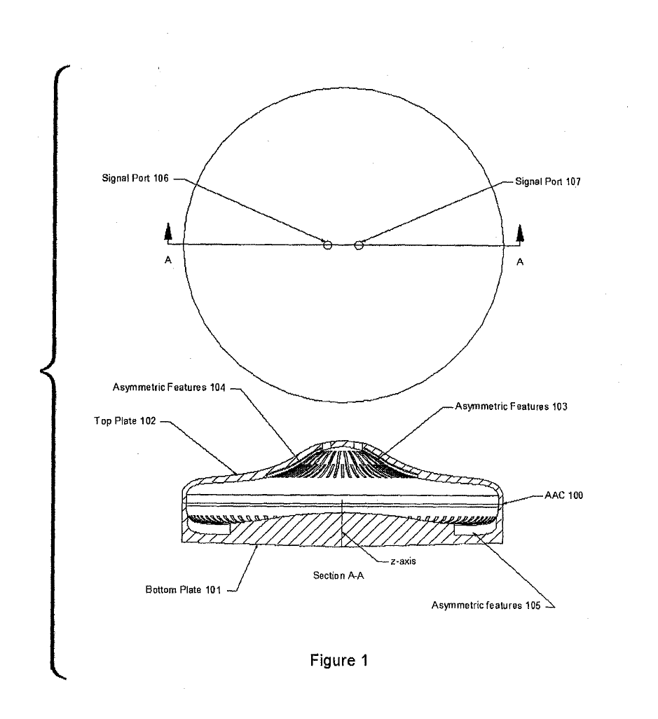

Axially-asymmetric resonating cavity: A resonating cavity that is not symmetric about the central axis (z-axis) of the resonating cavity. Signal ports do not affect axial asymmetry. An axially-asymmetric resonating cavity is also referred to as an AAC throughout this application. FIGS. 1, 7, 59 and 65 depict axially-asymmetric resonating cavities.

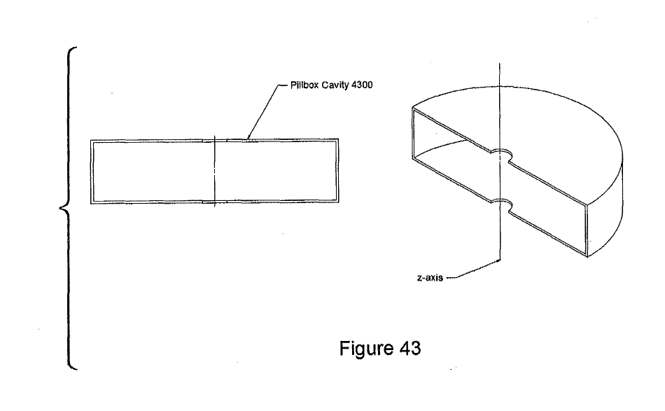

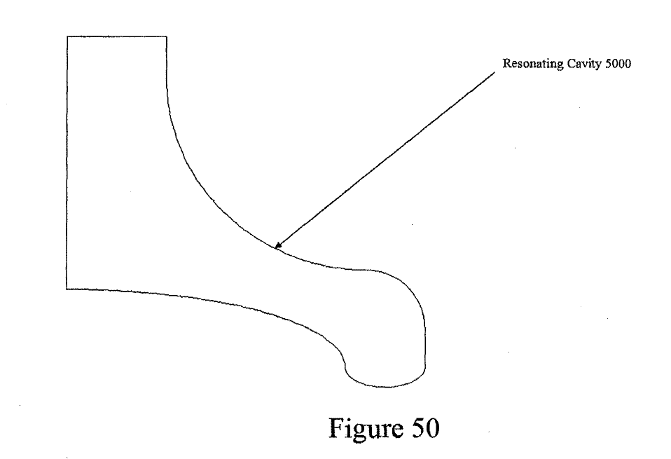

Axially-symmetric resonating cavity: A resonating cavity that is symmetric about the central axis (z-axis) of the resonating cavity. Signal ports do not affect axial symmetry. FIGS. 43, and 50 depict axially-symmetric resonating cavities.

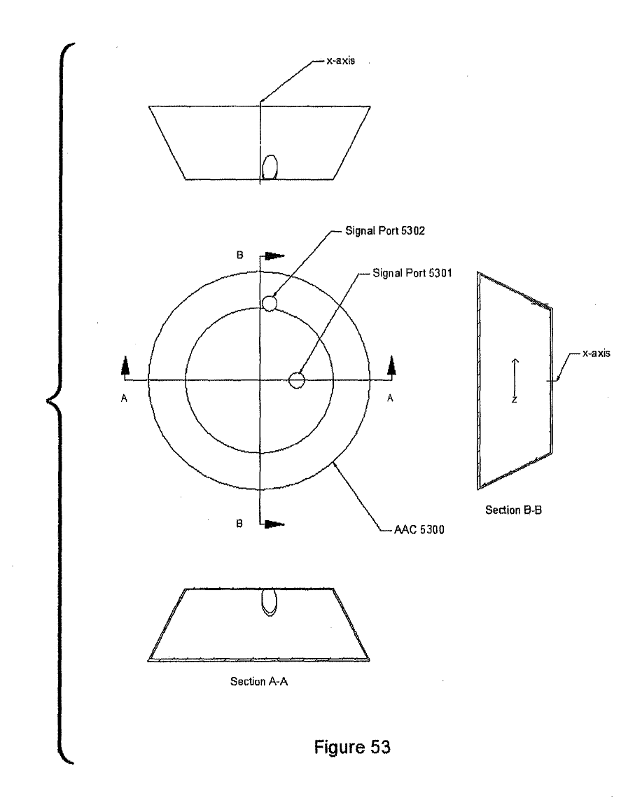

Equatorially-symmetric resonating cavity: A resonating cavity that is symmetric about the x-y plane of the resonating cavity. The x-y plane is the plane that is perpendicular to the z-axis and intersects the centerline of the equatorial wall of the resonating cavity. An equatorially symmetric resonating cavity may be axially symmetric, or axially asymmetric. Signal ports do not affect equatorial symmetry. FIGS. 53, 56, and 58 depict equatorially-symmetric resonating cavities.

Equatorially-asymmetric resonating cavity: A resonating cavity that is not symmetric about the x-y plane of the resonating cavity (or any other plane that is parallel to the x-y plane of the resonating cavity). The x-y plane is the plane that is perpendicular to the z-axis and intersects the centerline of the equatorial wall of the resonating cavity. An equatorially-asymmetric resonating cavity may be axially symmetric, or axially asymmetric. Signal ports do not affect equatorial asymmetry. FIGS. 1, 7, 27, 50 and 54 depict equatorially-asymmetric resonating cavities.

2nd-Axis Axial Symmetry: Axial symmetry of a resonating cavity where the resonating cavity is axially symmetric about an axis that is not the z-axis. 2nd-axis axially symmetric resonating cavities may also be axially symmetric, or may be axially asymmetric. 2nd-axis axially symmetric resonating cavities may also be equatorially symmetric, or may be equatorially asymmetric. Signal ports do not affect 2^{nd}-axis symmetry. FIG. 53 depicts a resonating cavity with 2^{nd}-axis axial symmetry.

Unidirectional thrust: Thrust that is generated without the use of reaction mass or ejected EM energy. Unidirectional thrust is generated by an unbalanced force. Unidirectional thrust causes an isolated system to change the net momentum of the isolated system. The thrust vector of unidirectional thrust is in the same direction as the acceleration vector created by the unidirectional thrust, and in the same direction as the unbalanced force vector which generates the unidirectional thrust.

Unbalanced force: a force that is generated without generation of an equal and oppositely directed second force. Unbalanced forces generate unidirectional thrust.

Unidirectional force: an unbalanced force.

Substantially in phase: The phase angle between two oscillating entities is less than or equal to 45 degrees.

Substantially out of phase: The phase angle between two oscillating entities is equal to or greater than 45 degrees and equal to or less than 90 degrees.

Substantially parallel: The angle between two entities is less than or equal to 45 degrees and greater than or equal to 0 degrees.

Substantially perpendicular: The angle between two entities is less than or equal to 90 degrees and greater than or equal to 45 degrees.

Substantially Evacuated: Refers to the vacuum level inside of a resonating cavity where the vacuum pressure in the cavity is less than 10% of the ambient pressure level outside of the resonating cavity, or (when ambient pressure is approximately zero) where the vacuum pressure in the cavity is less than 1 torr.

Signal Port: An opening in a resonating cavity wall surface used for the purpose of introducing EM power into a resonating cavity, monitoring EM wave energy in a resonating cavity, controlling EM wave energy in a resonating cavity, or monitoring and/or controlling other parameters inside of a resonating cavity including, but not limited to:

temperature, and/or cavity shape, and/or position of parts within a cavity. Signal ports are not considered when evaluating axial symmetry/asymmetry, equatorial symmetry/asymmetry, and 2^{nd} axis symmetry unless the cross-sectional area of the signal port opening is greater than 5% of the total resonating cavity wall surface area.

TM₀₁₀ EM wave: A standing wave mode where E_{Z} is not equal to zero and H, is zero (There may be some localized areas around axially asymmetic features where Hz is non zero).

Standing Wave: a resonating wave

### EM Wave Dynamics

Resonating electromagnetic waves are essential to the operation of embodiments of the present invention. The resonating waves inside of a resonating cavity have properties that are distinct from the properties of propagating EM waves. The resonating cavities of embodiments of the present invention exploit the unique properties of resonating EM waves to create unbalanced forces.

### Momentum Transfer in Standard Electromagnetic Wave Interactions

Propagating electromagnetic waves interact with electric charges and impart momentum to those electrically charged particles. The momentum of a propagating EM wave is expressed as:

$$ρ = \frac{E}{c} \qquad Equation ( 1 )$$

where:
ρ=wave momentum in kg·m/s
E=wave energy in joules
c=speed of light in m/s

When a propagating EM wave reflects off, passes through, or is absorbed by matter, it imparts momentum to said matter according to standard conservation of momentum equations. Radiation pressure exerted upon a reflective surface illustrates this principal.

A solar sail exploits radiation pressure by reflecting solar EM energy to create thrust. A laser engine is a conceptual engine that uses laser energy emitted from a propulsion system to drive the propulsion system in a direction opposite to the emitted laser energy.

### Standard Momentum Transfer for a Propagating EM Wave

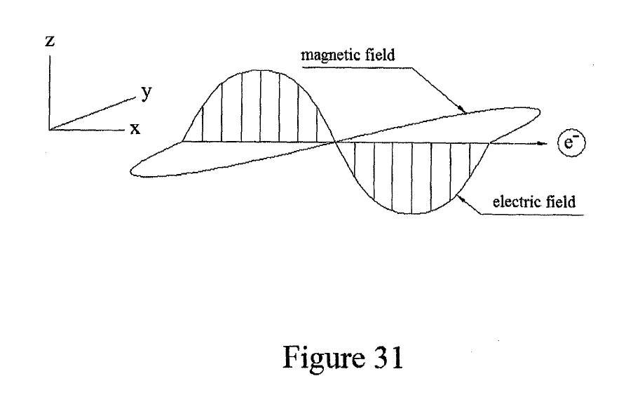

FIG. 31 depicts a propagating EM wave interacting with a free electron.

The EM wave is propagating in the positive x direction. As the electric field of the EM wave that points in the minus z direction passes over the electron, the electron will be forced in the positive z direction. The motion of the electron caused by the interaction of the electron with the electric field of the EM wave creates a small electric current in the negative z direction that interacts with the magnetic field of the EM wave. As the electron is forced in the positive z direction (creating an electric current in the negative z direction), the magnetic field of the EM wave that points in the positive y direction will create a force on the electron in the positive x direction. The electron experiences a force in the positive x direction and is accelerated in the positive x direction.

When the portion of the EM wave that has an electric field pointing in the positive z direction passes over the electron, the electron will be forced in the negative z direction (creating an electric current in the positive z direction). The magnetic field of the EM wave pointing in the negative y direction interacts with this electric current and the electron experiences a force in the positive x direction and is accelerated in the positive x direction.

Momentum is conserved in the interactions described above. The EM wave decreases in energy because of the work performed on the electron. The energy decrease of the EM wave also corresponds to a decrease in the momentum of the EM wave according to Equation (1). The momentum decrease of the EM wave is balanced by a momentum increase of the electron. Momentum is always imparted by a propagating EM wave to electrically charged particles in the same direction as the direction of propagation of the EM wave.

In order to perform work on the electron, photons of the propagating EM wave must either:
a) be absorbed by the electron (corresponding to a higher kinetic energy of the electron, a heating in anything attached to the electron, or some other manifestation of the photon energy in the electron or any matter attached to the electron).
b) be reemitted from the oscillating electron with a slightly higher wavelength (corresponding to a decrease in photon energy).

Propagating EM wave momentum transfer depends upon:
a) an EM wave electric field to create movement of an electrically charged particle located within the area of the EM wave electric field.
b) An EM wave magnetic field to interact with the electric current created by the interaction of the electric field and the electrically charged particle.
c) The electric and the magnetic field of the propagating wave must act on the electron at the same time to impart momentum to a charged particle.
   Resonating Wave momentum

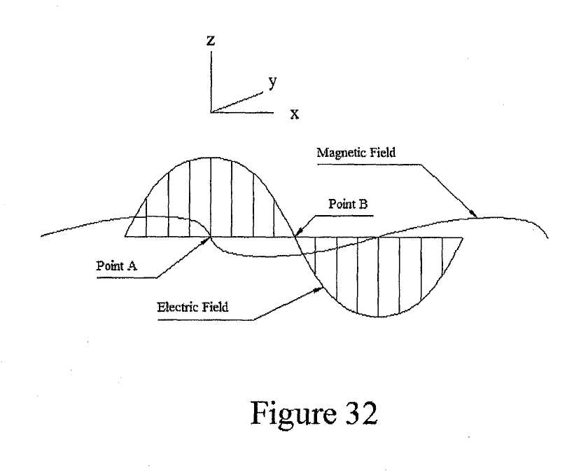

FIG. 32 represents the electric and magnetic fields of a resonating EM wave (also known as a standing wave). A resonating wave is created by the reflection of a propagating EM wave over itself. In a resonating cavity, a resonating EM wave is created and sustained by appropriate design of the cavity and appropriate signal generation and control of EM wave energy into said resonating cavity.

There are two primary differences between a propagating EM wave and a resonating EM wave. Those differences are:
a. The electric and magnetic fields of the resonating wave are out of phase by 90 degrees in location. The location of the electric field and the magnetic field of a propagating EM wave are in phase.
b. The electric and magnetic fields of the resonating wave are out of phase by 90 degrees in time. The electric and the magnetic fields of a propagating EM wave are in phase in time.

Because of the time and location phase difference between the electric and magnetic fields of a resonating electromagnetic wave, the time-averaged (over 180 degrees of wave cycle) E×B vector (also called the Poynting vector) is always zero. There is no time-averaged direction of energy propagation in a resonating wave and net momentum of the wave is zero (assumes steady state operating conditions). Within a resonating cavity, there are localized regions within the resonating wave fields that have an E×B vector, but over a 180 degree wave cycle, the time-averaged Poynting vector in these localized regions is zero. The time-averaged Poynting vector of the entire resonating field within a resonating cavity over 180 degrees is always zero.

Note: The time-averaged Poynting Vector is zero in a resonating cavity with infinite Q and where the EM wave does no non-dissipative work on the cavity. In actual cavity operation, a small, non-zero Poynting Vector exists as EM energy migrates into the cavity through signal port(s) and/or out of the cavity signal port(s). This non-zero time-averaged Poynting Vector for the finite Q cavity and/or cavities which have EM wave energy performing non-dissipative work have a time-averaged Poynting Vector which is negligible compared to propagating EM waves of equal energy density.

EM wave momentum throughout a resonating cavity is suppressed by interference patterns. A small point charge is placed at Point A in FIG. 32. Point A is an antinode of the electric field of the resonating EM wave. The charged particle at Point A is forced in the positive and negative z directions by the electric potential of the oscillating electric field surrounding Point A. There is no magnetic field present at Point A since Point A is also a node of the magnetic field. There can be no momentum transfer in the x direction to a charged particle at Point A due to oscillations of the charged particle in the positive and negative z directions. The magnetic field is always zero at Point A and the magnetic field effects on either side of Point A (in the x direction) will always cancel out since the magnetic fields on either side of Point A are always opposite in polarity.

In a z-direction homogenous oscillating electric field of a resonating wave, the charged particle will, over many wave periods of the resonating EM wave, gain no momentum in any direction, but will continue to oscillate through Point A along a path parallel to the z-axis. In an oscillating electric field of a resonating wave without z-direction homogeneity, the charged particle will be ejected from the resonating EM wave in the positive or negative z-direction by the ponderomotive force.

In the example of the oscillating particle above, the charged particle moves along an axis that is perpendicular to the localized Poynting vectors that exist during time intervals within the 180 degree cycle of the resonating wave.

Point B of FIG. 32 is located at the electric field node of the resonating EM wave. The electric field is always zero at Point B. A stationary particle at Point B will experience no force from the electric field of the resonating wave. The particle located at Point B will not move from Point B and therefore will experience no force at any time from the oscillating magnetic field of the resonating EM wave at Point B of FIG. 32.

At points along the x axis between Point A and Point B, a charged particle will experience x-directed forces due to E×B forces. The time-averaged force experienced by the charged particle at points between Point A and Point B will be zero since the electric and magnetic fields are 90 degrees out of phase in time. While the electric field is pointing in the positive z direction, the magnetic field of the resonating wave points in both the positive and negative y direction. While the electric field is pointing in the negative z direction, the magnetic field of the resonating wave points in both the positive and negative y direction. A charged particle that is fixed in position at any point between points A and B along the x-axis will experience no time averaged net force from the EM wave. Charged particles that are not fixed in position will be ejected from the wave fields by the ponderomotive force.

Conclusion:

The momentum transfer mechanism for a propagating EM wave to a charged particle does not always exist for resonating wave-charged particle interactions. Resonating waves have no time-averaged (over 180 degrees of EM wave cycle) net momentum and cannot impart momentum to charged particles of fixed position.

### Resonating Cavity Dynamics

### Resonating Cavity Operation

FIG. 43 represents two sectional-views of Pillbox Cavity 4300. The two holes in the cavity walls of Pillbox Cavity 4300 located along the axis of symmetry (the z-axis) are used for signal cables which allow for EM energy to enter the cavity, and used for a feedback control loop to be attached to the cavity (These signal cable systems are not pictured in FIG. 43).

Pillbox Cavity 4300 is axially symmetric and equatorially symmetric.

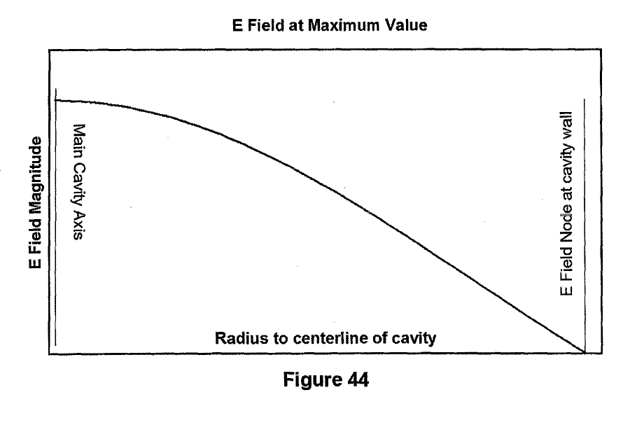

FIG. 44 represents the profile of the electric field of the resonating EM wave within Pillbox Cavity 4300 at maximum amplitude. At minimum amplitude, the electric field inside of the resonating cavity is zero at all points in the cavity. The resonating EM wave is operated in the first harmonic mode (TM₀₁₀) within Pillbox Cavity 4300. The distribution of the electric field of the EM resonating wave inside of Pillbox Cavity 4300 is modeled with a Bessel function.

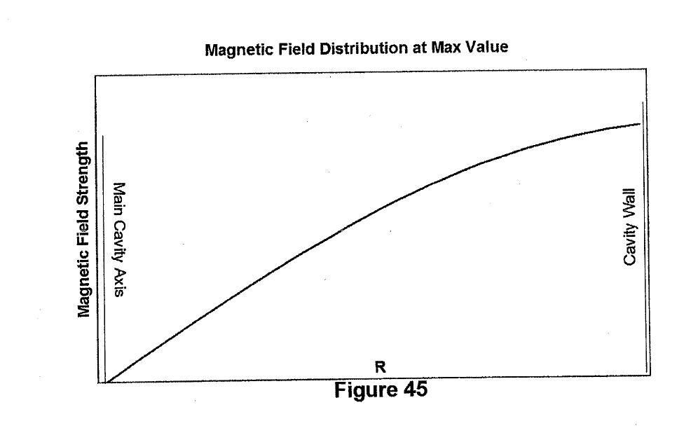

FIG. 45 depicts the profile of the magnetic field magnitude of the EM wave within Pillbox Cavity 4300 at maximum amplitude. At minimum amplitude, the magnetic field inside of Pillbox Cavity 4300 is zero at all points in the cavity. The resonating wave is operating in the first harmonic mode within Pillbox Cavity 4300. The behavior of the magnetic field inside of Pillbox Cavity 4300 is modeled by a Bessel function.

When the electric field of the EM resonating wave within Pillbox Cavity 4300 is at maximum positive or negative value, the magnetic field of the EM resonating wave is at zero amplitude everywhere within Pillbox Cavity 4300. When the magnetic field of the EM wave is at maximum positive or negative value within Pillbox Cavity 4300, the electric field of the EM resonating wave within Pillbox Cavity 4300 is at zero amplitude throughout the cavity.

The energy of the resonating EM wave within Pillbox Cavity 4300 oscillates between two states: being 100% present as electric field energy and 0% as magnetic field energy, to being present as 100% magnetic field energy and 0% as electric field energy.

During transition between said states, the energy of the EM wave is present as both electric and magnetic field energy. Interference patterns of the resonating EM wave within the Pillbox Cavity 4300 cause the time and positional phase difference between the electric and magnetic fields of the resonating EM wave.

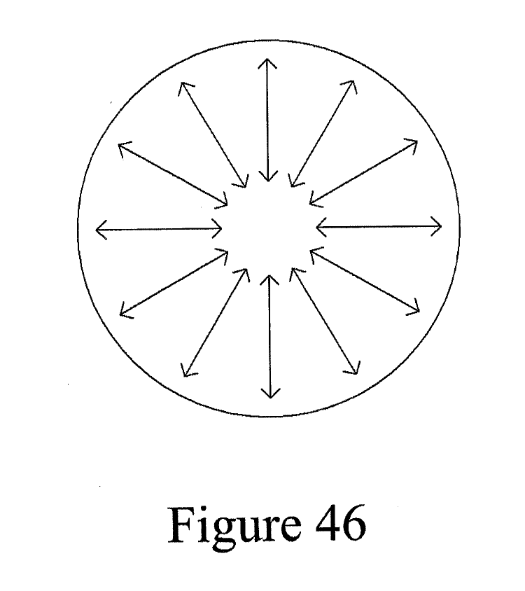

FIG. 46 depicts the localized Poynting vectors of the resonating EM wave within Pillbox Cavity 4300. These Poynting vectors are parallel to the x-y plane. When summed up over the entire area of the resonating wave and/or over the 180 wave cycle, these Poynting vectors cancel out and the resonating EM wave has a zero-net value Poynting vector. The time average (over 180 degrees of wave cycle) of net resonating wave momentum is also suppressed by interference patterns giving the resonating wave a time-averaged net-zero momentum vector.

The time average (over 180 degrees of wave cycle) of net momentum of the resonating wave is always zero. The resonating wave has magnetic field energy and has electric field energy available to do work. Any work done by the energy fields of the wave will decrease the energy of the wave, but will not change the wave momentum since the time-average net value of wave momentum remains at approximately zero value due to interference effects. The time-averaged zero net momentum of a resonating EM wave within a resonating cavity is exploited by embodiments of the present invention to generate an unbalanced force.

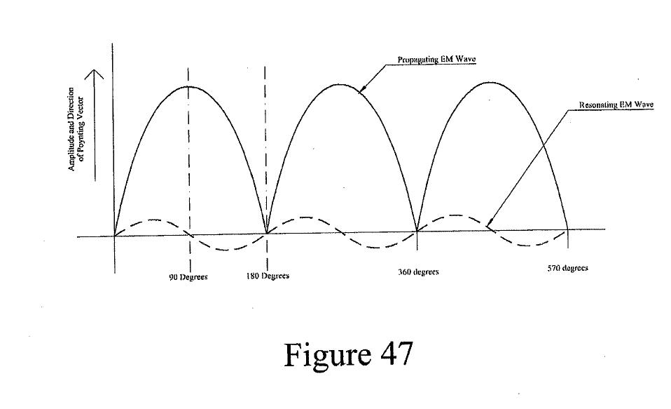

FIG. 47 depicts the Poynting vectors of a propagating EM wave travelling in free space and the Poynting vector at a single point within a resonating EM wave operating within a resonating cavity. Both the propagating EM wave and the resonating EM wave have the same wavelength. FIG. 47 illustrates the difference between the Poynting vectors of a propagating EM wave and a resonating EM wave.

The horizontal flat dashed line of FIG. 47 represents a zero-amplitude Poynting vector. The horizontal scale for FIG. 47 represents 540 degrees of EM wave cycle. The vertical scale in FIG. 47 represents amplitude and direction for the Poynting vector. Over 180 degrees of EM wave cycle, every point within a resonating wave field has a Poynting vector which creates a net-zero vector when summed over the 180 degree wave period. The Poynting vector of a propagating EM wave is unidirectional and has a non-zero net amplitude. The time-averaged (over 180 degrees) Poynting vector of a resonating wave is always zero at every point within the resonating field and for the sum of the entire area of the resonating wave electric and magnetic fields. The localized Poynting vectors at individual points within a resonating wave field are not unidirectional over 180 degrees of EM wave cycle.

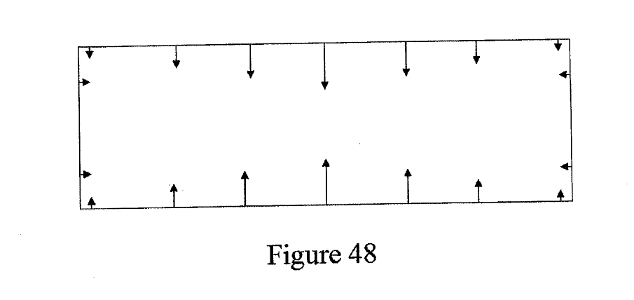

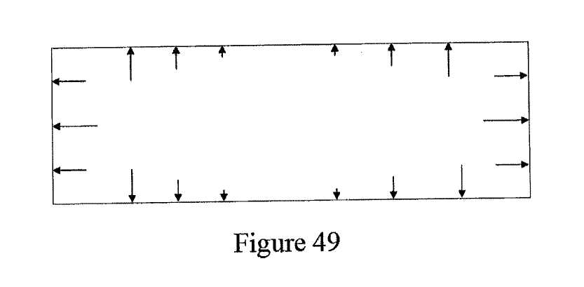

Within the Pillbox Cavity 4300 of FIG. 43, a resonating EM wave operating with the TM₀₁₀ frequency of Pillbox Cavity 4300 does not create unidirectional thrust. Pillbox Cavity 4300 experiences forces from sustaining the TM₀₁₀ resonating EM wave within Pillbox Cavity 4300. Pillbox Cavity 4300 of FIG. 43 experiences two types of forces on the cavity walls due to the resonating EM wave being sustained within Pillbox Cavity 4300. The two types of forces are electric field forces and magnetic field forces. The force vectors generated by electric field forces and magnetic forces within a pillbox-type resonating cavity are represented in FIGS. 48 and 49. The combined electric and magnetic field forces are also called the Lorentz forces.

One force exerted by the resonating EM wave within Pillbox Cavity 4300 is an electric field force which concentrates primarily near the axial center of Pillbox Cavity 4300. FIG. 48 depicts the distribution of electric field force across a cross section (Cross section is through the axial center of Pillbox Cavity 4300) of Pillbox Cavity 4300. The electric field within Pillbox Cavity 4300 interacts with surplus electric charges that concentrate on the upper and lower inner surfaces of Pillbox Cavity 4300. The surplus electric charges on the upper inner surface of Pillbox Cavity 4300 are opposite in polarity to the surplus electric charges that buildup on the lower inner surface of Pillbox Cavity 4300. The electric field of the EM wave resonating with Pillbox Cavity 4300 interacts with the surplus electric charges on the upper and lower surfaces of Pillbox Cavity 4300 and creates the force vectors depicted in FIG. 48. The length of the arrows in FIG. 48 depict the relative strength of the forces exerted by the electric field of the resonating EM wave on the surplus electric charges located on the inner walls of Pillbox Cavity 4300.

Another force exerted by the resonating EM wave within Pillbox Cavity 4300 is a magnetic field force. The magnetic field forces exerted by the EM resonating wave on the walls of Pillbox Cavity 4300 concentrate primarily near the equatorial walls of Pillbox Cavity 4300 and away from the axial center of Pillbox Cavity 4300. The oscillating magnetic fields of the EM wave within Pillbox Cavity 4300 create AC electric currents on the inner surfaces of Pillbox Cavity 4300. These AC currents interact with the magnetic field of the EM wave and create Lorentz forces that are directed outwardly from the center of Pillbox Cavity 4300 and perpendicular to the walls of Pillbox Cavity 4300 where the AC currents are present. The direction and magnitude of the magnetic field forces exerted by the resonating EM wave on the walls of Pillbox Cavity 4300 are depicted in FIG. 49.

The energy of the EM resonating wave within Pillbox Cavity 4300 oscillates from being present in the electric field of the resonating EM wave to being present in the magnetic field of the resonating EM wave. The magnitude of the force vectors created by the electric fields of the EM wave interacting with the electric charges on the inner walls of Pillbox Cavity 4300 oscillates in phase with the absolute magnitude of the electric field strength of the EM wave. The magnitude of the force vectors created by the magnetic fields of the EM wave interacting with the AC electric currents on the inner walls of Pillbox Cavity 4300 oscillates in phase with the absolute magnitude of the magnetic field strength of the EM wave.

In embodiments of the present invention, the force vectors generated by the electric fields and/or the magnetic fields of a resonating EM wave operating within a resonating cavity are used to create unbalanced force(s). The shape of the resonating cavities of embodiments of the present invention is designed to create time-averaged net imbalances in the net-force vectors generated by the interaction of the electric and/or the magnetic fields of the EM resonating waves with electric charges and/or electric currents located on the resonant cavity walls and on signal port(s) wall(s).

Said net imbalances in time-averaged net force vectors generated on a resonating cavity of embodiments of the present invention create time averaged (over 180 degrees of wave cycle) net-unbalanced forces on the resonant cavities. Net unbalanced forces are used to create linear, and/or angular unbalanced forces on the resonating cavities of embodiments of the present invention.

Embodiments of the present invention create unbalanced forces that generate linear thrust, and, that linear thrust causes the embodiment to change the net linear momentum of the isolated system of the embodiment.

Embodiments of the present invention create unbalanced forces that generate rotational thrust and that rotational thrust causes the embodiment to change the net angular momentum of the isolated system of the embodiment.

Embodiments of the present invention create unbalanced forces that generate linear thrust and rotational thrust, and, that linear thrust and rotational thrust causes the embodiment to change the net linear momentum and the net angular momentum of the isolated system of the embodiment.

Embodiments of the present invention that create unbalanced forces for more than 1 wave cycle of the fundamental operating EM wave may change the net energy of the system (the potential and kinetic energy of the embodiment) with respect to the initial reference frame of the embodiment.

### Axially Symmetric Cavity Dynamics:

Resonating cavities experience two types of forces from sustaining a resonating electromagnetic wave within the resonating cavities. Those forces are due to:
1) The electric field of the resonating wave interacting with electric charges contained on the walls of the resonating cavity. Throughout this application, this force is referred to as the Electric Field Force, or as the EFF, or as Electric Field Propulsion or EFP.
2) The magnetic field of the resonating EM wave interacting with AC electric currents located on the walls of the resonating cavity. Throughout this application, this force is referred to as the Magnetic Field Force, or as the MFF, or as Magnetic Field Propulsion or MFP.

The combined EFF and MFF are also referred to as the Lorentz Forces.

An axially-symmetric resonating cavity is a resonating cavity that is comprised of axially-symmetric surfaces (the surface comprises the interface that is the boundary of the resonating wave and the resonating cavity walls). Said surfaces are symmetric with respect to a central axis of the cavity and this axis is referred to as the z-axis. The z-axis is the axis line that intersects the electric field antinode of the operating EM wave for the cavity, and the z-axis is parallel to the electric field lines of the EM resonating wave at the antinode of the resonating EM wave contained by the axially-symmetric cavity.

### Axially Symmetric, Equatorially Symmetric Resonating Cavity Dynamics:

Pillbox Cavity 4300 is depicted in FIG. 43 and is axially symmetric about the z-axis. Pillbox Cavity 4300 is also symmetric about an x-y plane that runs through the centerline of the equatorial walls of Pillbox Cavity 4300, but this symmetry is not axially symmetry, it is equatorial symmetry. Pillbox Cavity 4300 is axially symmetric and Pillbox Cavity 4300 is equatorially symmetric.

Equatorial Symmetry: Geometric symmetry about a plane with said plane parallel to the x-y plane such that the two halves of the resonant cavity intersected by said plane are mirror images. A resonating cavity is equatorially symmetric when at least one of said planes exists.

Pillbox Cavity 4300 is operated with a TM₀₁₀ resonating EM wave. Due to cavity symmetries, Pillbox Cavity 4300 experiences no net force in the z-direction due to the electric field of the resonating wave interacting with electric charges contained on the walls of the resonating cavity. The positive z-directed force exerted by the electric field of the EM wave on surplus electric charges located on the bottom half of Pillbox Cavity 4300 is balanced by a negative z-directed force exerted by the electric field of the EM wave on surplus electric charges located on the top half of the Pillbox Cavity 4300.

Due to cavity symmetries, Pillbox Cavity 4300 experiences no net force in the z-direction due to the magnetic field of the resonating EM wave interacting with AC electric currents contained on the walls of Pillbox Cavity 4300. The positive z-directed force exerted by the magnetic field of the EM wave on AC electric currents located on the inner surface walls of the top half of Pillbox Cavity 4300 is balanced by a negative z-directed force exerted by the magnetic field of the EM wave on AC electric currents located on the inner surface walls on the bottom half of Pillbox Cavity 4300.

When summed over the entire cavity, the electric field forces and magnetic field forces exerted on the AC electric currents and surplus electric charges located on Pillbox Cavity 4300 walls are zero. No time-averaged net force is exerted on Pillbox Cavity 4300 by operating a TM₀₁₀ EM wave in Pillbox Cavity 4300. Pillbox Cavity 4300 is an axially-symmetric resonating cavity.

Signal Ports: the signal ports on Pillbox Cavity 4300 are also axially symmetric and equatorially symmetric and no time-averaged net-unbalanced force is exerted by the EM wave on the signal ports

Conclusion:
a) Axially and Equatorially symmetric resonating cavities produce no time-averaged net force on the resonating cavity due to Electric Field Forces.
b) Axially and Equatorially symmetric resonating cavities produce no time-averaged net force on the resonating cavity due to Magnetic Field Forces.
c) Axially and Equatorially symmetric resonating cavities produce no time-averaged net force on the resonating cavity due to combined Electric Field Forces and Magnetic Field Forces.
   Axially symmetric, equatorially symmetric resonating cavities do not experience a time-averaged, net-unbalanced Lorentz force.

### Axially Symmetric, Equatorially Asymmetric Resonating Cavity Dynamics:

FIG. 50 depicts one-half of the cross-sectional view of Resonating Cavity 5000. Resonating Cavity 5000 is a resonating cavity that is symmetric about the z-axis. The z-axis is coincident with the left-most line in the graph of FIG. 50. Resonating Cavity 5000 is not an equatorially-symmetric resonating cavity. Resonating Cavity 5000 also does not have 2^{nd} axis radial symmetry.

Resonating Cavity 5000 is operated with a TM₀₁₀ EM resonating wave. The top line on Resonating Cavity 5000 in FIG. 50 represents an opening (not a cavity wall) and the cavity is charged with EM energy through this opening. Resonating Cavity 5000 will experience both a net z-directed electric field force, and a net z-directed magnetic field force on the cavity walls.

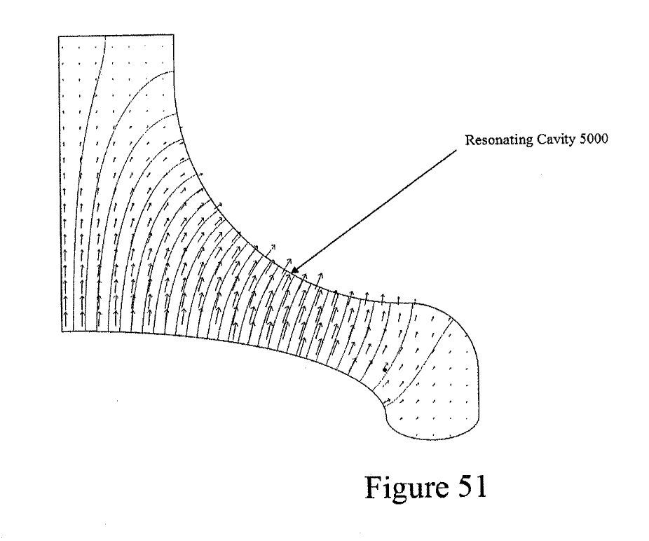

The arrows of FIG. 51 depict the electric fields in Resonating Cavity 5000 at an electric field maxima. The length of the arrows in FIG. 51 depicts the electric field intensity in the cavity at the location of the arrow. The arrow direction depicts the direction of the electric field in the cavity at the location of the arrow. The direction of the electric field reverses when the wave cycle of the EM wave shifts 180 degrees. The time-averaged net z-directed force vector on Resonating Cavity 5000 due to the electric field force is not zero. There is a time averaged net positive z-directed force on Resonating Cavity 5000 due to the electric field force.

Resonating Cavity 5000 has a TM₀₁₀ EM frequency of 598.16 Mhz and is operated in the TM₀₁₀ at steady state with steady state stored energy of 7.5 joules. There is a net-time averaged force on the cavity walls of Resonating Cavity 5000 due to the electric field force of approximately 53 Newtons in the positive z direction. Numerical analysis of Resonating Cavity 5000 was performed with the software Superfish in combination with post processing of numerical results in Microsoft Excel.

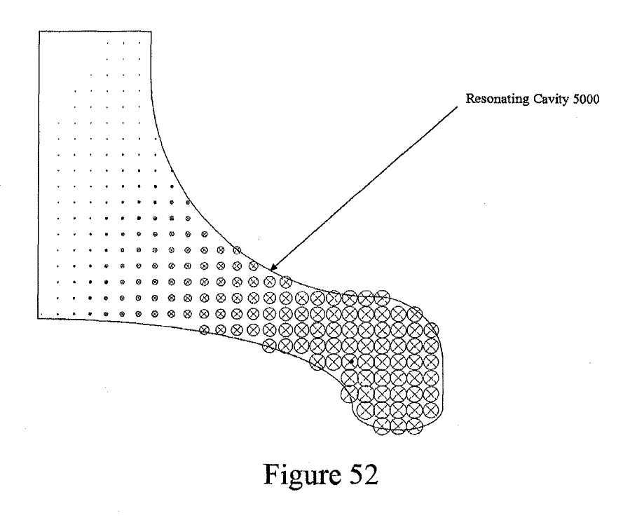

The circles of FIG. 52 depict the magnetic field in Resonating Cavity 5000 at a magnetic field maxima. The diameter of the circles in FIG. 52 depicts the magnetic field intensity in Resonating Cavity 5000 at the location of the circles. The magnetic field direction depicted in FIG. 52 is into the plane of the page (and away from the reader). The direction of the magnetic field reverses when the wave cycle of the EM wave shifts 180 degrees. The time averaged (over 180 degrees) net z-directed force vector on Resonating Cavity 5000 due to the magnetic field force is not zero. There is a time-averaged net negative z-directed force on Resonating Cavity 5000 due to the magnetic field force.

Resonating Cavity 5000 has a TM₀₁₀ frequency of 598.16 Mhz and is operated in the TM₀₁₀ at steady state with steady state stored energy of 7.5 joules. There is a time-averaged net force on Resonating Cavity 5000 walls due to the magnetic field force of approximately 53 Newtons in the negative z direction.

The time-averaged (over 180 degrees of wave cycle) net z-directed force on Resonating Cavity 5000 due to the combined electric field force and the magnetic field forces is zero.

The electric fields and magnetic fields of a resonating EM wave are 90 degrees out-of-phase in time. Within a 180 wave cycle of a resonating EM wave, there are periods of net unbalanced z-directed forces on Resonating Cavity 5000. In Resonating Cavity 5000, periods in the wave cycle where more energy is present in the electric field than in the magnetic field of the EM wave will cause a net positive instantaneous z-directed force to be exerted on the cavity. In Resonating Cavity 5000, periods in the EM wave cycle where more energy is present in the magnetic field than in the electric field of the EM wave will cause a net negative instantaneous z-directed force to be exerted on the cavity. When the time-averaged (over 180 degrees of wave cycle) electric field forces and magnetic field forces acting on Resonating Cavity 5000 are summed over the entire cavity, a net-zero-time-averaged z-directed Lorentz force results.

The cross-sectional shape of an axially symmetric (about the z-axis) resonating cavity can create an imbalance in the net z-directed electric field force on the cavity when a resonating EM wave is operated within said cavity. The net-time-averaged z-directed magnetic field force exerted on said cavity will be equal in magnitude and oppositely directed to the net-time-averaged z-directed electric field force on said cavity. The net z-directed electric field force oscillates from a minimum value to a maximum value in phase with the square of the absolute magnitude of the electric field of the EM wave. The net z-directed magnetic-field force oscillates from a minimum value to a maximum value in phase with the square of the absolute magnitude of the magnetic field of the EM wave.

Conclusion:

Axially-symmetric resonating cavities that are not equatorially symmetric can have non-zero time-averaged net z-directed Electric Field Forces and non-zero time-averaged net z-directed Magnetic Field Forces, but the time-averaged sum over 180 degrees of EM wave cycle of the combined Electric Field Forces and Magnetic Field Forces on a axially symmetric resonating cavity is always zero.
a) Axially symmetric resonating cavities that are not also equatorially symmetric can produce a time-averaged net force on the resonating cavity due to Electric Field Forces.
b) Axially symmetric resonating cavities that are not also equatorially symmetric can produce a time-averaged net force on the resonating cavity due to Magnetic Field Forces.
c) All axially symmetric resonating cavities (equatorially symmetric and equatorially asymmetric) can produce no time-averaged net force on the resonating cavity due to combined Electric Field Forces and Magnetic Field Forces.

### Unidirectional Force Generation in Embodiments of the Present Invention

Two mechanisms are responsible for creating the unidirectional forces generated by embodiments of the present invention. These mechanisms are the Magnetic Field Propulsion (MFP) mechanism, and the Electric Field Propulsion (EFP) mechanism. These propulsion mechanisms require an axially asymmetric resonating cavity to create unbalanced forces, and/or axially asymmetric and/or equatorially asymmetric signal port(s) to create unbalanced forces.

### Axially Asymmetric Resonating Cavity (AAC):

Axially-asymmetric cavities may be equatorially symmetric or may be equatorially asymmetric.

Embodiments of the present invention that are axially asymmetric and equatorially symmetric generate linear and/or angular unbalanced forces.

Embodiments of the present invention that are axially asymmetric and equatorially asymmetric generate linear and/or angular unbalanced forces.

Axially asymmetric resonating cavities that are equatorially symmetric may have 2^{nd} axis symmetry. 2^{nd} axis symmetry is axial symmetry of a resonating cavity about an axis that is not the z-axis of the resonating cavity.

Classifications of Resonating Cavities
with respect to the Present Application

| | Axially Symmetric | Axially Asymmetric |
|---|---|---|
| Equatorially | ASES | AAES with 2nd axis |
| Symmetric | | symmetry |
| | | AAES with no 2nd axis |
| | | symmetry |
| Equatorially | ASEA | AAEA |
| Asymmetric | | |

FIG. 53 depicts AAC 5300. AAC 5300 is an axially-asymmetric resonating cavity that is equatorially symmetric and has 2^{nd}-axis symmetry. Signal Ports 5301 and 5302 in FIG. 53 are signal ports used for powering EM wave energy into AAC 5300 and for monitoring and controlling EM wave energy in AAC 5300.

AAC 5300 is equatorially symmetric because AAC 5300 is symmetric about the x-y plane (Signal Ports 5301 and 5302 do not affect the axial symmetry, equatorial symmetry or 2^{nd}-axis symmetry of AAC 5300).

AAC 5300 has 2^{nd}-axis symmetry because AAC 5300 is axially symmetric about the x-axis. AAC 5300 is axially asymmetric because AAC 5300 is not axially symmetric about the z-axis.

Excluding effects on Signal Ports 5301 and 5302, AAC 5300 does not generate a time-averaged (over 180 degrees of wave cycle) net unbalanced force by the combined MFP and EFP mechanism of the present invention. The time-averaged MFP and EFP net force on AAC 5300 (excluding Signal Port/EM wave interactions) is zero.

There may be small time-averaged (over 180 degrees of EM wave cycle) unbalanced forces generated on AAC 5300 due to asymmetric interactions of the electric and magnetic fields of the EM wave with surplus electric charges and AC electric currents located on or near the walls of Signal Ports 5301 and 5302.

The primary purpose of signal ports for resonating cavities is to introduce, modulate, and control EM power in the resonating cavity. Prior to the present application, no prior art exists whereby signal ports on resonating cavities have been designed and/or determined to generate time averaged-unbalanced forces on a resonating cavity when the resonating cavity is operated with a resonating EM wave.

Embodiments of the present invention are designed such that signal port location and signal port design increase the time-averaged (over 180 degrees of EM wave cycle) net unbalanced force generated by the combined EFP and MFP mechanisms on the embodiment. Said signal ports are designed to asymmetrically interact with the electric and magnetic fields of the EM wave to create a time averaged net unbalanced force on the embodiment. The force vector of said unbalanced force may constructively add to the time-averaged net-unbalanced force generated by the embodiment.

An axially-asymmetric resonating cavity (AAC) is utilized by embodiments of the present invention. An AAC is a resonating cavity that is comprised in part or in total of axially asymmetric surfaces (the surface comprises the interface that is the boundary of the resonating EM wave and the resonating cavity walls). Said surfaces are asymmetric with respect to the z-axis (the asymmetric surface changes with respect to a 360 degree sweep around the z-axis). The z-axis is the axis line that intersects the electric field antinode of the EM operating wave of the AAC, and is parallel to the electric field lines at the electric field antinode of resonating EM operating wave contained by the AAC. This line is referred to as the z-axis throughout this document.

For embodiments of the present invention where a TM₀₁₀ EM operating is used, the z-axis is located at the single antinode of the EM wave.

An axially asymmetric surface of an AAC is defined as: a wall surface with a cross-sectional shape (the cross-sectional shape is defined as a 2-dimensional shape located in a plane containing a radii that is parallel to the x-y plane, and the z-axis, and said 2-dimensional shape is delineated by the boundary of the AAC inner conducting surface) that changes in shape as the radii (which is in the plane of the 2-dimensional shape) is rotated 360 degrees around the z-axis. The path of rotation of said radii is parallel to the x-y plane. The x-y plane is perpendicular to the z-axis.

An axially-symmetric resonating cavity has axial symmetry with respect to the z-axis of the resonating cavity. An axially asymmetric resonating cavity (AAC) does not have axial symmetry about the z-axis of the resonating cavity.

For embodiments of the present invention where higher mode EM waves are used, the z-axis is located at an electric field antinode of the EM wave which is closest to the geometric center of the resonating cavity and the z-axis is parallel to the electric field lines of the EM wave at said antinode.

Axially-asymmetric features are sections of a resonating cavity wall that make the resonating cavity axially asymmetric. Signal ports used for introducing EM wave energy into the cavity and signal ports used for measuring, and/or monitoring, and/or controlling EM wave energy or performing other functions in the cavity are not axially-asymmetric features of embodiments of the present invention except in embodiments where the surface area of the cross-section of the intersection of the signal port and the resonant cavity is greater than 5% of the resonant cavity inner surface area.

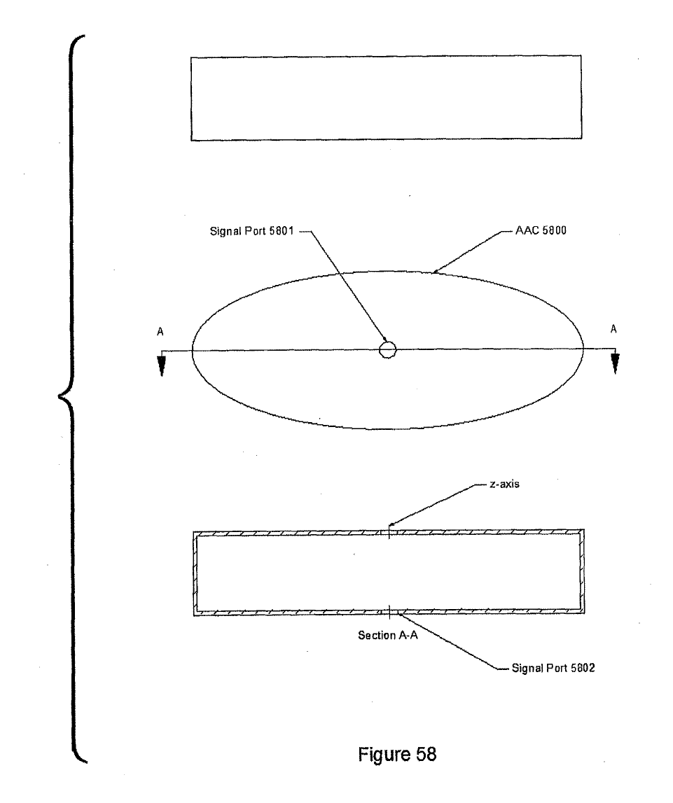

AAC 5800 is depicted in FIG. 58 and is an axially asymmetric resonating cavity that is equatorially symmetric. AAC 5800 does not generate unbalanced forces by operation of an EM wave within AAC 5800. AAC 5800 is not an embodiment of the present invention.

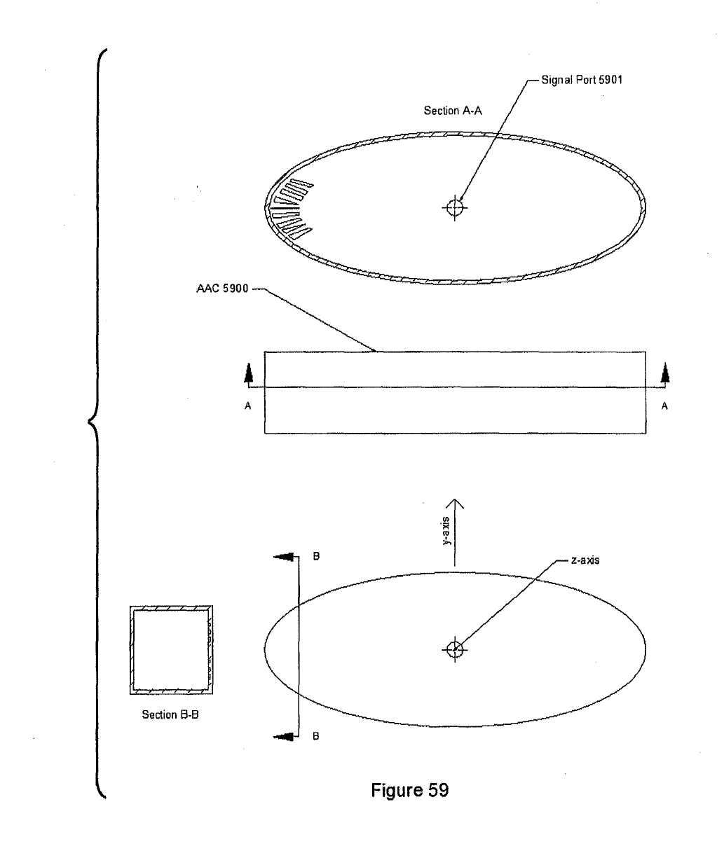

AAC 5900 is depicted in FIG. 59 and is an axially and equatorially asymmetric resonating cavity. AAC 5900 is identical to AAC 5800 except that AAC 5900 has asymmetric features added to AAC 5900. The asymmetric features added to AAC 5900 are depicted in FIG. 59 and are slots. AAC 5900 is an embodiment of the present invention and generates an unbalanced force which generates a torque around the y-axis of AAC 5900 when an EM wave of appropriate wavelength is resonated within AAC 5900.

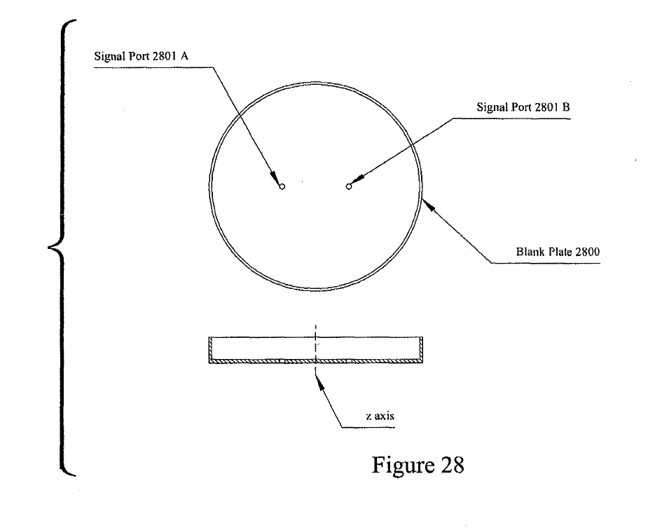

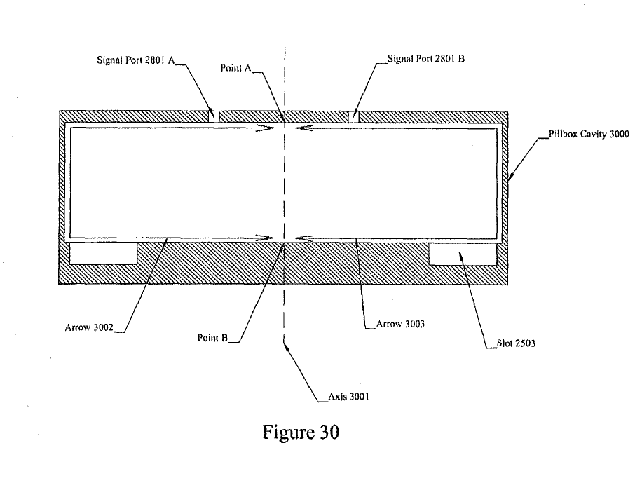

Pillbox 4300 of FIG. 43 is an axially symmetric resonating cavity. AAC 3000 of FIG. 30 is a pillbox type cavity and AAC 3000 is axially asymmetric. AAC 3000 is comprised of the union of Bottom Plate 2500 depicted in FIG. 25 and Blank Plate 2800 depicted in FIG. 28. AAC 3000 has 72 slots on the bottom half (Bottom Plate 2500) of the cavity (depicted in FIG. 25). The 72 slots are axially asymmetric features of AAC 3000. Signal Ports 2801 A and 2801 B of FIG. 28 are not axially asymmetric features of AAC 3000 since Signal Ports 2801 A and 2801 B are used to introduce and modulate EM energy into AAC 3000 and do not comprise more than 5% of the surface area of the interface between the inner cavity ails and the vacuum space of the cavity. If the 72 slots are removed from AAC 3000, then AAC 3000 would no longer be axially asymmetric and AAC 3000 would be an axially symmetric resonating cavity. The 72 slots of AAC 3000 are the axially-asymmetric features of AAC 3000.

AAC 3000 is not equatorially symmetric because no slice plane that is parallel to the x-y plane exists such that the two halves of AAC 3000 created by said slice plane are symmetric about said slice plane.

AAC 3000 does not have 2^{nd} axis symmetry since there exists no axis (which is not the z-axis) about which AAC 3000 has axial symmetry.

By appropriate design of an AAC, the time-averaged net-force vector created by the combination of the time-averaged net force vectors generated by the MFP and EFP mechanisms is not zero. The forces generated by the MFP and EFP mechanisms act alone and/or combine to create a linear and/or a rotational unbalanced force on embodiments of the present invention. In embodiments of the present invention, the MFP and EFP mechanisms may act alone on an AAC to create an unbalanced force. Embodiments of the present invention may generate unbalanced forces that are linear and/or angular (creating a change in linear momentum and/or angular momentum on bodies attached to the embodiments).

Axially-asymmetric cavities that do no generate unidirectional forces are known to those skilled in the art. Many AAC systems known to those skilled in the art are used for purposes other than to generate unidirectional thrust. Every resonating cavity that is axially-asymmetric does not necessarily generate an unbalanced force. Every resonating cavity that generates an unbalanced force by the MFP and/or EFP mechanisms of the present invention is axially asymmetric and/or has signal port(s) that create unbalanced force(s) by the MFP and EFP mechanisms. As of the date of the present application, no prior art exists regarding EM waves interacting with signal port(s) for the purpose of generating unidirectional forces on a resonating cavity.

### Magnetic Field Propulsion (MFP) Mechanism:

The MFP mechanism generates unbalanced forces in embodiments of the present invention by creating an imbalance in the magnetic-field-induced Lorentz forces created by the interaction of the EM wave magnetic field(s) interacting with the electric currents that flow on the inner conductive walls of a resonating cavity of the embodiment.

The AACs of embodiments of the present invention are a variety of shapes, but a pillbox cavity with axially-asymmetric surfaces (features) is an embodiment of the present invention which allows for illustration of the MFP mechanism. FIGS. 25, 28, and 30 represent Pillbox Cavity 3000. Pillbox Cavity 3000 is an AAC. Pillbox Cavity 3000 has axially-asymmetric surfaces that interact with the magnetic fields of a TM₀₁₀ EM wave operating within Pillbox Cavity 3000 to create a unidirectional force. FIG. 28 depicts Blank Plate 2800 and Blank Plate 2800 is the top plate of Pillbox Cavity 3000. Pillbox 3000 is formed by the union of Blank Plate 2800 with Bottom Plate 2500. The two holes in the Blank Plate 2800 are coupling ports (signal ports) used for powering Pillbox Cavity 3000 and for connecting a feedback control circuit. FIG. 25 depicts Bottom Plate 2500. Bottom Plate 2500 has 72 slots which comprise axially asymmetric features of Pillbox Cavity 3000. Slot 2503 depicts 1 of the 72 slots of Bottom Plate 2500. All of the slots of Bottom Plate 2500 are identical in shape to Slot 2503. Any number of axially-asymmetric features may be used in an AAC of embodiments of the present invention and the asymmetric features of an AAC of embodiments of the present invention do not need to be uniform in shape.

A resonating EM wave operating in the first harmonic mode within Pillbox Cavity 3000 creates a standing wave with an electric field node at the equatorial wall of the cavity and a magnetic field node located along the centerlines of FIGS. 25, 28 and 30 (the z-axis). During operation of a TM₀₁₀ EM wave within Pillbox Cavity 3000, the electric and magnetic fields of the EM wave are 90 degrees out of phase in time. Because of the interference patterns created by the resonating EM wave, the electric field is most intense at the axial center of Pillbox Cavity 3000 and the magnetic field is most intense towards the outer walls of Pillbox Cavity 3000.

The slots in FIG. 25 represent axially-asymmetric features of Pillbox Cavity 3000. When Pillbox Cavity 3000 is resonated with a TM₀₁₀ EM wave, electric currents are created on the walls of Pillbox Cavity 3000. These electric currents will move on FIG. 30 from Point A along the walls of Pillbox Cavity 3000 to Point B, passing over the AAC inner wall surfaces located between the slots depicted on FIG. 25. The AC electric currents that travel on the inner walls of Pillbox Cavity 3000 follow the paths depicted by Arrow 3002, and Arrow 3003 in FIG. 30. A single pathway for AC currents is depicted as Arrow 2506 in FIG. 25. Seventy one additional identical pathways exist between the additional slots of FIG. 25. The arrows for these additional pathways are not depicted in FIG. 25.

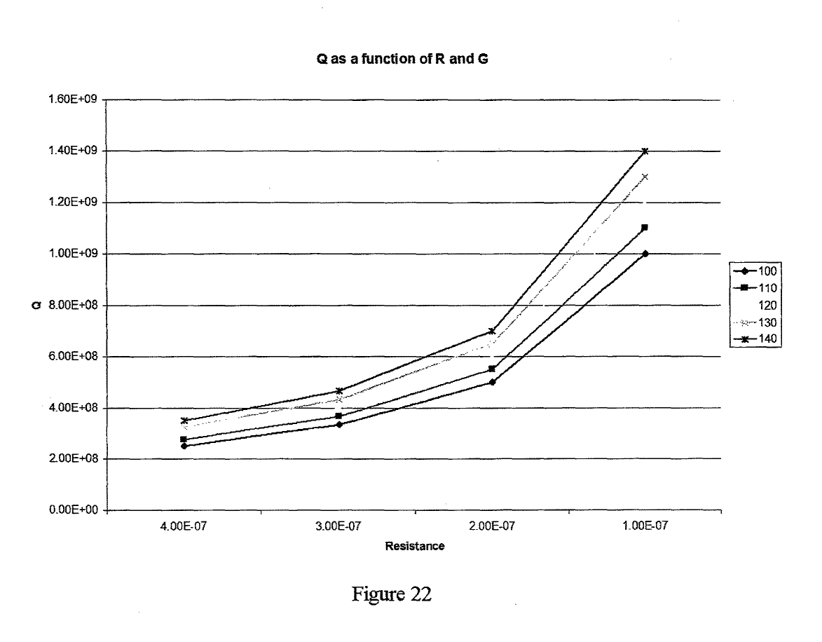

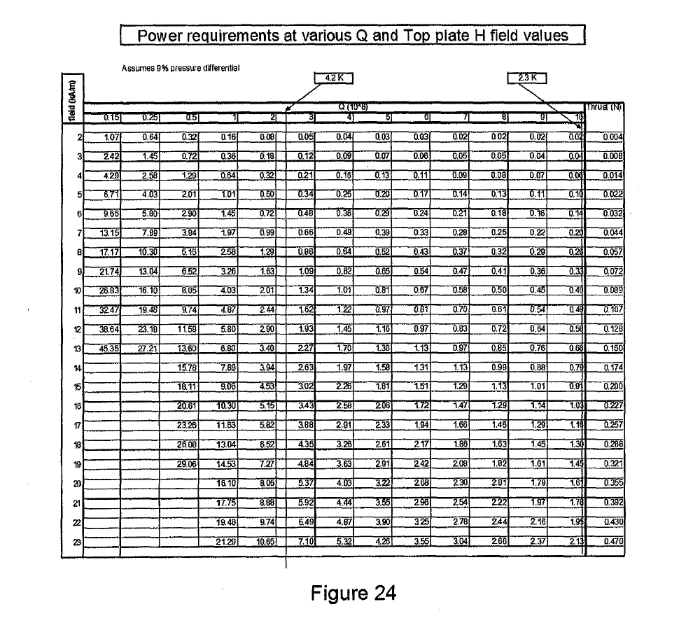

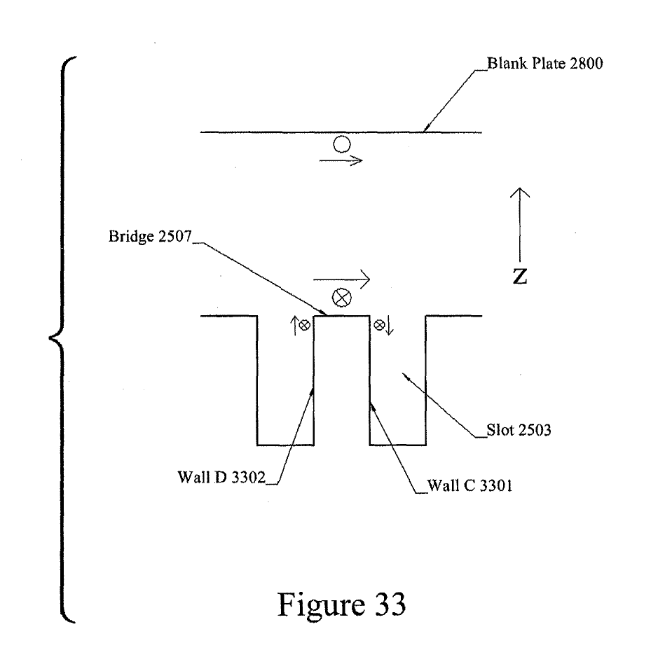

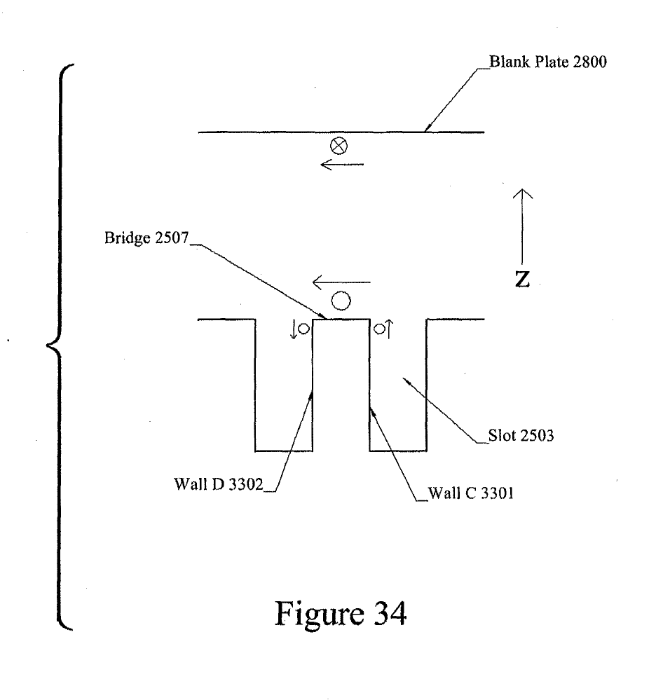

A detail view of the cross section (cross section at Cut Plane 2508 in FIG. 25) of Bridge 2507 is depicted in FIGS. 33 and 34. The AC currents that flow on the walls of the Pillbox Cavity 3000 will travel across the top of Bridge 2507 and some current will travel along the side walls of Bridge 2507. The AC current travels perpendicularly to the plane of FIGS. 33 and 34. In FIGS. 22 and 24, the AC currents are depicted as circles. The size of the circles represents the intensity of the AC current at that point on the walls of Bridge 507. The X in the circles of FIG. 33 depicts an AC current direction that is into the plane of FIG. 33 (away from the reader). The empty circles of FIG. 34 represent an AC current direction that is up from the plane of FIG. 34 (towards the reader).

During the first 90 degrees of the EM wave cycle, the electric current will travel as depicted in FIG. 33. During the second 90 degrees of the EM wave cycle, the electric current will travel as depicted in FIG. 34. The AC surface current changes in phase with the magnetic field intensity and direction of the magnetic field of the EM wave that operates within Pillbox Cavity 3000. The magnetic field lines are depicted as arrows in FIGS. 33, and 34. The size of the arrows in FIGS. 33 and 34 represent the intensity of the magnetic field at that point in Pillbox Cavity 3000. The arrow lengths are representative of the field strengths and the arrow lengths are not to scale. The z-direction arrow to the right of FIGS. 33 and 34 is not a magnetic field line. The z-direction arrow depicts the positive z-direction.

As the AC currents on the walls of Pillbox Cavity 3000 oscillate over Bridge 2507 during normal operation, some electric currents will be drawn onto the vertical walls located on either side of Bridge 2507. These vertical walls are depicted as Wall C 3301 and Wall D 3302 in FIGS. 33 and 34. The AC currents on Wall C 3301 and Wall D 3302 and on the top of Bridge 2507 will reach minimum and maximum amplitudes in phase with the minimum and maximum amplitude of the magnetic field of the TM₀₁₀ EM wave operating in Pillbox Cavity 3000.

When the currents on the walls of Pillbox Cavity 3000 interact with the magnetic field of the EM wave, a force is created. This force is the magnetic-field-induced component of the Lorentz Force. The direction of the force vector of said Lorentz force is always at right angles to both the current direction and the magnetic field direction and can be determined using the right hand rule of physics. The magnetic-field-induced Lorentz force in a resonating cavity will always be directed into the surface of the cavity walls that contain the resonating EM wave.

At every point on the walls of Pillbox Cavity 3000 where there is an electric current and a magnetic field interacting (due to the resonating wave), there exists a force pushing outward from the EM wave. The time average (over 180 degrees of wave cycle) of this outward force is always directed orthogonally to the wall containing the current and outwardly away from the EM wave magnetic field at the point of magnetic field-electric current interaction. The MFP induced unidirectional force on Pillbox Cavity 3000 is generated by the imbalance in z-direction MFF-induced Lorentz Force pressures exerted over the entire surface of the embodiment.

On the top plate (Blank Plate 2800) of Pillbox Cavity 3000, all electrons travelling above the area of the slots of FIG. 25 experience a positive z-directed MFF-induced Lorentz force. On Bottom Plate 2500 of Pillbox Cavity 3000, some of the electrons travel through the area of the slots along the side walls of the slots. Two of said walls are depicted as Walls C 3301 and Wall D 3302 in FIGS. 33 and 34. The electrons travelling along Wall C 3301 and Wall D 3302 experience a MFF-induced Lorentz force that is orthogonal to the z-axis and these electrons do not create time-averaged z-directed forces on the Pillbox Cavity 3000. Due to the identical geometries of the slots of Bottom Plate 2500 of Pillbox Cavity 3000, all side walls of the slots of Bottom Plate 2500 will experience non z-directed forces. The force vectors exerted by the MFF on the side walls of the slots of Bottom Plate 2500 are parallel to the x-y plane.

The electrons that travel along the top of Bridge 2507 experience a MFF-induced Lorentz force in the negative z-direction (due to symmetry of the bridges of Pillbox Cavity 3000, all bridges of Pillbox Cavity 3000 experience identical magnitude z-directed forces).

The time-averaged net z-directed force on Pillbox Cavity 3000 due to the MFP propulsion mechanism is the time-averaged sum of all z-direction MFF-induced Lorentz Forces exerted on the inner walls of Pillbox Cavity 3000. When all MFF-induced Lorentz forces are vector added over the entire surface of Pillbox Cavity 3000, a time-averaged net z-directed unbalanced MFF-induced Lorentz force pointing in the positive z-direction results. This time-averaged net-unbalanced z-directed Lorentz force generates unidirectional thrust on Pillbox Cavity 3000 and any body attached to Pillbox Cavity 3000.

The MFF-induced Lorentz force at a given point on a resonant cavity wall is proportional to the energy density of the magnetic field at said point. Over the area of the slots, all energy interacting with Blank Plate 2800 creates positive z-directed Lorentz forces.

Over the area of the slots on Bottom Plate 2500, most of the energy interfaces with Bottom Plate 2500 on the area of the bridge tops. This interaction creates negative z-directed forces. Some of the energy that interacts with Bottom Plate 2500 does so at the side walls of the slots (Wall C 3301 and Wall D 3302 are two of said side walls) and these interactions create no time-averaged z-directed forces.

The time-averaged net sum of all MFF-induced z-directed forces over the entire inner surface of Pillbox Cavity 3000 results in a time-averaged net positive z-directed force on Pillbox Cavity 3000. A unidirectional positive z-directed thrust is created by operating a TM₀₁₀ resonating EM wave in Pillbox Cavity 3000.

The electric-field of the TM₀₁₀ wave concentrates near the axial center of the cavity. The electric field energy of the EM wave primarily acts on the cavity in regions of the cavity that do not have axially-asymmetric features. Most of the electric field energy interacts with the cavity walls symmetrically. The EFF induced Lorentz force imbalance on Pillbox Cavity 3000 is much lower in magnitude than the MFF-induced Lorentz force imbalance. A net unbalanced Lorentz force (combined EFF and MFF) results from operating a TM₀₁₀ EM wave in Pillbox Cavity 3000.

The magnitude of the MFF-induced unidirectional force is proportional to the square of the magnetic field intensity within the cavity. The magnitude of the unidirectional force on Pillbox Cavity 3000 is directly proportional to the stored energy of the EM wave.

Pillbox Cavity 3000 represents one embodiment of the present invention. AACs of embodiments of the present invention with appropriately designed asymmetric features create an unbalanced force with the MFP mechanism.

The MFP force for embodiments of the present invention can be calculated numerically. It is ½ the time and surface integral of the permeability constant times the square of the surface current taken over the entire surface area of the cavity during 180 degrees of the wave period of the operating EM wave.

For linear thrusting on embodiments of the present invention, the MFP mechanism creates a linearly unbalanced force that is substantially parallel to the z-axis. For Pillbox Cavity 3000, the time-averaged net force induced by the MFP mechanism is parallel to the z-axis (due to cavity symmetries). At each point on the cavity walls, the time-averaged net z-directed MFF due to the MFP mechanism at that point is:

$$\overline{F} = - \frac{1}{2} {u}_{0} {\vert H \vert}_{max}^{2} ( \vec{n} \cdot \vec{z} ) \qquad Equation ( 2 )$$

F̅=the time-averaged net force at a given point of an AAC during 180 degrees of the wave cycle
   |H|ₘₐₓ=the magnetic field intensity at field max of the resonating wave in A/m
\vec{n}=the unit vector of the surface normal (pointing into the cavity from the wall surface)
\vec{z}=the unit vector parallel to the z-axis
   When the MFP force is integrated over the entire surface of an AAC of an embodiment of the present invention, a time-averaged net-unbalanced z-directed force results.

The MFP mechanism creates a net-force on cavity 3000 because:
1) Over the area of the slots, all of the surface currents on the inner surface of the Blank Plate 2800 of Pillbox Cavity 3000 interact with the magnetic field of the EM wave to create a MFF-induced Lorentz force with a vector pointing in the positive z-direction.
2) All of the surface currents located on the slot walls of Bottom Plate 2500 (Wall C 3301 and Wall D 3302 are 2 of said walls) interact with the EM wave magnetic fields to create time-averaged force vectors that point in a direction orthogonal to the z-axis. The MFF-induced Lorentz forces on Wall C 3301 and Wall D 3302 are parallel to the x-y plane and do not oppose the time-averaged MFF-induced Lorentz forces pointing in the positive z-direction exerted on Blank Plate 2800.
3) The AC electric surface currents on top of Bridge 2507 interact with the magnetic field of the EM wave and create a MFF-induced Lorentz force directed in the negative z-direction. This negative z-directed force opposes the Lorentz force that is exerted in the positive z-direction on Blank Plate 2800. The net MFF-induced Lorentz forces in the negative z-direction located on the bridge tops of Bottom Plate 2500 are less than the net MFF-induced Lorentz forces in the positive z-direction being exerted on the area over the slots on Blank Plate 2800.
4) When all time-averaged z-directed MFF-induced Lorentz forces on Pillbox Cavity 3000 are vector added, a time-averaged net-positive MFF-induced z-directed force on Pillbox Cavity 3000 results.
5) Embodiments of the present invention generate MFF and/or EFF-induced Lorentz forces on asymmetric features of the resonating cavities of the embodiments and said Lorentz forces have vector components parallel to the x-y plane that either:
   a. Vector add to cancel out.
   b. Generate a net x-y directed force vector which creates a torque around the z-axis. Creation of such a torque around the z-axis will generate angular thrust and that angular thrust may cause the embodiment to change the net angular momentum of the isolated system of the embodiment over multiple wave cycles. Embodiments of the present invention create torques using the MFP and or the EFP mechanism. Note: creation of net unbalanced angular forces will require axially asymmetric features that differ from the axially asymmetric features depicted in Pillbox Cavity 3000.
   c. Generate a net x-y directed force vector which creates a net linear force with a component parallel to the x-y plane.

In addition to the slots depicted in FIGS. 33 and 34, embodiments of the present invention use other axially-asymmetric features to generate unidirectional forces (linear and/or angular) by the MFP mechanism. These axially asymmetric features include, but are not limited to:
a) Pillars, and/or rods, and/or convex geometries, and/or concave geometries and/or other geometries that protrude from the base of the resonating cavity walls into the resonating cavity, and may or may not be uniform in geometry, and may or may not be uniform in location in the resonating cavity.
b) Slots, and/or etches, and/or convex and/or concave geometries that are cut into the top and/or bottom and/or side walls of the resonating cavity, and may or may not be uniform in geometry, and may or may not be uniform in location in the resonating cavity.
c) Other cavity wall surface geometries that create axially-asymmetric features.
d) Use of multiple materials and/or materials with non-homogenous properties to create axially-asymmetric features including using the orientation of the grain structures of conductive materials used on the cavity walls to create asymmetric features.
e) Use of reconfigurable cavity shapes and/or reconfigurable axially asymmetric feature shapes and/or reconfigurable axially asymmetric feature locations to modulate the magnitude and/or the direction of the unbalanced force vector generated by the MFP mechanism.
   An Embodiment of the Present Invention that Creates an Unbalanced Angular Force using the MFP Mechanism:

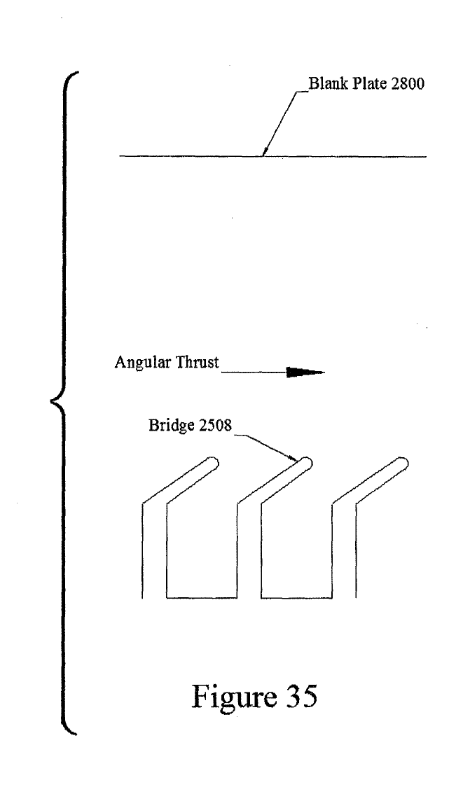

FIG. 35 represents the cross-sectional shape of a bridge that is substituted for Bridge 2507 on Bottom Plate 2500. The design of Bridge 2508 is substituted for all of the bridges of Bottom Plate 2500. A first harmonic EM wave operated in Pillbox Cavity 3000 (and all of the bridges of Bottom Plate 2500 have the design of Bridge 2508 instead of the design of Bridge 2507), a time-averaged net unbalanced force (torque) is created around the z-axis by the MFP mechanism. In addition, the MFP mechanism will create a time-averaged net-z-directed unbalanced force on Pillbox Cavity 3000 (Pillbox Cavity 3000 configured with bridges identical to Bridge 2508 instead of bridges identical to Bridge 2507).

Bridge 2508 represents one embodiment of an asymmetric feature that will create rotational time-averaged net force vectors on embodiments of the present invention. Other bridge designs that will create a time-averaged rotational net-force vector and/or a time-averaged net z-directed force vector are used in other embodiments of the present invention.

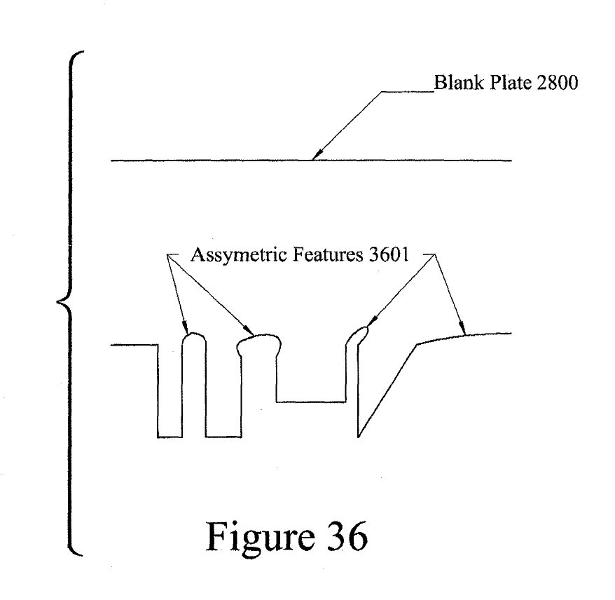

FIG. 36 depicts the cross-sectional shape of the axially-asymmetric features of an AAC configured with multiple non-identical axially-asymmetric features. Asymmetric features 3601 represent the non-identical axially-asymmetric features of an embodiment of the present invention. Other non-identical axially-asymmetric features and/or combinations of non-identical axially-asymmetric features are used with alternate embodiments of the present invention.

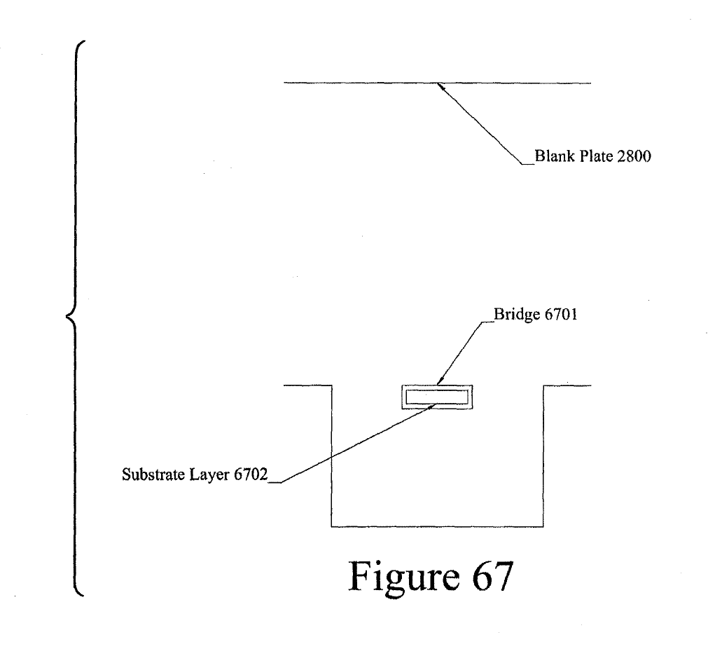

FIG. 67 depicts the cross-sectional shape of the axially-asymmetric features of an AAC configured with a bridge that has an opening that passes under the Bridge. Bridge 6701 is an axially asymmetric feature that has an epitaxially deposited superconductor layer over a substrate layer (Substrate Layer 6702). The open area beneath Bridge 6701 allows the magnetic field of the resonating EM wave to interact with the bottom side of Bridge 6701 and create positive z-directed forces on the underside of Bridge 6701. In embodiments of the present invention, Bridge 6701 is substituted for the axially asymmetric bridges of Bottom Plate 2500 of FIG. 25.

A variety of techniques known to those skilled in the art are used to create thin layers of conductive materials over substrate layers. These various coating techniques are used to manufacture embodiments of the present invention.

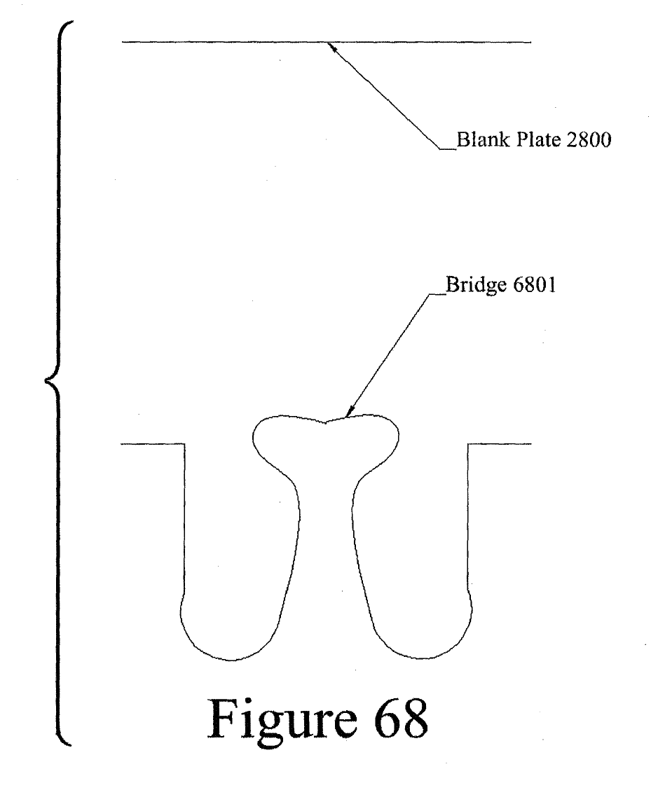

FIG. 68 depicts the cross-sectional shape of the axially-asymmetric features of an AAC configured with a bridge that has an irregular shape. Bridge 6801 is an axially asymmetric feature that is comprised of a homogenous Type II superconductor. In embodiments of the present invention, Bridge 6801 is substituted for the axially-asymmetric bridges of Bottom Plate 2500 of FIG. 25.

An Embodiment of the Present Invention that Uses an Axially-Symmetric, Equatorially-Symmetric Resonating Cavity with Signal Ports that Generate an Unbalanced Force Using the MFP Mechanism:

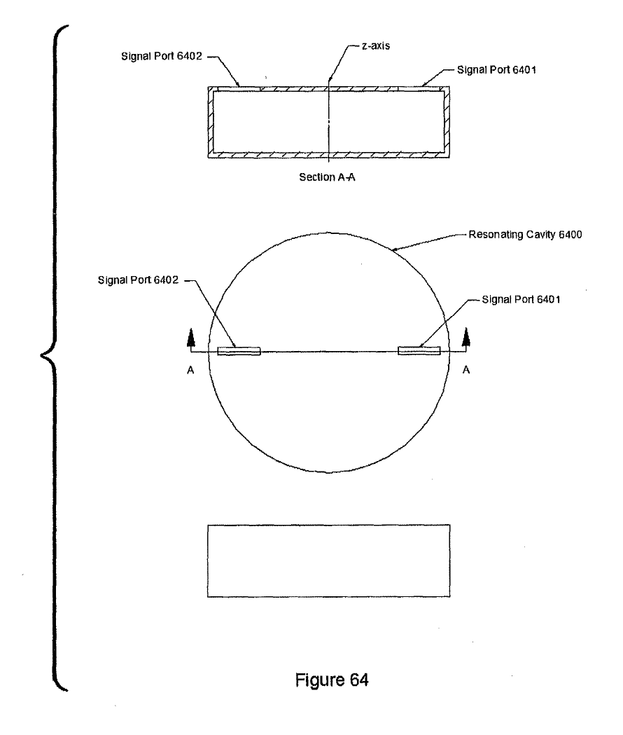

FIG. 64 depicts Resonating Cavity 6400. Resonating Cavity 6400 is an axially-symmetric and equatorially-symmetric resonating cavity. Signal Ports 6401 and 6402 are axially-asymmetric with respect to the z-axis of Resonating Cavity 6400.

Operation of a TM₀₁₀ EM wave within Resonating Cavity 6400 creates a time-averaged net unbalanced force in the negative z-direction on Resonating Cavity 6400. The unbalanced force is created primarily by the MFP Mechanism operating on the walls of Signal Ports 6401 and 6402. AC electric currents travelling along the vertical (parallel to the z-axis) walls of the signal ports create Lorentz forces on the vertical signal port walls and those Lorentz forces are orthogonal to the z-axis. On the lower half of Resonating Cavity 6400 beneath the signal ports, all Lorentz forces are parallel to the z-axis.

A time-averaged net imbalance in the z-directed MFF-induced Lorentz forces on Resonating Cavity 6400 is generated by operation of a TM₀₁₀ EM wave within Resonating Cavity 6400.

Operation of an EM wave within Resonating Cavity 6400 would generate no unbalanced forces if Signal Port 6401 and Signal Port 6402 were not present on Resonating Cavity 6400.

Because Signal Ports 6401 and 6402 are located in areas of high magnetic field and low electric field in Resonating Cavity 6400, the time-averaged MFF imbalance on the Signal Ports is greater in magnitude than the time-averaged EFF imbalance on said Signal Ports. A time-averaged, net linear Lorentz Force imbalance is thus generated on Resonating Cavity 6400.

### Electric Field Propulsion (EFP) Mechanism:

The EFP mechanism of the present invention generates unbalanced forces by creating an imbalance in the forces created by the interaction of the EM wave electric field(s) interacting with surplus electric charges located on the walls of embodiments of the present invention. The time-averaged net force vector created by the Electric Field Propulsion (EFP) mechanism of embodiments of the present invention can be substantially parallel to the z-axis or can be substantially parallel to the x-y plane. The EFP mechanism of the present invention creates a linear unbalanced force and/or an angular unbalanced force on embodiments of the present invention.

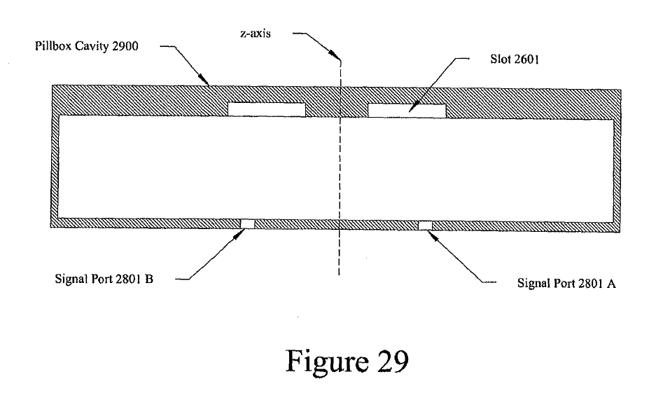

FIG. 29 depicts Pillbox Cavity 2900. Pillbox Cavity 2900 is comprised of Top Plate 2600, depicted in FIG. 26, and Blank Plate 2800, depicted in FIG. 28. Pillbox Cavity 2900 is configured with axially-asymmetric features that interact with the electric fields of a TM₀₁₀ EM wave operating within Pillbox Cavity 2900 to create a time-averaged, net-unbalanced z-directed EFF-induced Lorentz force on Pillbox Cavity 2900. Pillbox Cavity 2900 is an axially-asymmetric and equatorially-asymmetric resonating cavity.

Top Plate 2600 of FIG. 26 has 36 slots which comprise axially-asymmetric features of Pillbox Cavity 2900. Any number of axially-asymmetric features may be used in embodiments of the present invention and the asymmetric features of embodiments of the present invention do not need to be uniform in design or location on the resonating cavity of the embodiment. Blank Plate 2800 has two holes which are used as signal ports for powering Pillbox Cavity 2900 and for connecting a feedback control circuit to control EM wave energy in Pillbox Cavity 2900.

Slot 2601 of FIG. 26 represents one of the axially-asymmetric features of Pillbox Cavity 2900. Pillbox Cavity 2900 is resonated with a 1^{st} harmonic EM wave, causing electric charges to build up on the walls of Pillbox Cavity 2900. These surplus electric charges have the highest concentration on the upper and lower plates near the axial center of the Pillbox Cavity 2900. At points on the equatorial wall of Pillbox Cavity 2900, the surplus electric charge is always zero at the electric field node. The surplus electric charge densities on the walls of Pillbox Cavity 2900 reach a minimum and maximum magnitude in phase with the minimum and maximum amplitude of the electric field of the TM₀₁₀ EM wave operating in Pillbox Cavity 2900.

FIG. 29 depicts a cross-sectional view of assembled Pillbox Cavity 2900 that is comprised of Blank Plate 2800, depicted in FIG. 28, and Top Plate 2600, depicted in FIG. 26.

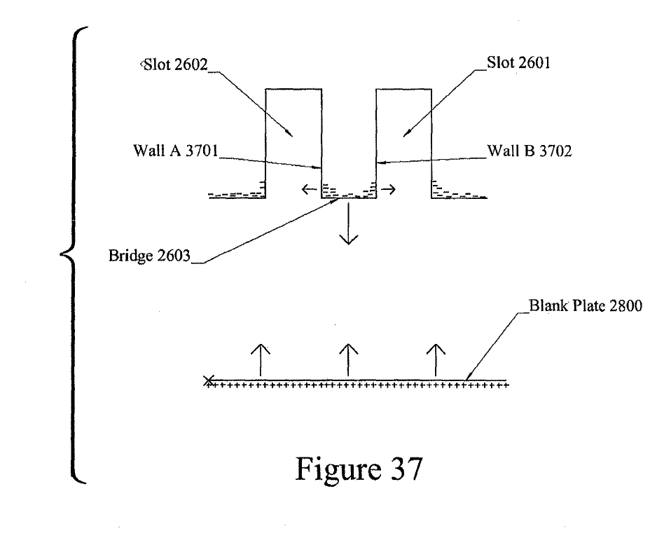

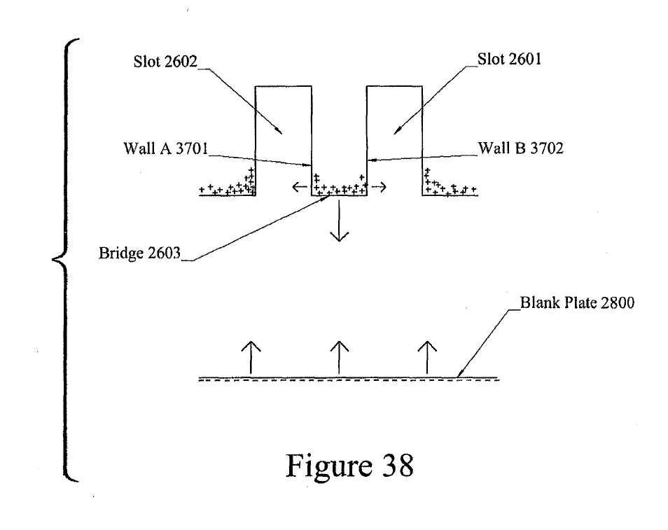

FIGS. 37 and 38 depict the cross-sectional shape of Slot 2601, Slot 2602 and Bridge 2603. A section of Blank Plate 2800 is also depicted in FIGS. 37 and 38.

During periods of operation of Pillbox Cavity 2900 with a TM₀₁₀ EM wave, surplus electric charges build up on the walls of Top Plate 2600 and Blank Plate 2800. FIG. 37 depicts the surplus electric charges of Pillbox Cavity 2900 at Slot 2601, Slot 2602, and Bridge 2603 during 90 degrees of EM wave cycle. The arrows of FIG. 37 (except for the z-axis arrow) depict the direction and magnitude of the force exerted by the electric field of the EM wave on the surplus electric charges located on the walls of Pillbox Cavity 2900 at Slot 2601, 2602, Bridge 2603, and on Blank Plate 2800 below Slot 2601, 2602, and Bridge 2603. In FIG. 37, the minus symbols on Bridge 2603, Wall A 3701, and Wall B 3702 depict surplus electron charges that build up on these walls during the 90 degrees of EM wave cycle. In FIG. 37, the plus symbols on the wall of Blank Plate 2800 depict a surplus of positive proton electric charges that exist on this section of wall during 90 degrees of EM wave cycle.

The electric field of the EM wave interacts with the surplus surface electric charges on the walls of Pillbox Cavity 2900 and create forces on said walls. The direction of the time-averaged force vector at each point on the wall where the electric field of the EM wave and a surface electric charge exists is orthogonal to said wall and points towards the electric field of the EM wave that creates the force.

Bridge 2603 experiences a time-averaged negative z-directed force. Wall A 3701 and Wall B 3702 also experience a force from the interaction of surplus surface electric charges and the electric field of the EM wave. The time-averaged force vectors on Wall A 3701 and Wall B 3702 are parallel to the x-y plane and create no z-directed forces on Pillbox Cavity 2900.

In FIG. 37, all of the positive surface electric charges on Bottom Plate 2800 experience a positive time-averaged z-directed force because of the interaction of the positive surplus electric charges with the E-field of the EM wave.

Pillbox Cavity 2900 experiences a time-averaged net positive z-directed force because the net negative z-directed force exerted by the electric field of the EM wave on surface electric charges located on Top Plate 2600 is less in magnitude than the net positive z-directed force exerted by the E-Field of the EM wave on surface electric charges located on Blank Plate 2800.

During the 2^{nd} 90 degrees of EM wave cycle, the polarity of the surplus electric surface charges on the walls of Pillbox Cavity 2900 reverses and the direction of the electric field of the EM wave reverses. FIG. 38 depicts the surplus electric charges of Pillbox Cavity 2900 at Slot 2601, Slot 2602, Bridge 2603, and a wall section of Bottom Plate 2800 during the 2^{nd} 90 degrees of EM wave cycle. During this 2^{nd} 90 degrees of wave cycle, Pillbox Cavity 2900 experiences the same net-positive z-directed force as Pillbox Cavity 2900 experienced during the 1^{st} 90 degrees of wave cycle.

The time-averaged (over 180 degrees of wave cycle) net z-directed force experienced by Pillbox Cavity 2900 by operation of a TM₀₁₀ EM wave within Pillbox Cavity 2900 is in the positive z-direction. The EFP mechanism of embodiments of the present invention produces an EFF-induced unbalanced Lorentz force in the positive z-direction. In the embodiment of Pillbox Cavity 2900, the unbalanced force generated by the EFP mechanism creates unidirectional thrust on Pillbox Cavity 2900 and any body attached to Pillbox Cavity 2900.

In addition to the slots depicted in FIGS. 37 and 38, other axially-asymmetric features can be used to generate EFF-induced unbalanced Lorentz forces (linear and/or angular) by the EFP mechanism. These axially-asymmetric features include, but are not limited to:
a) Pillars, and/or rods, and/or convex geometries, and/or concave geometries and/or other geometries that protrude from the base of the resonating cavity walls into the resonating cavity, and may or may not be uniform in geometry, and may or may not be uniform in location in the resonating cavity.
b) Slots, and/or etches, and/or convex and/or concave geometries that are cut into the top and/or bottom and/or side walls of the resonating cavity, and may or may not be uniform in geometry, and may or may not be uniform in location in the resonating cavity.
c) Other cavity wall surface geometries that create axially-asymmetric features.
d) Use of multiple materials and/or materials with non-homogenous properties to create axially-asymmetric features including using the orientation of the grain structures of conductive materials used on the cavity walls to create asymmetric features.
e) Use of reconfigurable cavity shapes and/or reconfigurable axially-asymmetric feature shapes and/or reconfigurable axially-asymmetric feature locations to modulate the magnitude and/or the direction of the unbalanced force vector generated by the EFP mechanism.

Pillbox Cavity 2900 produces a linear unbalanced force and Pillbox Cavity 2900 represents one exemplary embodiment of the present invention. Other embodiments of the present invention produce rotational unbalanced forces and/or linear unbalanced forces using the EFP mechanism.

The EFP mechanism of the present invention operates by creating an unbalanced force on the resonating cavities of embodiments of the present invention. Said unbalanced force is created by asymmetric interactions between the electric field of an EM wave and the electric surplus surface charges on the walls of the resonating cavity that contains the EM wave. The unbalanced force of the EFP mechanism may be linear and/or rotational.

The time-averaged z-directed force exerted at a point on the wall section of an AAC where surplus electric charge is located is:

$$\overline{F} = \frac{1}{2} {ɛ}_{0} {\vert E \vert}_{max}^{2} ( \vec{n} \cdot \vec{z} ) \qquad Equation ( 3 )$$

F̅=the time-averaged net force on the EMT during 180 degrees of the wave cycle
   |E|ₘₐₓ=the Electric field intensity at field max of the resonating wave in V/m
\vec{n}=the unit vector of the surface normal at the point
\vec{z}=the unit vector parallel to the z-axis

When the EFP force is integrated over the entire surface of an AAC of embodiments of the present invention, and over a 180 degrees of EM wave cycle, a time-averaged-net-unbalanced z-directed Lorentz force results.

Like the MFP mechanism, the EFP mechanism uses axially-asymmetric features of an AAC to reduce z-directed force vectors that oppose a desired direction of an unbalanced Lorentz force vector in embodiments of the present invention. Surfaces in the AAC of embodiments of the present invention that are not perpendicular to the z-axis will interact with the electric field of the resonating EM wave of embodiments of the present invention to produce force vectors that have a component vector that is parallel to the xy plane and said vector components do not contribute to z-directed forces on the AAC.

In embodiments of the present invention, the MFP and EFP mechanisms are designed to operate substantially in the same direction and both mechanisms contribute unbalanced forces to create a non-zero, time-averaged-unbalanced net Lorentz force. The combined force equation for MFP and EFP collinear z-directed force vectors generated by embodiments of the present invention is:

The total time-averaged Lorentz force on the cavity is calculated as:

$$\overline{F} = \frac{1}{2} {\int }_{S}^{ } {μ}_{0} {H}_{max}^{2} - {ɛ}_{0} {E}_{max}^{2} d a \qquad Equation ( 4 )$$

where:
F̅ is the time-averaged net Lorentz force on the cavity over a complete wave cycle of the resonant wave.
Hₘₐₓ is the maximum magnetic field during the wave cycle (A/m)
Eₘₐₓ is the maximum electric field during the wave cycle (V/m)
   Equation (4) takes into account the time integral of the electric and magnetic fields for a resonating cavity with the ½ (Hₘₐₓ)² and ½ (Eₘₐₓ)² terms.

FIG. 27 depicts a cross sectional view of Pillbox Cavity 2700 which is one embodiment of the present invention and is comprised of Top Plate 2600 and Bottom Plate 2500. Pillbox Cavity 2700 is operated with a TM₀₁₀ EM resonant wave. Signal ports for Pillbox Cavity 2700 are not depicted in FIG. 27. Pillbox Cavity 2700 has a combined MFP and EFP net force vector that is coincident with the z-axis and points in the positive z direction. The total unbalanced-time-averaged-net-force on Pillbox Cavity 2700 is calculated for the Pillbox Cavity 2700 by Equation (4).

Unbalanced force generation for embodiments of the present invention where the net-force vector generated by the MFP and/or EFP mechanisms are not coincident and/or are not coincident to the z-axis are also calculated with equation (4). If the time-averaged net unbalanced force vector does not pass through the center of mass of the cavity, then torques are induced on the cavity.

The vector sum of all MFP and EFP net unbalanced forces exerted over the entire surface of the resonating cavity and signal port(s) of the embodiment. This force may create a linear and/or a rotational net unbalanced force on the embodiment.

### Angular Unbalanced Force Generation:

The MFP and/or EFP propulsion mechanisms are used to create unbalanced linear and/or unbalanced angular forces on embodiments of the present invention. The geometries of the axially-asymmetric features of embodiments of the present invention are designed to generate unbalanced linear and/or unbalanced angular forces. When operated with a TM₀₁₀ EM resonating wave, the EFP and MFP mechanisms produce a time-averaged-net-z-directed unbalanced Lorentz force on the embodiment of Pillbox Cavity 2700. No unbalanced angular forces are produced on Pillbox Cavity 2700 since the MFP and EFP mechanisms acting on the axially-asymmetric features of Pillbox Cavity 2700 produce uniform x-y directed forces that cancel out when summed over the entire cavity.

Angular forces are generated in embodiments of the present invention by using axially-asymmetric features that interact with the fields of a resonating EM wave to produce time-averaged-unbalanced force vectors that have a vector component that is parallel to the x-y plane, and/or have a vector component that is parallel to the z-axis and not coincident with the z-axis, and/or create an time-averaged unbalanced Lorentz force vector that does not pass through the center of mass of the cavity. A variety of axially-asymmetric features' can achieve unbalanced angular forces in embodiments of the present invention. The axially-asymmetric features that can achieve unbalanced angular forces in embodiments of the present invention include, but are not limited to:
a) Slots in the cavity wall that are asymmetric with respect to all planes that intersect and are parallel to the z-axis.
b) Ridges, protrusions and/or wall features that protrude from the cavity wall and have a cross section that is asymmetric with respect to all planes that intersect and are parallel to the z-axis.
c) Use of multiple materials and/or materials with non-homogenous properties to create axially-asymmetric features including using the orientation of the grain structures of conductive and/or nonconductive materials used on the cavity walls to create axially-asymmetric features.
d) The axially-asymmetric features used to create unbalanced angular forces in embodiments of the present invention may be uniform or non-uniform in shape, uniform or non-uniform in position in the AAC, and uniform or non-uniform in materials and/or methods of construction.

### Axially Asymmetric Equatorially Asymmetric x-y Rotational Embodiment

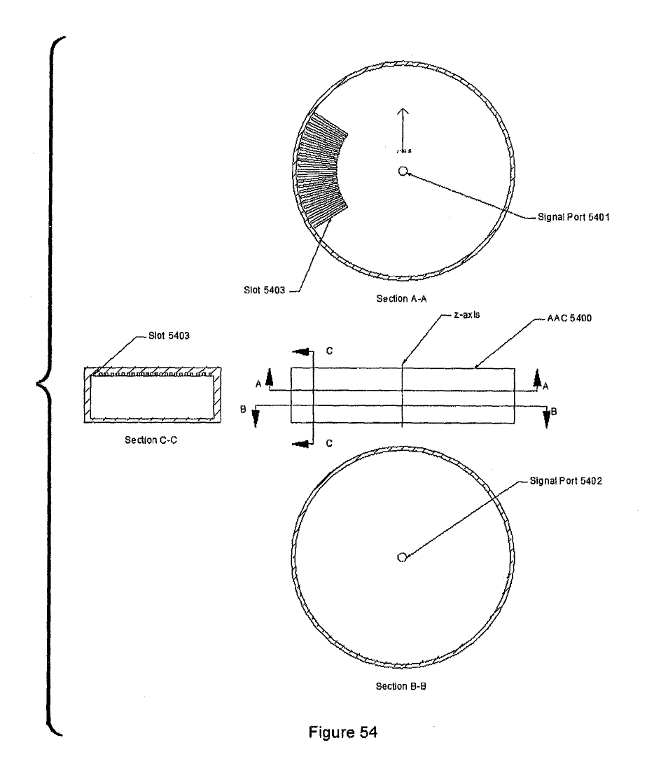

FIG. 54 depicts AAC 5400 which is an embodiment of the present invention that generates a time-averaged (over 180 degrees of EM wave cycle) angular net unbalanced force. AAC 5400 is axially asymmetric and equatorially asymmetric. Operation of a TM₀₁₀ EM wave within AAC 5400 generates a time-averaged, net-unbalanced force vector which is parallel to the z-axis of FIG. 54. The force vector generated by operation of AAC 5400 is not coincident with the z-axis. Operation of AAC 5400 generates a net unbalanced torque around the y-axis depicted in FIG. 54.

Rotation of AAC 5400 by 90 degrees about the z-axis causes operation of AAC 5400 to generate a time-averaged net unbalanced torque around the x-axis (x-axis not depicted in FIG. 54).

### Axially Asymmetric Equatorially Symmetric x-y Linear Embodiment

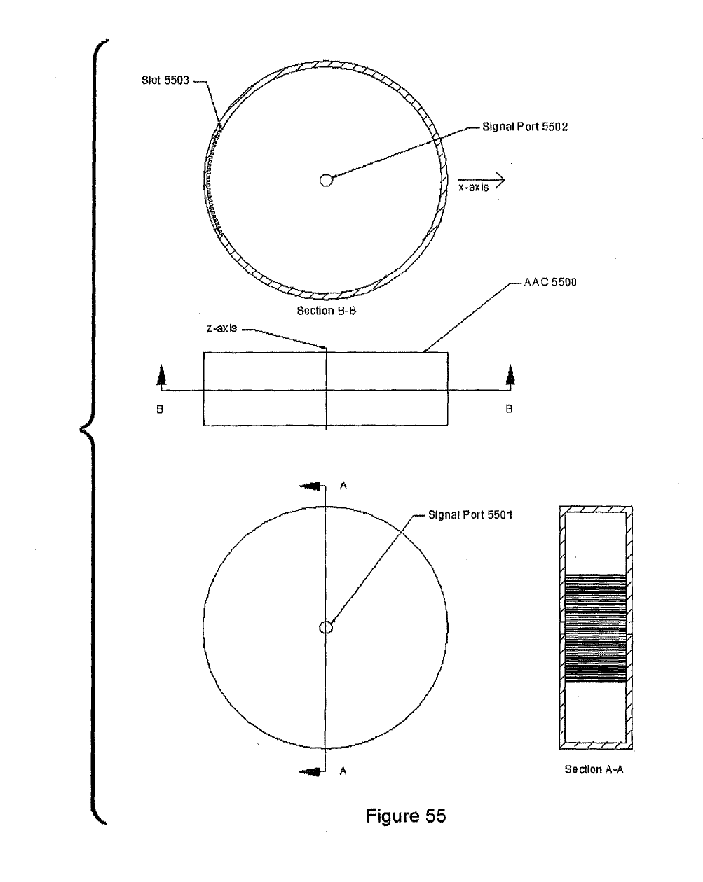

FIG. 55 depicts AAC 5500 which is an embodiment of the present invention that generates a time-averaged (over 180 degrees of EM wave cycle) linear unbalanced force that is parallel to the x-y plane. AAC 5500 is axially asymmetric and equatorially symmetric. Operation of a TM₀₁₀ EM wave within AAC 5500 generates a time averaged net unbalanced force in the positive x-direction. The x-axis is depicted in FIG. 55.

### Axially-Asymmetric, Equatorially-Symmetric x-y Linear Embodiment

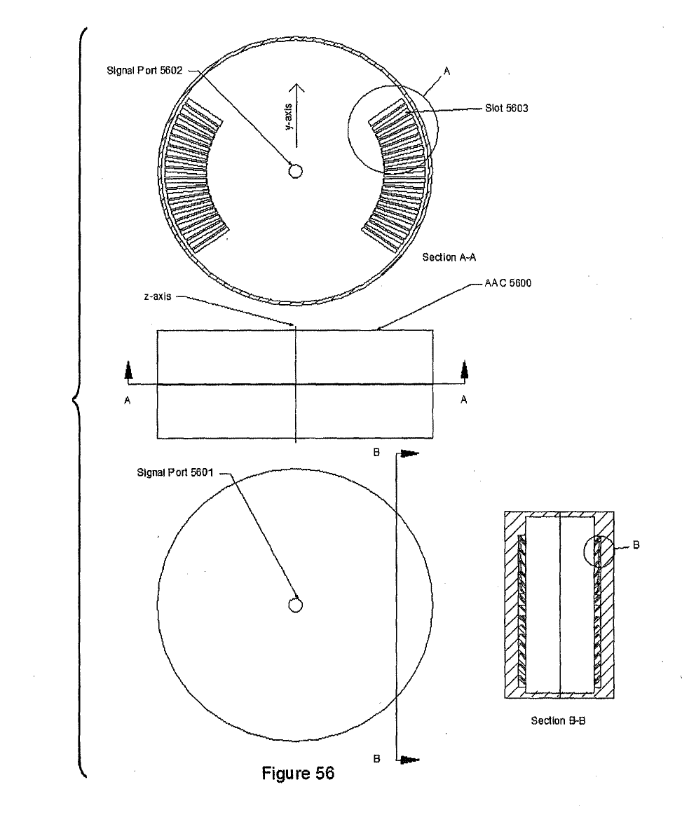

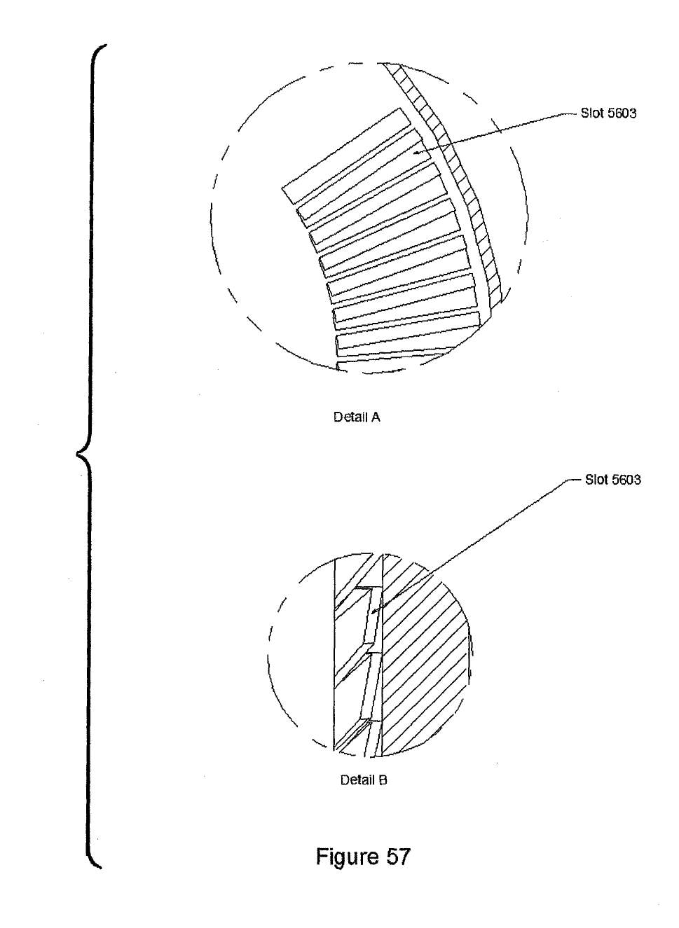

FIGS. 56 and 57 depict AAC 5600 which is an embodiment of the present invention that generates a time averaged (over 180 degrees of EM wave cycle) linear unbalanced force that is parallel to the x-y plane. AAC 5600 is axially asymmetric and equatorially symmetric. The top half of AAC 5600 (depicted in sectional view A-A of FIG. 56) is the mirror image of the bottom half of AAC 5600. The x-y plane is the plane about which AAC is equatorially symmetric.

Slot 5603 is one slot of AAC 5600 and Slot 5603 is an axially-asymmetric feature of AAC 5600. All of the slots on the walls of AAC 5600 are identical to Slot 5603 or are the mirror image of Slot 5603. A sectional detail (Detail B) of Slot 5603 is depicted in FIG. 57. AAC 5600 is also symmetric about the y-z plane

The Lorentz force exerted by the magnetic field of the EM wave on AC currents travelling on Slot 5603 create a net z-directed force and a net torque around the z-axis (z-axis torque is created by x-y directed force vector). Due to the symmetric design and placement of all slots on AAC 5600, all z-axis torques, z-directed forces, and x-directed forces cancel out. The y-directed forces exerted by the magnetic field of the EM wave on the AC currents travelling over all of the slots of AAC 5600 constructively add to create a time-averaged (over 180 degrees of EM wave cycle) net unbalanced y-directed force on the embodiment.

### Axially Asymmetric Equatorially Symmetric Rotational Embodiment

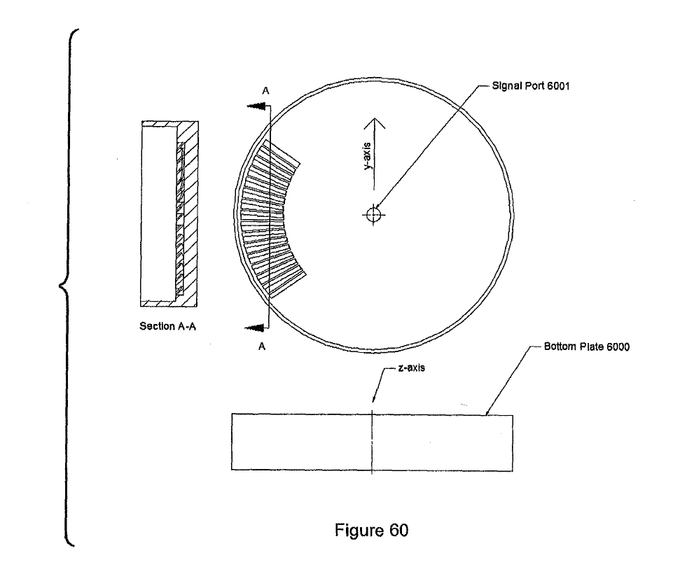

FIG. 60 depicts Bottom Plate 6000 of an embodiment of the present invention that generates a torque around the z-axis of the embodiment. The AAC of the embodiment is comprised of Bottom Plate 6000 in union with a plate that is the mirror image of Bottom Plate 6000 and the plates are aligned making the embodiment an axially-asymmetric, equatorially-symmetric cavity with no 2^{nd}-axis symmetry. The slots of Bottom Plate 6000 are identical to the slots of AAC 5600.

Operation of a TM₀₁₀ EM wave in the embodiment which is the union of Bottom Plate 6000 and the mirror image of Bottom Plate 6000 generates an unbalanced force which creates a torque around the z-axis of the embodiment.

### Axially-Asymmetric, Equatorially-Asymmetric Rotational Embodiment

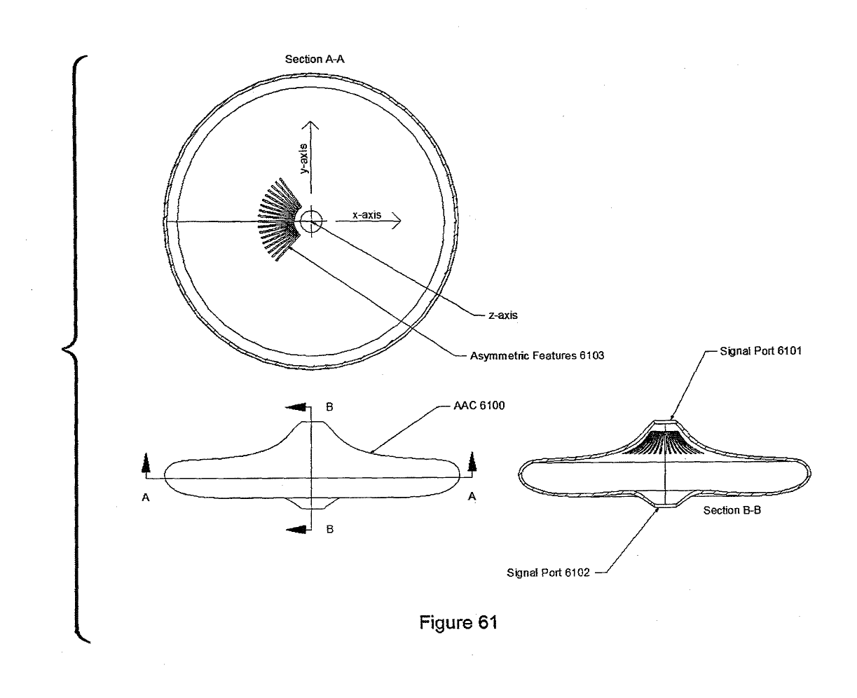

FIG. 61 depicts AAC 6100 of an embodiment of the present invention that generates a torque around the y-axis of the embodiment. AAC 6100 is an axially-asymmetric, equatorially-asymmetric cavity with no 2^{nd} axis symmetry. AAC 6100 is equatorially asymmetric because of the cross-sectional shape of AAC 6100. AAC 6100 is also equatorially asymmetric because of Asymmetric Features 6103 which are located above the x-y plane and have no mirror images located below the x-y plane.

Operation of a TM₀₁₀ EM wave in AAC 6100 generates an unbalanced force which generates a torque around the y-axis of the embodiment. The EFP mechanism operating on this embodiment of the present invention is the primary mechanism which generates the y-axis torque.

### Axially Asymmetric Equatorially Asymmetric Linear Embodiment

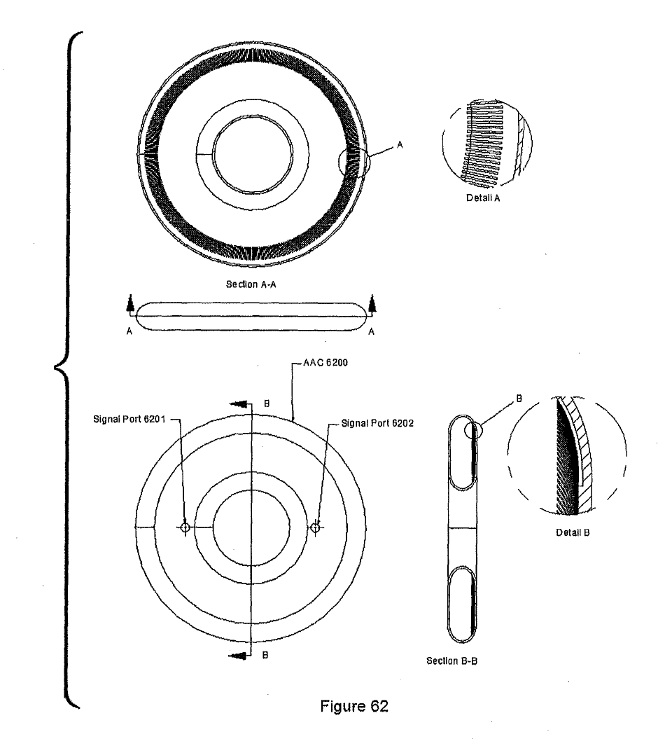

FIG. 62 depicts AAC 6200 which is an embodiment of the present invention that generates a linear unbalanced force that is parallel to the z-axis of AAC 6200. AAC 6200 is a axially-asymmetric, equatorially-asymmetric resonant cavity with no 2^{nd} axis symmetry. AAC 6200 is equatorially asymmetric because of slots located above the x-y plane of AAC 6200 are not mirrored below the x-y plane.

Operation of a resonating EM wave of appropriate mode within AAC 6200 generates a linear unbalanced force on AAC 6200 and said unbalanced force is parallel to the z-axis.

### Axially Asymmetric Equatorially Asymmetric Linear Embodiment

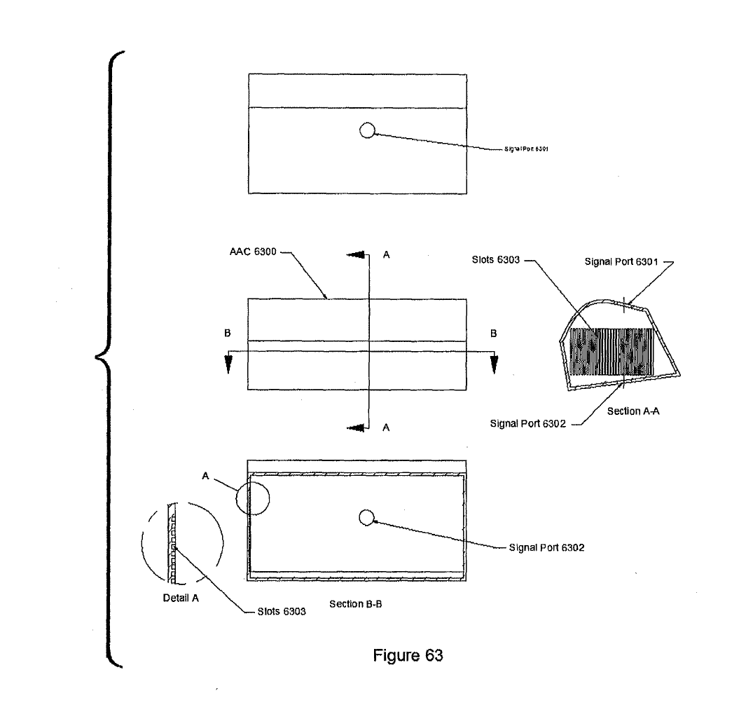

FIG. 63 depicts AAC 6300 which is an embodiment of the present invention that generates a linear unbalanced force that is parallel to the x-y plane of AAC 6300. AAC 6300 is an axially asymmetric, equatorially asymmetric cavity with no 2^{nd} axis symmetry.

Operation of a resonating EM wave of appropriate mode within AAC 6300 generates a linear unbalanced force on AAC 6300 that is parallel to the x-y plane.

### Quarter Wavelength Resonator Axially-Asymmetric, Equatorially-Asymmetric Linear Embodiment

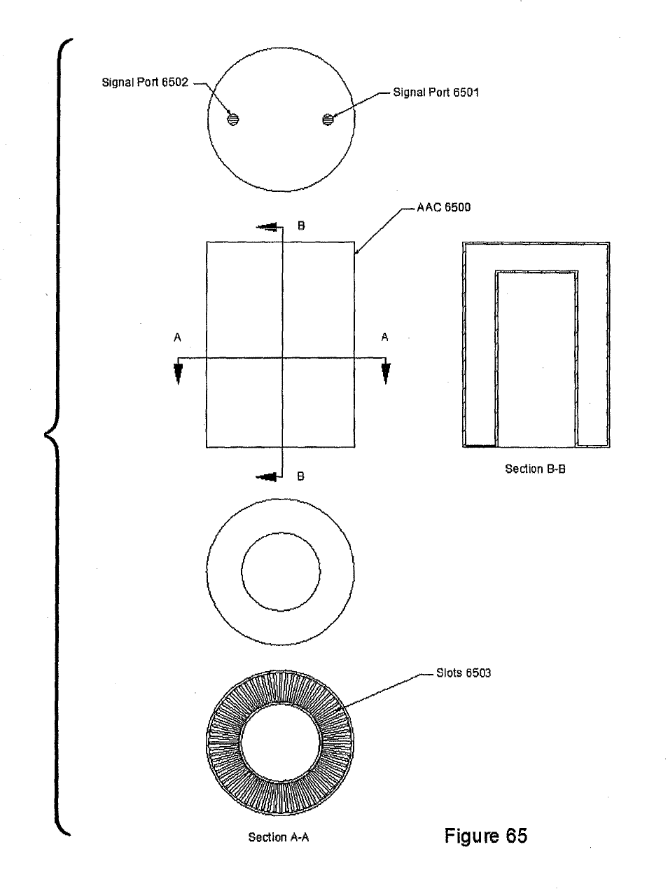

FIG. 65 depicts AAC 6500 which is an embodiment of the present invention that generates a linear unbalanced force that is parallel to the z-axis of AAC 6500. AAC 6500 is an axially asymmetric, equatorially asymmetric cavity with no 2^{nd} axis symmetry.

AAC 6500 is a quarter wavelength resonator with axially asymmetric features (Slots 6503).

### Axially Asymmetric Equatorially Asymmetric Rotational Embodiment

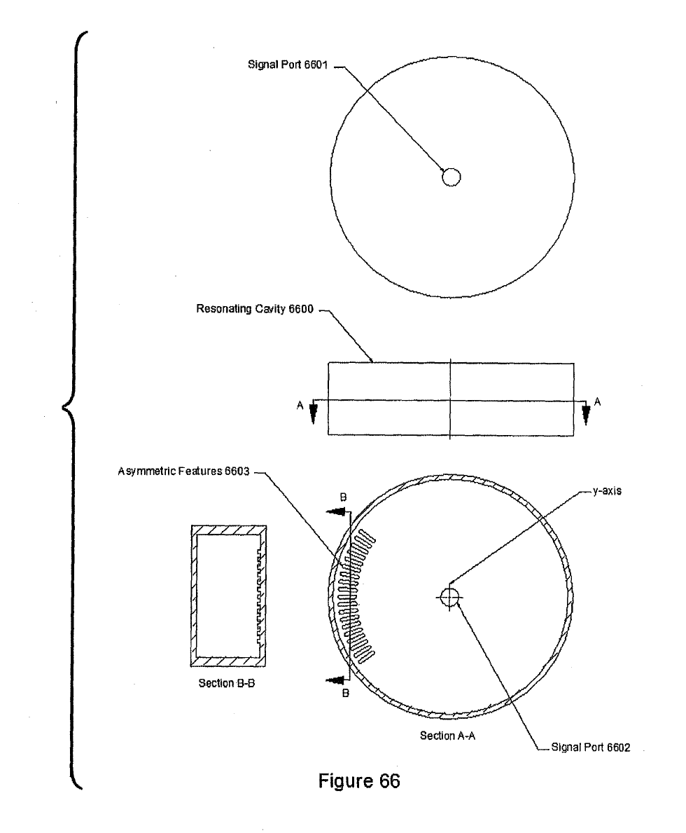

FIG. 66 depicts Resonating Cavity 6600 which is an embodiment of the present invention that generates a torque around the y-axis of FIG. 66. Asymmetric Features 6603 are convex protrusions.

### Momentum, Angular Momentum, and Energy Utilization in Embodiments of the Present Invention

### Momentum

The action of a moving body is defined as the integral over time of the Lagrangian that defines the motion of the moving body.

S=∫ₜ_{₁}^{t}^{₂}(KE−PE)dt
S=Action of the system in joule-seconds
KE=Kinetic energy of the system in joules
PE=Potential energy of the system in joules

The principle of least action states that a moving body will follow a path that minimizes the action of the system. If the moving body travels along an equipotential surface, then the potential energy term of Equation (5) is zero and the action of Equation (5) becomes the integral over time of the kinetic energy of the moving body. If no outside forces act on the system, the kinetic energy and momentum of the moving body remain constant.

In embodiments of the present invention, the contribution to the action of the potential energy term of Equation (5) is not zero. The resonating EM fields within the AAC of embodiments of the present invention provide energy to move the embodiment, causing a potential energy decrease of the EM wave. The energy of the EM wave interacts with the resonating cavity and/or signal port(s) wall(s) of the embodiment and generates an unbalanced force on the embodiment. The unbalanced force creates a momentum change on the resonating cavity of the embodiment. The EM wave has a time-averaged zero net momentum and does not change in momentum after generating the momentum change on the embodiment. The net momentum of the isolated system is changed by embodiments of the present invention.

In order for the action of Equation (5) to remain zero for a system where EM potential fields are present, at least one of several conditions must apply to the potential energy term of the Lagrangian (Equation (5)).
Eq (5) Condition A. The potential is a static field that interacts on the moving body such that the force exerted by the static field on the moving body acts equally in magnitude and oppositely directed on the entity that creates the static field (For example, a device that creates a static electric field which accelerates an ion experiences a force equal in magnitude and oppositely directed to the force exerted on the ion).
Eq (5) Condition B. The potential is a dynamic field which has a time-averaged (over 180 degrees of wave cycle) net-momentum vector. In propagating electromagnetic fields, the momentum of the EM field=E/c. An example of a system with a dynamic EM potential field with a time-averaged, non-zero momentum vector is a solar sail reflecting sunlight to accelerate the solar sail.
Eq (5) Condition C. The potential is a time-averaged, zero-net-momentum dynamic field that interacts symmetrically with the moving body (for example, a resonating EM wave acting in an axially-symmetric resonating cavity located on a satellite creates no time-averaged net force, no change in momentum, and no energy change on the closed system).

In the presence of EM potential fields, at least one of these three conditions (Eq (5) Conditions A,B, and/or C) for the potential energy term of Equation (5) is necessary for momentum to be balanced and for the action of the system to always remain zero when the integral of the action is calculated. These conditions are not applicable to embodiments of the present invention.

Embodiments of the present invention use a resonating EM wave operating within an axially-asymmetric resonating cavity (or on an axially-symmetric cavity with signal port(s) that interact with the EM operating wave to create asymmetric interactions on the cavity) to produce a time-averaged-net-unbalanced Lorentz force on the resonating cavity. The resonating EM wave is a dynamic field, but that dynamic field has a time-averaged zero-net-momentum vector. Through interference patterns created by the resonating EM wave, time-averaged net momentum of the resonating EM wave is always suppressed and the resonating wave always has a time averaged zero-net-momentum vector (There are some localized regions within the EM fields inside the resonating cavity that have a momentum vector, but these vectors cancel out when summed over the entire area of the cavity and over the 180 degree wave cycle of the EM wave within the cavity).

Because of interference patterns, the resonating EM wave always has a time-averaged zero-net momentum-vector. This resonating EM wave also acts asymmetrically upon the axially-asymmetric resonating cavity (or on an axially symmetric cavity with signal port(s) that interact with the EM operating wave to create asymmetric interactions on the cavity) to create an time-averaged net-unbalanced force. For the action of Equation (5) to be minimized within a single wave cycle kinetic energy and potential energy changes of the system must balance:

ΔKE+ΔPE=0 Equation (6)

Within a single wave cycle, the magnitude of the kinetic energy change of the moving system equals the magnitude of the change in potential energy of the field acting upon the moving system. In the case of static fields, dynamic fields with momentum vectors, and zero-net-momentum dynamic fields, the system changes potential energy by the exact magnitude of change in kinetic energy of the moving system.
a) In a static field, the source of the static field and the moving body conserve momentum, and the position of the center of mass between the two entities remains constant. Changes in the kinetic energy of the moving body are exactly balanced by the changes in the potential energy of the moving system within the static field.
b) In a dynamic EM field, the EM field changes in net momentum by E/c, with the magnitude of E being equal to the magnitude of the change in kinetic energy of the moving body. Momentum of the system of the EM field and the moving body is conserved. The magnitude of the change in EM field energy equals the magnitude of the change of kinetic energy of the moving body.
c) In embodiments of the present invention, a resonating EM wave acts on an axially-asymmetric resonating cavity (or on an axially-symmetric cavity with signal port(s) that interact with the EM operating wave to create asymmetric interactions on the cavity), and, within a single wave cycle the EM wave decreases in field energy by an amount equal in magnitude to the change of the kinetic energy of the moving body (the resonating cavity of the embodiment and bodies coupled to the resonating cavity) during the single EM wave cycle. Energy is conserved within a single wave cycle of the present invention since the EM field energy depletion creates the kinetic energy increase of the embodiment. The resonating EM wave performs work on the resonating cavity of the embodiment and changes the momentum of the resonating cavity. The resonating EM wave cannot change in net momentum, since the EM wave always has a zero-net-momentum vector. The EM wave imparts momentum to the resonating cavity of the embodiment and does not undergo any change in wave momentum since the net momentum of the EM wave is always zero. The momentum of the system (the resonating wave and the embodiment) is not constant within a single wave cycle or over multiple wave cycles.

Embodiments of the present invention create unidirectional thrust because the resonating EM wave has no net momentum and cannot balance the momentum change that the EM wave induces on a resonating cavity of an embodiment of the present invention. The EM wave energy acts asymmetrically upon the cavity walls and creates a unidirectional time-averaged net Lorentz force vector on the embodiment. During the EM wave interaction with the embodiment, the EM wave imparts momentum to the resonant cavity and carries no time-averaged net momentum change away from the EM wave-resonant cavity interaction. Unidirectional thrust without use of reaction mass is achieved.

### Conclusion:

a) Embodiments of the present invention create a time-averaged non-zero net unbalanced force which induces a net change in momentum on an isolated system.
b) When EM fields act on a system, an isolated system necessarily maintains constant momentum only when conditions Eq (5) Conditions A, and/or B, and/or C, can completely describe the potential energy EM field term of Equation (5). If the EM field cannot be completely described by said conditions, then an isolated system containing said EM field does not necessarily retain a constant net momentum.

### Angular Momentum

Embodiments of the present invention create unbalanced angular forces by two methods.

Method 1: Embodiments of the present invention create linear unbalanced forces on an AAC of the embodiment. The linear unbalanced force vector is not coincident with the center of mass of the body propelled by the embodiment, creating rotations of the propelled body around the center of mass of the propelled body.

Method 2: Embodiments of the present invention create angular unbalanced forces (torques) around the x-axis, and/or y-axis, and/or z-axis of the resonating cavity of the embodiment. The angular unbalanced forces create rotations of the embodiment and bodies attached to the embodiment.

Embodiments of the present invention use Method 1 and/or Method 2 to create angular unbalanced forces on bodies that are acted on by said embodiments.

The time-averaged, net-unbalanced angular forces generated by Method 1 and/or Method 2 of embodiments of the present invention create changes in the angular momentum of an isolated system. Over multiple wave cycles of the EM operating wave, embodiments of the present invention may also change the net rotational energy of the closed system (the combined potential and kinetic energy of the embodiment) with respect to the initial inertial reference frame of the embodiment.

### Energy in the Present Invention:

Embodiments of the present invention generate thrust without the use of reaction mass by creating an unbalanced Lorentz force on an axially-asymmetric resonating cavity (or on an axially-symmetric cavity with signal port(s) that interact with the EM operating wave to create asymmetric interactions on the resonant cavity). As a consequence of creating a unidirectional force, the present invention may (over multiple wave cycles of the EM operating wave) change the net energy of the closed system (the combined potential and kinetic energy of the embodiment) with respect to the initial inertial reference frame of the embodiment. Any device which generates an unbalanced force (creates thrust without the use of reaction mass) may change the net energy of a closed system (the combined potential and kinetic energy of the embodiment) with respect to the initial inertial reference frame of the embodiment. With the exception of embodiments of the present invention, such systems are not currently known.

### Single-Pulse Thrust Equation for the Present Invention:

Energy is conserved within a single EM wave cycle of embodiments of the present invention.

For a single EM wave cycle of embodiments of the present invention, the kinetic energy increase of a device that is thrust by the embodiment is balanced by a decrease in the electromagnetic field energy of the resonating EM wave contained within the resonating cavity of the embodiment of the present invention. Some photon energy from photons comprising the resonating electromagnetic wave within the resonating cavity of the embodiment is converted into kinetic energy of the body thrusted by the embodiment.

The single wave cycle kinetic energy change of a body propelled by embodiments of the present invention is given by:

$$Δ {E}_{{k}_{1}} = \frac{1}{2} m Δ {v}^{2} \qquad Equation ( 7 )$$

Where
m=mass of the thrusted body in kgs

Δv=velocity change of the thrusted body after 1 wave cycle in m/s
ΔEₖ_{₁}=kinetic energy change of the thrusted body after 1 wave cycle in joules

For a single thrust cycle of an embodiment of the present invention, a body attached to the embodiment will be accelerated from an initial inertial reference frame v₀ to a new inertial reference frame v₁ by a velocity change of Δv. The velocity change is calculated as:

$$\begin{matrix}Δ v = {v}_{1} - {v}_{0} \\ = \overline{a} Δ t \\ = \frac{\overline{a}}{f} ( single pulse velocity equation )\end{matrix} \qquad Equation ( 8 )$$

where
Δv=velocity change over 1 wave period in m/s
ā=Average acceleration of the thrusted body over 1 wave period in m/s²
f=frequency of the EM wave in s⁻¹ (180 degrees of the wave cycle)

$$\overline{a} = \frac{\overline{F}}{m}$$

m=mass of the thrusted body in kg
F̅=average net-force on the AAC of the present invention during 1 wave cycle of the resonating wave in newtons.

The kinetic energy imparted to embodiment of the present invention during one cycle is:

$$\begin{matrix}Δ {E}_{k 1} = \frac{1}{2} m Δ {v}^{2} \\ = \frac{1}{2} m {( \overline{a} Δ t )}^{2} \\ = \frac{1}{2} {m ( \frac{\overline{F}}{m} Δ t )}^{2} \\ = \frac{1}{2} {m ( \frac{\overline{F}}{mf} )}^{2} \\ = \frac{{\overline{F}}^{2}}{2 {mf}^{2}}\end{matrix}$$

Therefore, the kinetic energy increase of the thrusted body during one wave cycle, and the electromagnetic energy depleted from the resonating EM wave (from thrusting alone, additional energy will be depleted from the wave due to ohmic heating of the resonant cavity) for each cycle is:

$${E}_{k 1} = \frac{{\overline{F}}^{2}}{2 {mf}^{2}} ( single \text{-} pulse kinetic energy increase of embodiments of the present invention ) \qquad Equation ( 9 )$$

where Eₖₗ=kinetic energy increase of the thrusted body in joules per cycle

Equation (9), and single-wave-cycle thrusts of the present invention obey the principle of conservation of energy.

### Multiple Pulse Thrust Equation:

Over multiple wave cycles, the energy input from the resonating EM wave of embodiments of the present invention to the body propelled by the embodiment is given by the total number of EM wave cycles times the energy loss from the EM wave per single cycle (assumes steady state conditions during operation). The number of cycles is:

N=ft Equation (10)

where
N=number of wave cycles (dimensionless)
t=duration of embodiment operation in s
f=frequency of the resonating wave in s⁻¹

$${E}_{kw} = N \frac{{F}^{2}}{2 {mf}^{2}} ( N cycle energy depletion of EM wave ) \qquad Equation ( 11 )$$

where
E_{kw}=total energy depletion (due to thrusting) of the resonating wave over N wave cycles.

Equation (11) is not the kinetic energy increase of the thrusted body with reference to the initial inertial frame, v₀ of the thrusted body. Kinetic energy of embodiments of the present invention with respect to an initial inertial reference frame is as follows:

$${v}_{N} = N \overline{at} = \frac{N \overline{a}}{f} ( N pulse velocity equation ) \qquad Equation ( 12 )$$

Where v_{N}=velocity of a body thrusted by embodiments of the present invention with respect to an initial inertial reference frame after N pulses of the resonating wave.

$$\begin{matrix}{E}_{k 0} = \frac{1}{2} {mv}_{N}^{2} \\ = \frac{1}{2} {m ( N \overline{at} )}^{2} \\ = \frac{1}{2} {m ( \frac{N \overline{F}}{m} t )}^{2} \\ = \frac{1}{2} {m ( \frac{N \overline{F}}{mf} )}^{2} \\ = \frac{{N}^{2} {\overline{F}}^{2}}{2 {mf}^{2}}\end{matrix} \qquad Equation ( 13 )$$

Where Eₖ₀=kinetic energy increase in joules of a body thrusted by embodiments of the present invention after N wave cycles with respect to an initial inertial frame, v₀.

Over multiple wave cycles, there is a difference between the amount of energy depleted from the resonating EM wave (converted into kinetic energy of the thrusted body during each wave cycle) and the total amount of kinetic energy increase of the thrusted body with respect to an initial inertial reference frame, v₀ of the thrusted body. The energy difference is equal to Equation (13) minus Equation (9).

$$\begin{matrix}Δ {E}_{k} = \frac{{N}^{2} {\overline{F}}^{2}}{2 {mf}^{2}} - \frac{N {\overline{F}}^{2}}{2 {mf}^{2}} \\ = N ( N - 1 ) \frac{{\overline{F}}^{2}}{2 {mf}^{2}}\end{matrix} \qquad Equation ( 14 )$$

Where ΔEₖ=Net difference between the increase of the kinetic energy of a body thrusted by embodiments of the present invention with respect to v₀ and the energy depletion of the resonating EM wave of the embodiment of the present invention used to create the thrust which moves the thrusted body out of the v₀ inertial reference frame.

For a single cycle, N=1, and ΔEₖ=0 (energy is conserved)

For multiple thrusting cycles N>1 and ΔEₖ≠0. The kinetic energy imparted to a body thrusted by embodiments of the present invention with respect to the reference frames outside of the single pulse reference frame of the embodiment of the present invention is not equal to the electromagnetic field energy depleted from the resonating EM wave used to create the velocity change of the body by the embodiment of the present invention.

Equation (14) is valid for operation of embodiments of the present invention with uniform pulses and collinear, unidirectional force vectors. Energy changes created by multi-directional operation of embodiments of the present invention and/or periods of varying acceleration/deceleration using embodiments of the present invention can be calculated by summing individual thrusting segments that are uniformly pulsed and have collinear, unidirectional force vectors.

Embodiments of the present invention configured to create unbalanced angular forces may cause the embodiment to change the net angular momentum of the isolated system of the embodiment over multiple wave cycles. For pulse durations greater than once wave cycle, embodiments of the present invention create a rotational unbalanced force on a thrusted body. The unbalanced rotational force may create a differential between net rotational energy change (with respect to an initial rotational energy state prior to the first wave pulse) and the total EM field energy depleted from the resonating EM wave used to create the rotational energy change of the rotationally thrusted body.

### Conclusion:

Embodiments of the present invention create an unbalanced force which, over multiple wave cycles of the EM resonating wave, may create a change of net closed-system energy (with respect to an initial inertial reference frame). The net closed-system energy change (with respect to an initial inertial reference frame) is the result of linear and/or rotational kinetic energy changes created by embodiments of the present invention. The net closed-system energy change (with respect to an initial inertial reference frame) imparted by embodiments of the present invention are not necessarily equal to the EM field energy used to create said closed-system energy changes. An isolated body propelled by embodiments of the present invention can change the net energy of the isolated system with respect to reference frames outside of the closed system's reference frame.

### Multiple-Pulse Energy Balance for a Linearly Balanced Force (Energy is Conserved):

A projectile of constant mass m is accelerated by uniform interactions with a series of reaction mass objects.

Mᵢ=the reaction mass objects that interact with the projectile of mass m. All of the reaction mass objects are of equal mass Mᵢ. M is >>m.

Each reaction mass Mᵢ travels in a different inertial frame. M₀ travels in the v₀ frame. M₁ travels in the v₁ frame. M₂ travels in the v₂ frame and Mᵢ travels in the vᵢ frame.

The projectile of mass m starts in the v₀ frame and is accelerated in a series of pulsed accelerations with a succession of reaction mass objects. The projectile is accelerated from the v₀ frame to the v₁ frame by a push off of reaction mass M₀. The projectile is accelerated from the v₁ frame to the v₂ frame by a push off of reaction mass M₁. The projectile is accelerated from the vᵢ inertial frame to the vᵢ₊₁ inertial frame by a push off of reaction mass Mᵢ.

The difference between the energy required to accelerate the projectile in N pulses to a final velocity and the kinetic energy of the projectile with respect to the v₀ inertial frame is given by Equation (14). Overall system energy is conserved as the reaction masses Mᵢ decrease in kinetic energy with respect to the v₀ inertial frame by exactly the ΔE of Equation (14).

The accelerating forces between the projectile and the reaction masses Mᵢ are linearly balanced meaning that:
a) The accelerating force vector on the projectile of mass m is equal to and oppositely directed to the accelerating force vector acting on reaction mass Mᵢ.
b) For cases where M>>m, almost all of the potential energy that is converted to kinetic energy by the accelerating force is carried away from the interaction by the kinetic energy increase of the projectile. If M=∞, 100% of the kinetic energy created by the accelerating force is carried away by the projectile.
c) For multiple-pulsed accelerations of a projectile, a decrease of reaction mass kinetic energy (with respect to the v₀ frame of the projectile) is necessary to balance the ΔEₖ of Equation (14).

### Multiple-Pulse Energy Equations for a Linearly Unbalanced Force:

Embodiments of the present invention create a linearly unbalanced force. The resonating EM wave creates an unbalanced net force on the AAC of embodiments of the present invention. The resonating electromagnetic wave has a net zero-value Poynting vector and an approximately zero-value, time-averaged net momentum vector.

The interaction of the resonating EM wave with the walls of the resonating cavity does not create a change in the time-averaged net momentum of the resonating wave since the resonating wave has an approximately zero-value net time-averaged momentum. The electromagnetic wave creates an unbalanced Lorentz force and a momentum change on the resonating cavity of embodiments of the present invention, but the resonating EM wave cannot change in net momentum or transfer momentum because the wave has no time-averaged net Poynting vector. The EM wave of embodiments of the present invention cannot pick up or change momentum to balance the change of momentum that the EM wave imparts to the AAC.

During a single pulse of embodiments of the present invention, energy is conserved. The energy of the resonating EM wave is depleted as the AAC is accelerated by the unbalanced forces created by the interaction of the EM wave with the AAC walls. Energy must be added back into the resonating EM wave to allow for continuous operation (additional pulse cycles) of embodiments of the present invention.

During each successive EM wave cycle of embodiments of the present invention, energy is conserved within the inertial frame of the embodiment itself. Each pulse of the resonating EM wave does work on the embodiment by accelerating the embodiment. The energy depleted from the EM wave for thrusting the embodiment during each pulse is given by Equation (7). Additional wave energy will be depleted from the resonating EM wave by ohmic heating in the walls of the AAC. Energy is added to the resonating wave to make up for ohmic losses, and to make up for the EM field depletion due to imparting kinetic energy to the thrusted device.

In order to maintain constant acceleration for a constant mass, kinetic energy input required to accelerate a mass during a single pulse increases linearly with time duration of the pulse according to Equation 15 below:

$$\begin{matrix}\frac{d {E}_{k}}{d t} = \frac{d ( \frac{1}{2} {mv}^{2} )}{d t} \\ = \frac{d ( \frac{1}{2} {ma}^{2} {t}^{2} )}{d t} \\ = {ma}^{2} t\end{matrix} \qquad Equation ( 15 )$$

where
t is the time duration of the single pulse.
At time duration=0, no energy is required to accelerate the mass.
At time durations close to time duration=0, very small amounts of energy are required to accelerate the mass (compared to t>>0).

Embodiments of the present invention function with resonant wave frequencies in the Mhz to GHz range (other frequencies of operation are used by other embodiments of the present invention). The duration of a pulse is inversely proportional to the operating frequency of the EM wave. Short duration pulses will require very small EM wave energy inputs to achieve acceleration over the pulse period. Embodiments of the present invention convert EM field energy into kinetic energy of a thrusted body in very short-duration pulses. Since the velocity differential between the thrusted body velocity at the start and at the finish of the pulse is small, tiny amounts of energy are required to achieve vehicle acceleration during the pulse cycle.

For example: An embodiment of the present invention uses an 805 MHz AAC for accelerating a 5000 kg space vehicle with total continuous thrust of 5 newtons. To create this thrust, the embodiment would require 3.86×10⁻²¹ joules per cycle or 3.1×10⁻¹² watts of field energy to provide the 5 newtons of continuous thrust (numbers derived from input into Equation (9) and then multiplying the single pulse energy by the frequency to get the power requirements from the field). Additional energy is input to the field to makeup for ohmic losses in the cavity walls of the embodiment.

Note: A 5000 kg space vehicle that pushes off of Mᵢ reaction masses in vᵢ inertial frames (vᵢ frame is always the same frame as the satellite inertial frame after Nᵢ acceleration pulses) at a pulse frequency of 805 MHz would require the same 3.1×10⁻¹² watts power to generate a 5 newton continuous accelerating force on the satellite.

With every new pulse of the resonating EM wave, embodiments of the present invention start a new pulse of acceleration on the resonating cavity of the embodiment. The resonating EM wave thrusts the embodiment for a period of

$$\frac{1}{f}$$

seconds and then a new field is generated in the same inertial frame as the new inertial frame of the accelerated embodiment. During the pulse period when the EM wave thrusts the resonating cavity, power requirements to achieve the acceleration are very close to zero. This system of operation is analogous to starting a new journey with every cycle of the resonating EM wave.

The first step of the journey requires the smallest amount of energy, and the first step is the only one the embodiment ever takes.

Problem:

Using an embodiment of the present invention to accelerate a mass out of a v₀ frame to a v′ frame and then decelerating the system back to the v₀ inertial frame in a single pulse (for example: crashing a thrusted body into a wall) generates more energy than was input into the embodiment mass by the resonating EM wave of the embodiment.

Explanation:

Energy imbalance is a consequence of creating an unbalanced force. Equation (9) yields the same ΔEₖ result for an embodiment of the present invention as for a multiple pulse acceleration of a constant mass projectile with the reaction masses Mi (Mi>>than projectile mass) in inertial frames vᵢ. In the traditional projectile systems, the ΔEₖ is balanced by a decrease of reaction mass kinetic energy with respect to the initial inertial reference frame. For embodiments of the present invention, the unbalanced forces generated by the embodiment require no reaction mass.

Note:

Within the inertial frame of the embodiments of the present invention, energy is always conserved. For embodiments of the present invention to move uniformly from a v₀ frame to a v′ frame and then uniformly back to a v₀ frame, equal amounts of energy will be used by the resonating EM wave to accelerate the embodiment to v′ and then to decelerate the embodiment to v₀.

### Design Considerations

The axially-asymmetric resonating cavities of embodiments of the present invention (or embodiments that employ an axially-symmetric cavity with signal port(s) that interact with the EM operating wave to create asymmetric interactions on the cavity) are operated in the normal conducting mode and/or in the superconducting mode. Use of superconducting resonating cavity systems allows higher electric and magnetic field strengths to be reached in the resonating cavities of embodiments of the present invention. The higher field strengths achieved in superconducting resonating cavities generate greater unbalanced forces and increase the linear and/or rotational thrust of embodiments of the present invention.

### Materials and Methods of Construction:

A variety of materials and methods can be used to manufacture the resonating cavities of embodiments of the present invention. Any material that can support an electric current and an electric surface charge can be fabricated into a resonating cavity used in embodiments of the present invention. Those skilled in the art are aware of the materials and the methods required to make a resonating cavity that is capable of sustaining the electric and magnetic fields with field magnitudes appropriate for desired operation of embodiments of the present invention.

### Frequency of Operation

Embodiments of the present invention may operate at any frequency. Typically, the operating frequencies used in embodiments of the present invention range between 1 MHz and 50 GHz. The resonating cavities of embodiments of the present invention that operate with a TM₀₁₀ EM wave and operate at high frequencies will generate less thrust than TM₀₁₀ embodiments that operate at lower frequencies. The size of a TM₀₁₀ embodiment of the present invention is inversely proportional to the frequency of the TM₀₁₀ EM wave operated within the embodiment.

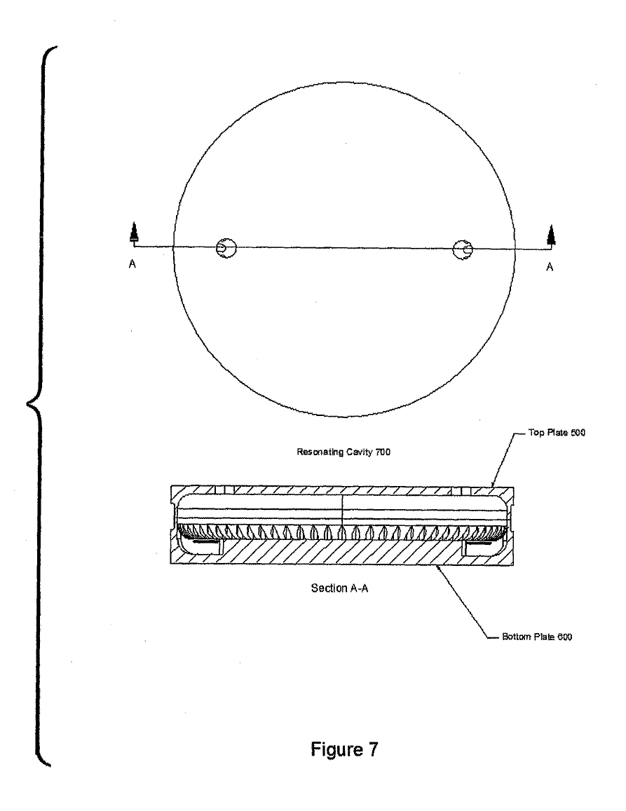

The chart below depicts the thrust generated by operation of a TM₀₁₀ EM wave operated in resonant cavities of embodiments of the present invention with geometry similar to the geometry of Resonating Cavity 700 of FIG. 7. All of the resonant cavities are scaled versions of Resonating Cavity 700 with frequencies listed in the first column. The chart lists the thrusts (in Newtons) generated by operation of a TM₀₁₀ wave in the embodiments with the magnetic field strength on the top plate over the slots of 25, 50, and 75 kA/m.

| | kA/m | | |
|---|---|---|---|
| Frequency | 25 | 50 | 75 |
| MHz | Thrust (Newtons) | | |
| 100 | 34.69 | 138.76 | 312.20 |
| 200 | 8.67 | 34.69 | 78.05 |
| 300 | 3.85 | 15.42 | 34.69 |
| 400 | 2.17 | 8.67 | 19.51 |
| 500 | 1.39 | 5.55 | 12.49 |
| 600 | 0.96 | 3.85 | 8.67 |
| 700 | 0.71 | 2.83 | 6.37 |
| 800 | 0.54 | 2.17 | 4.88 |
| 1000 | 0.35 | 1.39 | 3.12 |
| 1047 | 0.32 | 1.27 | 2.85 |
| 1500 | 0.15 | 0.62 | 1.39 |
| 3000 | 0.04 | 0.15 | 0.35 |

The lower frequency cavities are larger than the higher frequency cavities. The net force generated within the embodiments of the present invention is proportional to the surface area of the embodiments. Larger cavity sizes (with identical geometries) generate larger unbalanced forces.

The thrust numbers listed in the chart use a 9% net differential in z-directed MFP forces over the area of the slots of Resonating Cavity 700.

Higher frequency cavities will use more power per unit of thrust than lower frequency cavities since the ohmic losses in the resonant cavity walls is proportional to the square of the frequency of the EM wave operated within the cavity.

The unidirectional force generated by a TM₀₁₀ embodiment of the present invention is approximately inversely proportional to the square of the frequency of the embodiment.

The figures attached to the present application depict numerous embodiments of the present invention. The resonant cavities depicted in the figures may be of any size and the resonant cavities are scalable. For example, AAC 5500 of FIG. 55 may have a cavity diameter of 10 centimeters, or may have a diameter of 1 meter. The TM₀₁₀ frequency of the cavity is dependent on the cavity diameter. The larger diameter version of AAC 5500 has a lower frequency than the smaller diameter cavity. Operation of a TM₀₁₀ EM wave within either diameter for AAC 5500 generates unidirectional thrust on AAC 5500.

The diameter of AAC 5500 may be of any length. AAC 5500 may be operated at 5 GHz, 2 GHz, 500 MHz, 100 MHz, or any other frequency appropriate for the desired operation of the embodiment. AAC 5500 is scaled to the appropriate size required to generate desirable levels of thrust.

Embodiments of the present invention may be operated at any TM₀₁₀ frequency or higher mode frequency required by the operating parameters of the embodiment and/or application of the embodiment.

### Electric and Magnetic Field Strengths

The square of the field strengths of the EM wave are proportional to the thrust generated by embodiments of the present invention. A doubling of the magnetic field strength in an MFP driven embodiment of the present invention quadruples the unbalanced force generated by the embodiment. A doubling of the electric field strength in an EFP driven embodiment of the present invention quadruples the unbalanced force generated by the embodiment.

In embodiments of the present invention, the highest thrust possible is desirable. High thrust corresponds to high electric and/or magnetic field strengths in the embodiment of the present invention. In order to achieve the highest field strengths, superconducting materials are desirably used in the embodiment.

Each superconducting material has critical field strengths that limit the maximum field achievable for the superconducting resonating cavity of the embodiment. For example, niobium has a critical magnetic field of 0.198 Tesla. The maximum surface magnetic field sustainable in a superconducting embodiment using niobium is approximately 158,000 A/m. Superconducting embodiments of the present invention that utilize a resonating cavity with niobium as the surface conductor operate with magnetic fields of 0 to 158,000 A/m.

The Lorentz force exerted by a Magnetic field in a given point in resonating cavity of the embodiment is:

$$\overline{F} = \frac{1}{2} {u}_{0} {\vert H \vert}_{max}^{2}$$

And this force is directed perpendicularly to the walls surface and away from the magnetic field of the EM wave. Niobium generates a maximum Lorentz force of 15600 N/m². The differential in Lorentz force pressures on two opposite sides of a resonant cavity generates an unbalanced force in embodiments of the present invention. If the net differential in Lorentz force pressures is 10%, the embodiment generates a maximum of 1560 N/m² over the areas in the resonant cavity where the differential in Lorentz forces exists.

Current niobium manufacturing techniques known to those skilled in the art allow Niobium to reach a maximum surface electric field strength of approximately 100 MV/m. The EFP Lorentz force exerted by the electric field on surplus electric surface charges is:

$$\overline{F} = \frac{1}{2} {ɛ}_{0} {\vert E \vert}_{max}^{2}$$

This force is directed perpendicularly to the walls surface and towards the electric field of the EM wave. Niobium generates a maximum electric field force of approximately 44000 N/m². If the net differential in electric field force pressures is 10%, the embodiment generates a maximum of 4400 N/m² over the areas in the resonant cavity where the differential in the electric field forces exist.

Niobium-Tin is a superconducting alloy that has a critical magnetic field density of 25 Teslas corresponding to a maximum surface current of approximately 20 million A/m and a maximum Lorentz force of approximately 250 million N/m². Embodiments of the present invention that utilize Niobium-Tin operate with a maximum magnetic field strength of 20 million A/m.

The choice of conducting materials significantly affects the maximum operating fields of embodiments of the present invention.

Modulation of the electric and magnetic field strengths within embodiments of the present invention allows the embodiments to modulate the unbalanced force generation by the embodiment.

The embodiment of AAC 5500 may be comprised of Niobium-Tin, and this embodiment may be operated in a superconducting state with a maximum magnetic surface field strength of 20 kA/m, 100 kA/m, 1000 kA/m, 3000 kA/m or any other maximum magnetic surface field strength as long as the maximum surface magnetic field strength (at all points on the inner walls of AAC 5500) remains below the superconducting critical magnetic field strength of Niobium-Tin.

The embodiment of AAC 5500 may be comprised of Niobium-Tin, and this embodiment may be operated in a superconducting state with a maximum electric surface field strength of 1 MV/m, 5 MV/m, 10 MV/m, or 15 MV/m any other maximum electric surface field strength as long as the maximum surface electric field strength (at all points on the inner walls of AAC 5500) remains below the electric field level where significant surface emission occurs. Currently, the state of the art production techniques allow for Niobium-Tin superconducting alloys to be operated up to 15 MV/M. As techniques for the manufacture of superconducting Niobium-Tin alloys improve, higher (than 15 MV/m) maximum electric field operating strengths will be possible.

Embodiments of the present invention operate with inner conducting surfaces that have superconducting and non-superconducting regions. Appropriate electric and magnetic field strengths are used to prevent prohibitive ohmic losses on non-superconducting regions of the resonant cavity.

Embodiments of the present invention operate in normal conducting modes. In normal conduction operating mode, embodiments of the present invention require appropriate cooling to remove ohmic heating induced by the resistive heating on the walls of the resonant cavity.

### Geometry of the Axially Asymmetric Cavities:

A variety of axially-asymmetric features are incorporated into embodiments of the present invention. Features that generate linear, and/or rotational unbalanced forces are described in the present application. A variety of design factors are used to fabricate appropriate geometries for the asymmetric features of embodiments of the present invention. Design features include but are not limited to:
a) The number of asymmetric features incorporated into the design
b) The shape of the asymmetric features
c) The use of multiple, non-identical asymmetric features
d) The placement locations of the asymmetric features in the resonant cavity
e) The materials of construction for the resonant cavity and the materials of construction for the asymmetric features
f) The methods for fabrication of the resonant cavity and the methods for fabrication of the asymmetric features of the resonant cavity

Embodiments of the present invention are operated with high field strengths of the EM resonating waves within the resonating cavities of the embodiments. The high field strengths of the EM waves create strong electric fields and large electric currents on the resonating cavity walls. High electric fields at the cavity walls induce field emissions that impede or stop the generation of unbalanced forces by embodiments of the present invention. Large magnetic fields at the surface of the resonant cavity walls causes excessive power losses which impede the generation of unbalanced forces by embodiments of the present invention.

When operated in the superconducting mode, high surface currents can cause the superconducting materials of the cavity walls to exceed the material's critical current density and thus cause cavity quench to occur. Cavity quench causes embodiments of the present invention to significantly decrease generation of unbalanced forces.

Embodiments of the present invention use larger cavity sizes: Large cavity size allows for lower EM wave frequency. Lower EM wave frequency reduces heating per unit area in the walls of the resonating cavity and decreases power requirements per unit of unbalanced force generation. Optimization of cavity size depends on the material parameters of the cavity surface material (s) and overall weight and thrust requirements for the embodiment of the present invention.

The geometry features of embodiments of the present invention are optimized based on the intended use for the embodiment. A variety of numerical methods and design techniques known to those skilled in the art can be used to optimize the geometries of embodiments of the present invention.

### Signal Ports and Powering the Resonant Cavities

A variety of techniques are used to input power into the resonant cavities of embodiments of the present invention. Those techniques include, but are not limited to:
a) One or more signal cables coupled to the electric field of the resonating EM wave within the resonant cavity of the embodiment.
b) One or more signal cables coupled to the magnetic field of the resonating EM wave within the resonant cavity of the embodiment.
c) One or more wave guides coupled to the electric field of the resonating EM wave within the resonant cavity of the embodiment.
d) One or more wave guides coupled to the magnetic field of the resonating EM wave within the resonant cavity of the embodiment.

Embodiments of the present invention use one or more signal ports to couple the signal cable(s) and/or wave guide(s) to the resonant cavity of the embodiment. Embodiments may use single signal ports, or multiple signal ports to couple signal cable(s) and/or wave guide(s) to the resonant cavity of the embodiment. Embodiments of the present invention may use a combination of signal cable(s) and or wave guide(s) to power and modulate EM energy into the resonant cavity of the embodiment.

Embodiments of the present invention may use a signal cable to input power into the resonant cavity and use a waveguide for signal pickup. Alternatively, embodiments of the present invention may use a waveguide to input power into the resonant cavity and use a signal cable for signal pickup. Embodiments of the present invention may also use signal cables exclusively or waveguides exclusively for signal pickup and power input into the resonant cavity of the embodiment.

Those skilled in the art are familiar with techniques for inputting power and picking up signals from the EM fields within a resonant cavity and those techniques are used in embodiments of the present invention.

### Signal Generation

Embodiments of the present invention use electromagnetic energy to power the resonant cavities of the embodiments. A variety of techniques are used to generate the EM wave energy of appropriate wavelength for thrust generation in the embodiments. EM wave generation may be analog or digital. Techniques include, but are not limited to;
a) Analog methods including, but not limited to:
   Use of a Signal Generator.
   Use of a voltage controlled oscillator (VCO) which uses the error voltage output of the phase detector to tune the VCO output frequency. The oscillator may be one of several topologies, including but not limited to: A Colpitts oscillator, a Hartley oscillator, a Clapp oscillator, an N-core cross-coupled oscillator, and/or a Dielectric Resonator Oscillator (DRO). Each of these oscillator topologies uses a voltage variable tank circuit to vary the oscillator frequency.
b) Digital signal generation techniques including, but not limited to use of a Direct Digital Synthesizer (DDS). The error voltage from the phase detector is fed into an analog-to-digital converter (ADC) which controls the DDS, varying the output frequency of the DDS

Embodiments of the present invention use phase lock loop circuits to maintain EM wave energy within the resonant cavities of the embodiments at appropriate wavelength and power levels.

### Cooling Systems:

The resonating cavities of embodiments of the present invention require a cooling system to remove ohmic heating that occurs on the walls of the resonating cavity as AC electric currents oscillate on the cavity walls. A variety of cooling techniques capable of maintaining the embodiment of the present invention at appropriate operating temperatures are known to those skilled in the art.

Embodiments of the present invention use no cooling system and allow ohmic heat to radiate out from the resonating cavity walls to colder heat sinks. In space-based applications, embodiments of the present invention that use no cooling system remove ohmic heat from the resonating cavity of the embodiment by radiating ohmic heat to deep space.

### Vacuum Design:

Embodiments of the present invention operate with substantially evacuated resonating cavities. A perfect vacuum is desirable, but unachievable with current technology. The high vacuums of the resonating cavities of embodiments of the present invention allow for higher EM field strengths within said resonating cavities. Higher field strengths correspond to higher unbalanced force generation by the embodiments.

Embodiments of the present invention operate with resonating cavities that are not evacuated and said embodiments may contain air or other materials within the resonating cavity of the embodiment.

### Energy Sources and Powering the Resonating Cavities of the Embodiments:

The resonating cavities of embodiments of the present invention require energy sent into the resonating cavities in order to power the embodiments. Energy input into the cavities is used to replace ohmic heating losses that occur in the walls of the resonating cavity. Energy input into the cavity is also used to replace EM field energy that is depleted from the EM wave as the unbalanced forces generated by embodiments of the present invention do work on the resonating cavities of the embodiments.

A variety of energy sources can be used to power embodiments of the present invention. Any energy source that can be converted into electromagnetic energy is used to power the resonating cavities of embodiments of the present invention. Those skilled in the art are aware of the techniques available to convert energy sources into the electromagnetic energy that is required by embodiments of the present invention. Energy sources used to power embodiments of the present invention include, but are not limited to:
a) Solar
b) Chemical
c) Nuclear fusion/fission/radioisotope decay
d) Thermal
e) Battery
f) Matter/antimatter
g) Beamed energy from a remote power source

Electromagnetic energy is used to power the resonating cavities of embodiments of the present invention. The power levels into the resonating cavities of embodiments of the present invention, and the frequency of the electromagnetic energy being sent to the resonating cavities of embodiments of the present invention are modulated and controlled by a variety of techniques known to those skilled in the art. In the preferred embodiment of the present invention, a signal generator incorporated into a standard phase-locked loop used in linear accelerator applications is used to establish and maintain EM resonant energy in the resonating cavity of the preferred embodiment.

### Materials of Construction:

Low resistance materials: EM wave reflecting surfaces within the resonating cavity of embodiments of the present invention are desirably formed of a low resistance material that has a high reflectivity of the EM wavelength used for development of unbalanced forces. Lower resistance materials used on the reflecting surfaces within the cavity may minimize cooling and power requirements for operation of the embodiment. The ideal material for the reflecting surfaces is one that has zero AC electrical resistivity and that is able to withstand high magnetic fields and electric fields while maintaining AC superconductivity. No such AC superconductor is presently known to the inventor. However, materials are known that have low AC resistivities and high critical magnetic field strengths.

### Control of Embodiments of the Present Invention:

The unbalanced forces generated by embodiments of the present invention are modulated and controlled by appropriate control of the electromagnetic energy sent into the resonating cavities of embodiments of the present invention. The direction of the net force vector generated on the resonating cavity is modulated by controlling the orientation of the resonating cavity and/or by operation of multiple resonating cavities which generate non-coincident unbalanced force vectors, or by controlling the orientation of multiple resonating cavities with non-coincident unbalanced force vectors. In addition, some cooling systems of embodiments of the present invention require control in order to maintain appropriate temperatures for resonant cavity operation. Those skilled in the art are aware of a variety of cooling system configurations and control techniques which can maintain appropriate operating temperatures for embodiments of the present invention.

### System Configuration:

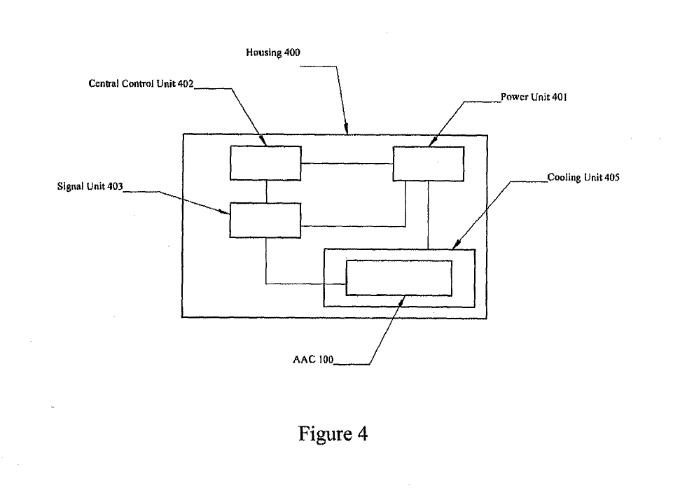

FIG. 4 represents an embodiment of the present invention. A variety of other configurations for other embodiments of the present invention are also possible. Housing 400 is connected to power unit 401, Central Control Unit 402, Signal Unit 403, AAC 100, and Cooling Unit 405.

AAC 100 is powered with EM field energy by Signal Unit 403. Signal Unit 403 also maintain energy levels inside AAC 100 at levels sufficient to achieve desired thrust levels.

Central Control Unit 402 uses a feedback control system to control Signal Unit 403. A variety of other feedback control systems are known to those skilled in the art and these other feedback control systems can be used for other embodiments of the present invention. Central Control Unit 402 contains a feedback control system that is a configuration of laser gyroscopes which monitors accelerations of Housing Unit 400 and modulates the level of energy inside of AAC 100 by instructions sent to Signal Unit 403. Modulated thrust of Housing Unit 400 (and all attached devices) is achieved by operation of the feedback control system of Central Control Unit 402.

Cooling Unit 405 modulates and controls the temperature of AAC 100. Cooling Unit 405 uses a set-point control loop to maintain AAC 100 at a temperature appropriate to achieve normal operation. A variety of cooling systems are available to cool the resonating cavities of embodiments of the present invention. Cooling Unit 405 contains a pulsed tube heat exchanger which is operated to remove ohmic heating from AAC 100. Cooling unit 405 is powered by Power unit 401.

The embodiment of the present invention depicted in FIG. 4 is used to generate unidirectional (linear and/or rotational) thrusting.

### Alternative Configurations

Embodiments of the present invention allow for versatile operations including, but not limited to:
a) Ability to modulate unbalanced force levels.
b) Ability to control direction of the unbalanced force and unidirectional thrusting.
c) In addition to unidirectionally thrusting in 3 directions, embodiments of the present invention are used to control yaw, pitch, and roll of embodiments of the present invention and bodies attached to embodiments of the present invention.
d) Ability to use a variety of power sources to generate unbalanced forces.
e) Ability to create unbalanced forces using higher EM wave resonating operating modes (2nd harmonic, 3rd harmonic, 4th harmonic, etc.)

### 6-Axis Motion Control

Embodiments of the present invention only generate z-direction unbalanced forces. Other embodiments of the present invention generate 6-axis motion and motion control. Control of 6-axis motion allows for thrusting of the embodiment of the present invention in the x, y, and z directions as well as controlling yaw, pitch and roll of the embodiment.

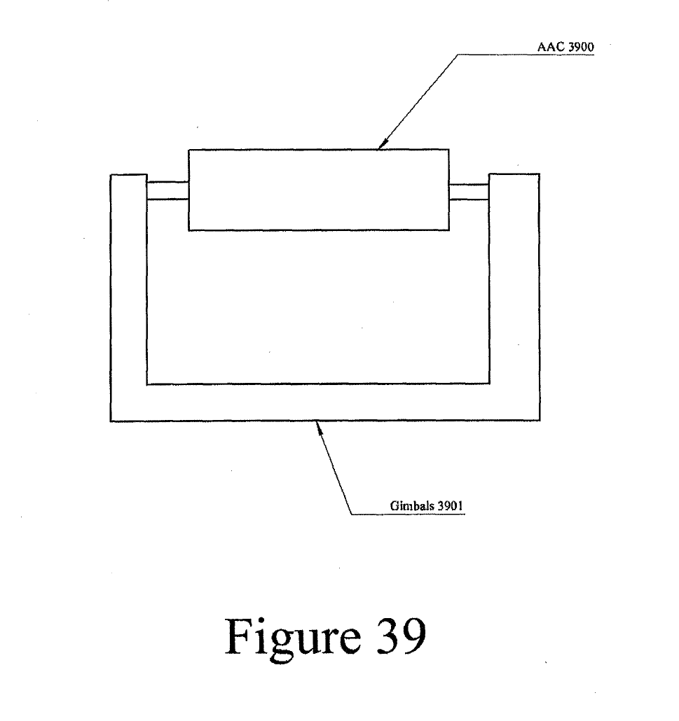

FIG. 39 depicts one exemplary embodiment of the present invention mounted in a 3-axis gimbal. Through rotation of AAC 3900 within Gimbal 3901, thrusting along any of the three linear axis (x,y and/or z) is achieved. In addition, the configuration depicted in FIG. 39 may create torques and rotate a body around said bodies center of mass when the force vector generated by AAC 3900 is not collinear with the center of mass of the body being thrusted.

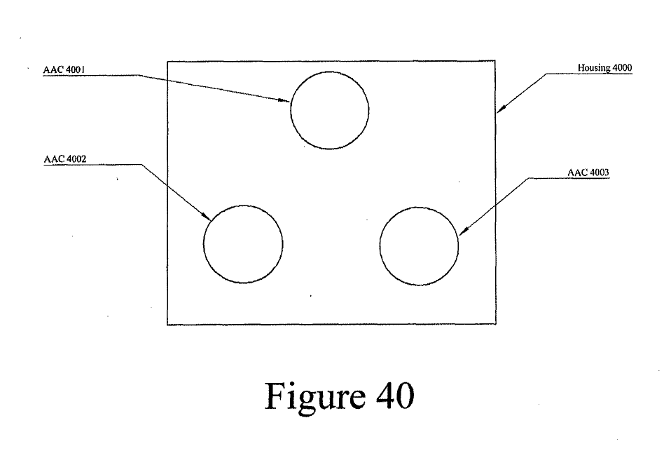

FIG. 40 depicts an exemplary embodiment of the present invention that uses three resonating cavity thrusters mounted on a housing to achieve 6-axis motion control. In FIG. 40, AAC 4001, 4002, and 4003 are attached to Housing 4000.

By modulation of the unbalanced forces generated within AAC 4001, AAC 4002, and AAC 4003, 6-axis motion control is achieved. In addition, AAC 4001, AAC 4002, and AAC 4003 are desirably movable on Housing 4000, so that AAC 4001, AAC 4002, and AAC 4003 may achieve 6-axis motion control while maintaining constant levels of unidirectional thrust generated by each cavity.

Modulation of unidirectional thrust magnitudes for embodiments of the present invention is accomplished by modulating the EM signal power into the resonating cavities of embodiments of the present invention. Higher power levels of EM energy into the resonating cavities of embodiments of the present invention create larger magnitude unbalanced forces.

### Higher Operating Modes

In the exemplary embodiment of FIGS. 1, 2, and 3, the exemplary propulsion system operates with a TM₀₁₀ standing EM wave. Embodiments of the present invention use higher resonating operating modes for the standing EM wave within the resonating cavity of the embodiment.

Higher harmonic operating modes of embodiments of the present invention also produce both linear and/or rotational unbalanced forces. The axially-asymmetric features of the AAC (or embodiments that employ an axially-symmetric cavity with signal port(s) that interact with the EM operating wave to create asymmetric interactions on the cavity) of higher EM wave operating mode embodiments of the present invention are positioned appropriately to create unbalanced Lorentz forces by the EFP and/or MFP mechanisms.

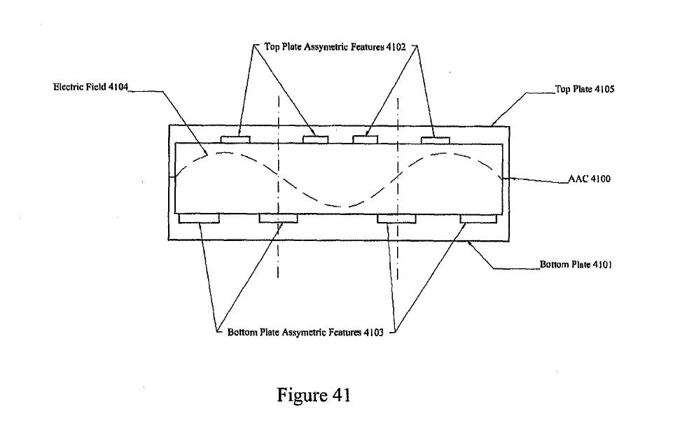

FIG. 41 depicts AAC 4100 which is an embodiment of the present invention that operates in the 3^{rd} harmonic mode within AAC 4100. AAC 4100 is a pillbox type cavity of cylindrical shape. The vertical dashed lines of FIG. 41 represent the electric field node of the EM wave operating in the 3^{rd} harmonic of AAC 4100. There is also another electric field node of the EM wave located on the equatorial wall of the AAC Electric Field 4104 depicts the electric field strength across the cross section of the AAC at a period in the wave cycle when the electric field energy is at maximum amplitude.

AAC 4100 depicted in FIG. 41 produces a unidirectional thrust in the positive z-direction. The Top Plate Asymmetric Features 4102 are depicted in cross section. These features are slots cut into the Top Plate 4105 and arranged in two circular sets of 72 slots.

Bottom Plate 4101 has Bottom Plate Asymmetric Features 4103 located in areas of high EM magnetic field strength. Bottom Plate Asymmetric Features 4103 are depicted in cross section and are slots cut into Bottom Plate 4101 and arranged in two circular sets of 72 slots.

Other embodiments of the present invention use other resonating cavity shapes operating in higher EM wave modes within the resonating cavity of the embodiment. These other higher EM operating mode embodiments of the present invention are used to develop linear and/or rotational unbalanced forces. FIG. 41 depicts one embodiment of the present invention that generates a linear unbalanced force and operates at a higher EM operating mode.

Any resonant mode of operation for the standing EM wave is possible for embodiments of the present invention. Different application requirements for embodiments of the present invention may require a variety of optimal standing EM wave operating modes.

Embodiments of the present invention may operate with more than one EM operating wave mode. AAC 4100 of FIG. 41 is depicted with a third harmonic EM wave (the dashed line of FIG. 41) operating within AAC 4100. Operation of a 1^{st} order (TM₀₁₀) EM wave within AAC 4100 also creates a time-averaged (over 180 degrees of EM wave cycle) unbalanced net force vector on AAC 4100. Embodiments of the present invention use multiple operating modes of the operating EM wave to modulate unbalanced force levels and/or to modulate the direction of a generated unbalanced force vector.

Note: Operation of a TM₀₁₀ EM wave within AAC 4100 will generate an unbalanced force vector which is parallel to the z-axis, and operation of a third harmonic EM wave within AAC 4100 generates an unbalanced force vector which is parallel to the z-axis. Embodiments of the present invention require features that differ than those depicted in FIG. 41 to achieve force vectors that are not coincident when the embodiments are operated with multiple EM modes. Features such as Bridge 2508 of FIG. 35 may generate non-coincident force vectors in embodiments that operate multiple EM operating waves within the single embodiment.

### Reconfigurabie Resonant Cavity

Embodiments of the present invention employ a reconfigurable resonant cavity. The reconfigurable resonant cavity has sections of the resonant cavity wall that are movable and/or reconfigurable. The reconfiguration of the resonant cavity walls is done for the purpose of modulating the magnitude and/or direction of the unidirectional force vector generated by the interactions of the EM wave with the resonant cavity.

Embodiments of the present invention also utilize reconfigurable resonant cavity walls to modulate the EM operating frequency of the embodiment.

An embodiment of the present invention is AAC 5500 depicted in FIG. 55. Slot 5503 is equipped with a piston actuator that adjusts the depth of slot 5503 (actuator not depicted in FIG. 55). Said piston actuator can modulate the depth of Slot 5503 from the position depicted in FIG. 55 to a depth which makes Slot 5503 flush with the cylindrical inner conducting surface of AAC 5500.

All slots of AAC 5500 are equipped with actuators identical to the actuator attached to Slot 5503. By modulation of the actuators to make all slots of AAC 5500 flush with the cylindrical inner conducting wall of AAC 5500, AAC 5500 is converted into an axially-symmetric resonating cavity and generates no unidirectional thrust. AAC 5500 can modulate the unbalanced force generated by the embodiment through modulation of the pistons which adjust the depth of the slots of AAC 5500.

In addition, modulation of the actuators on various slot configurations induces rotational unbalanced forces on AAC 5500. For example, modulation of the actuators to make the slot openings flush with the inner cavity wall for a 45 degree wide section of the cavity causes a rotational force to be developed by the embodiment when the embodiment is operated in the TM₀₁₀ mode

### Applications

Applications for embodiments of the present invention include, but are not limited to:

Satellite Propulsion:

Embodiments of the present invention are used to maintain satellite orbits and orientations, and to change satellite orbits and orientations. Six-axis motion control of satellites is provided by embodiments of the present invention. Embodiments of the present invention provide extensive advantages over other types of satellite propulsion systems including, but not limited to: extended satellite life, reduced satellite weight, increased satellite mission capabilities, reduced satellite complexity, and reduced satellite power requirements.

Some satellite-deployed embodiments of the present invention include, but are not limited to vehicles that:
a) Perform satellite propulsion missions known to those skilled in the art
b) refuel existing satellites
c) collect, redirect, and/or destroy space debris
d) change and/or retask satellite orbits
e) are directed at high speeds at targets for the purpose of releasing large amounts of kinetic energy on said targets

Leo to Geo Application:

Many satellites are launched to Low Earth Orbit (LEO). An additional class of satellite is launched to higher orbits including Geosynchronous Orbit (GEO). There exists a significant launch cost increase between launching a mass to LEO versus launching the same mass to higher orbits including GEO. Embodiments of the present invention are used to change the orbit of satellite and/or space probes from LEO to GEO and/or higher orbits, and/or orbits that allow transfer to deep-space destinations.

Embodiments of the present invention that are used to increase orbital heights of satellites and/or space probes provide numerous benefits including, but not limited to:
1) Significant launch cost reduction. Satellite and space probe mass is launched to LEO, and an embodiment of the present invention is then used to raise the vehicle to a desired orbit, or send the vehicle into deep space. The cost to launch mass to LEO is significantly less than the cost to launch mass to higher orbits and/or deep space transfer orbits. These costs are known to those skilled in the art.
2) Increased mass to orbit: In satellite and space-probe applications, it is desirable to send large mass vehicles beyond LEO to higher orbits, GEO and/or deep space destinations. Launch systems are limited in the amount of mass that can be sent to these higher orbits. By launching larger mass vehicles to LEO, and then raising the orbit of the mass to a desirable orbit (including deep space transfer orbit) using an embodiment of the present invention, significanity larger mass vehicles can be sent to higher orbits, GEO and/or deep-space destinations. Currently, the mass sent to these desirable orbits is limited by launch systems and this limitation is known to those skilled in the art.

Vibration Damping:

It is desirable to damp vibrations on satellites. The modulation of the unbalanced forces generated by satellite-mounted embodiments of the present invention are used to reduce and/or eliminate unwanted vibration and/or oscillation modes on the satellite.

Reaction Wheel Replacement:

Reaction wheels on satellites are known to those skilled in the art. These devices are used to control angular momentum of the satellite. Embodiments of the present invention are used on satellites to control the angular momentum of the satellite. Said embodiments are used in place of the reaction wheels and provide advantages over reaction wheel technology including lower weight, elimination of need to de-spin reaction wheels and ability of the embodiment to provide linear and angular thrusting of the satellite in a single system (which reduces satellite complexity).

Leo to Higher Orbits:

Embodiments of the present invention are used to transfer satellites and space vehicles to higher energy orbits including medium earth orbit, high earth orbit and orbits associated with destinations outside of the Earth-moon system.

Asteroid Deflection:

An embodiment of the present invention is configured to deflect, redirect, and/or destroy asteroids and/or comets. Redirection of asteroid trajectories is used for planetary protection, and/or scientific purposes, and/or for commercial purposes including but not limited to asteroid mining.

Deep Space and Planetary Exploration:

Embodiments of the present propulsion system are used to rapidly propel vehicles between distant points. Interplanetary, interstellar and deep space transit times are dramatically reduced by embodiments of the present invention compared with any other propulsion systems known to those skilled in the art. The rapid transit times enabled by embodiments of the present invention allow for rapid new manned and unmanned space missions to destinations in the solar system and outside of the solar system. Said rapid new missions are not currently practical with any propulsion system known to those skilled in the art.

The table below is a tabulation of the transit times from Earth to various planets in the solar system when using a continuous constant acceleration propulsion system. Transits to the planets are accomplished by continuous, constant acceleration to the half way point between Earth and the target planet, and then rotating the propulsion system (or rotating the unbalanced force vector which creates unidirectional thrust) 180 degrees and continuing constant acceleration (which decelerates the space vehicle with respect to the target planet) to the destination planet. The first row of the table (below the row listing the planets) is the minimum distance to the target planet from Earth in meters. At the constant acceleration (and deceleration) listed in column one, transit to the target planets (in days) is listed in each row corresponding to the constant acceleration value of column one. Relativistic effects are neglected in this table since maximum velocities remain under 3% of the speed of light.

| Acc. | Mars | Jupiter | Saturn | Uranus | Neptune | Pluto | |
|---|---|---|---|---|---|---|---|
| (m/s\hat{ }2) | 5.60E+10 | 5.88E+11 | 1.20E+12 | 2.57E+12 | 4.3E+12 | 4.28E+12 | |
| 0.01 | 54.8 | 177.5 | 253.6 | 371.1 | 480.0 | 478.9 | Transit Time in Days |
| 0.05 | 24.5 | 79.4 | 113.4 | 166.0 | 214.7 | 214.2 | |
| 0.10 | 17.3 | 56.1 | 80.2 | 117.3 | 151.8 | 151.4 | |
| 0.15 | 14.1 | 45.8 | 65.5 | 95.8 | 123.9 | 123.6 | |
| 0.20 | 12.2 | 39.7 | 56.7 | 83.0 | 107.3 | 107.1 | |
| 0.25 | 11.0 | 35.5 | 50.7 | 74.2 | 96.0 | 95.8 | |
| 0.30 | 10.0 | 32.4 | 46.3 | 67.8 | 87.6 | 87.4 | |
| 0.35 | 9.3 | 30.0 | 42.9 | 62.7 | 81.1 | 80.9 | |
| 0.40 | 8.7 | 28.1 | 40.1 | 58.7 | 75.9 | 75.7 | |
| 0.45 | 8.2 | 26.5 | 37.8 | 55.3 | 71.6 | 71.4 | |
| 0.50 | 7.7 | 25.1 | 35.9 | 52.5 | 67.9 | 67.7 | |
| 0.55 | 7.4 | 23.9 | 34.2 | 50.0 | 64.7 | 64.6 | |
| 0.60 | 7.1 | 22.9 | 32.7 | 47.9 | 62.0 | 61.8 | |
| 0.65 | 6.8 | 22.0 | 31.5 | 46.0 | 59.5 | 59.4 | |
| 0.70 | 6.5 | 21.2 | 30.3 | 44.4 | 57.4 | 57.2 | |
| 0.75 | 6.3 | 20.5 | 29.3 | 42.9 | 55.4 | 55.3 | |
| 0.80 | 6.1 | 19.8 | 28.4 | 41.5 | 53.7 | 53.5 | |
| 0.85 | 5.9 | 19.3 | 27.5 | 40.3 | 52.1 | 51.9 | |
| 0.90 | 5.8 | 18.7 | 26.7 | 39.1 | 50.6 | 50.5 | |
| 0.95 | 5.6 | 18.2 | 26.0 | 38.1 | 49.2 | 49.1 | |
| 1.00 | 5.5 | 17.8 | 25.4 | 37.1 | 48.0 | 47.9 | |
| 9.00 | 1.8 | 5.9 | 8.5 | 12.4 | 16.0 | 16.0 | |
| 9.50 | 1.8 | 5.8 | 8.2 | 12.0 | 15.6 | 15.5 | |
| 10.00 | 1.7 | 5.6 | 8.0 | 11.7 | 15.2 | 15.1 | |

Embodiments of the present invention are used to propel vehicles to planets in the solar system. Because embodiments of the present invention require no reaction mass, constant acceleration and deceleration over long time periods (days, months, and years) are economically and practically accomplished. Travel to planets in the solar system, and to targets outside of the solar system, are rapid and economical using embodiments of the present invention.

Light Speed and Planck Energy Propulsion:

Embodiments of the present invention are used to achieve extremely high velocities. The high velocity travel of embodiments of the present invention allow for fast, economical travel to destinations that are not practically reachable by current propulsion systems known to those skilled in the art.

With appropriate power sources (on board and/or off-board power sources), embodiments of the present invention accelerate continuously and can reach velocities that approach the speed of light (greater than 0.99 c). As the velocity of said embodiments increases, the apparent mass of these embodiments of the present invention with respect to initial inertial reference frames increases. The apparent mass cannot increase indefinitely. Once the apparent mass of the rapidly moving embodiment of the present invention reaches the Planck energy density, space time in the local region of the embodiment is warped with respect to an initial inertial reference frame, and a singularity is formed. The inventor of the present invention is unaware of the consequences of travel while an embodiment of the present invention is travelling at a velocity which causes said embodiment to reach the Planck energy density.

The energy imbalance (differential between energy input by the EM wave and the kinetic energy of the thrusted body with respect to an initial inertial reference frame) created by embodiments of the present invention, allows a variety of energy sources known to those skilled in the art to be used to achieve vehicle velocities which exceed 0.99 c.

In-Atmosphere Transport Applications:

Embodiments of the present invention produce accelerations which exceed 9.8 m/s². Vehicles equipped with these embodiments of the present invention are used to lift, move, and/or transport payloads. These embodiments of the present invention have significant economic and logistical advantages over current propulsion systems.

An embodiment of the present propulsion system transports cargo between distant points on earth by accelerating a cargo from an origin, through the atmosphere, accelerating and decelerating through space, and decelerating to a destination. The acceleration/deceleration phase of the trip through space is not restricted by atmospheric drag and high velocities are achieved. Transit times between origin and destination points are dramatically reduced (compared to other propulsion methods) by high velocity travel through space.

Launch Systems:

Embodiments of the present invention produce accelerations which exceed 9.8 m/s² on a vehicle. Said vehicles equipped with said embodiments of the present invention launch payloads into space. Said embodiments of the present invention have significant economic and logistical advantages over any other propulsion system known to those skilled in the art. Launch system embodiments of the present invention that lift payload bodies from other planets and/or other space bodies may require embodiments of the present invention to produce accelerations that are greater or less than 9.8 m/s².

Hovering Systems:

Embodiments of the present invention produce accelerations which exceed 9.8 m/s² on a body. Said embodiments are operated at an acceleration which exactly counterbalances gravitational forces on said body and cause said body to hover in a stationary position. The hovering of said body serves a variety of useful applications including, but not limited to: construction, observation, entertainment, and storage. Hovering within the gravitational fields of other planets or space bodies may require embodiments of the present invention to produce accelerations other than 9.8 m/s² to achieve hovering.

Energy Harvesting:

The energy imbalance created by embodiments of the present invention (differential between energy input by the EM wave and the kinetic energy of the vehicle with respect to an initial inertial reference frame) is extracted for useful purposes. A variety of configurations of embodiments of the present invention are used to produce energy. Embodiments include, but are not limited to:
a) Linear systems where embodiments of the present invention raise the potential energy of a mass. Said mass then falls through the potential field and useful energy is extracted.
b) Linear systems where embodiments of the present invention propel a body. Kinetic energy of the body is converted into useful energy.
c) Rotational systems where embodiments of the present invention produce useful energy. Useful energy is extracted from a rotating body and said rotating body is propelled by an embodiment of the present invention.

The unbalanced forces generated by embodiments of the present invention create energy imbalances between energy input to create the unbalanced force on the embodiment, and kinetic energy of a body propelled by the embodiment. The kinetic energy generated by operation of the embodiment is linear and/or rotational kinetic energy. The difference between energy input to the embodiment of the present invention and the kinetic energy of a body propelled by the embodiment is proportional to the square of the velocity (linear and/or angular) of the propelled body. Maximum energy extraction from embodiments of the present invention occur at the highest practical linear and/or rotational operating velocities of the embodiment (operating velocity is: the differential velocity between the embodiment velocity and the reference frame velocity of the energy extraction apparatus).

### An Exemplary Method of Propulsion According to the Present Invention

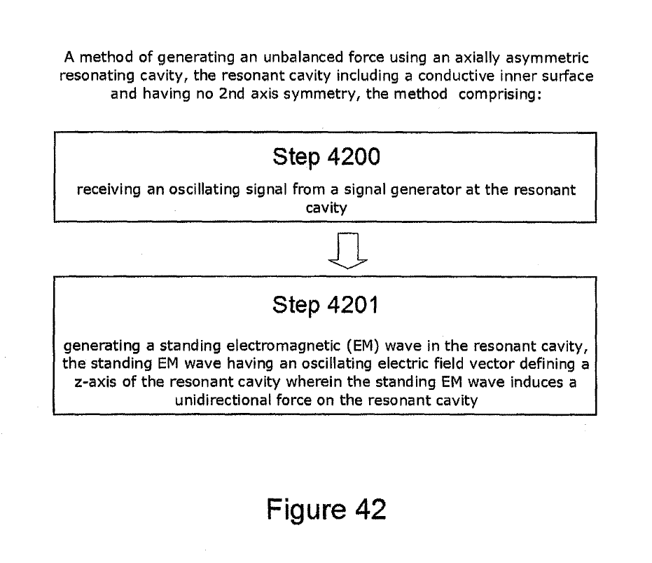

FIG. 42 depicts the steps of an exemplary method by which the present invention may generate and modulate Unidirectional Thrust.

The exemplary method proceeds as follows:

Step 4200: Power is Sent to a Resonant Cavity:

An axially-asymmetric resonant receives an oscillating signal from a signal generator.

Step 4201: Unidirectional Thrust is Induced by the EM Wave:

generating a standing electromagnetic (EM) wave in the resonant cavity, the standing EM wave having an oscillating electric field vector defining a z-axis of the resonant cavity wherein the standing EM wave induces a unidirectional force on the resonant cavity

The method further may include the following steps:

a) receiving a feedback signal from the resonant cavity and controlling the frequency generator to maintain the standing EM wave at a desired level.

b) cooling the resonant cavity to a predetermined temperature.

c) changing the orientation of the resonant cavity;

d) changing the shape of the resonant cavity;

### One Experimental Embodiment of the Present Invention

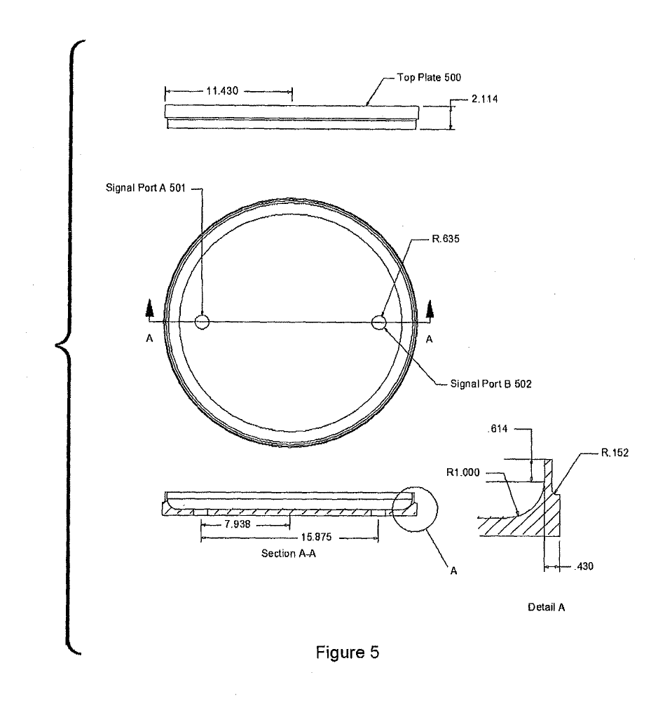

FIGS. 5,6,7,8,9,10, 11, and 12 depict one embodiment of the present invention. This embodiment of the present invention is a proof-of-concept model used for experimental demonstrations of a linear unbalanced force generated by embodiments of the present invention.

FIG. 5 depicts Top Plate 500. Top Plate 500 has 2 signal ports, Signal Port A 501 and Signal Port B 502.

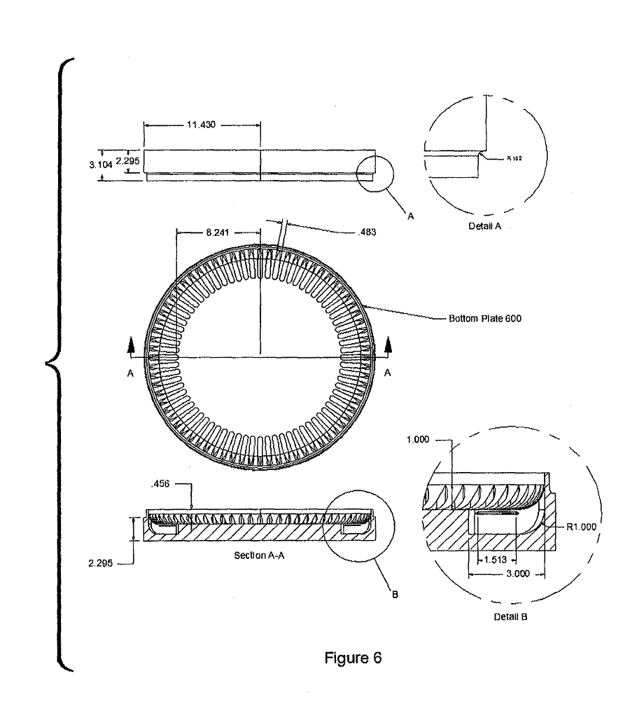

FIG. 6 depicts Bottom Plate 600. Bottom Plate 600 has 72 identical slots. One of said slots is depicted in Detail B of FIG. 6. The 72 slots of Bottom Plate 600 are axially-asymmetric features of Bottom Plate 600.

Top Plate 500 and Bottom Plate 600 are made of 250 RRR niobium. Top Plate 500 and Bottom Plate 600 are electron beam welded together along the equatorial wall of both plates. FIG. 7 depicts Resonating Cavity 700 which is formed by the union of Top Plate 500 and Bottom Plate 600. Resonating Cavity 700 is an axially and equatorially-asymmetric resonating cavity. When operated with a TM₀₁₀ EM wave Resonating Cavity 700 generates a linear unbalanced force that is parallel and coincident with the z-axis of Resonating Cavity 700.

The TM₀₁₀ operating frequency of Resonating Cavity 700 is approximately 1047 MHz. The TM₀₁₀ frequency of Resonating Cavity 700 changes during normal operation. The changes in frequency are due to cooling to liquid helium operating temperatures (which changes the cavity shape), and introduction of EM wave energy into Resonating Cavity 700 (which also changes the cavity shape due to Lorentz force detuning effects).

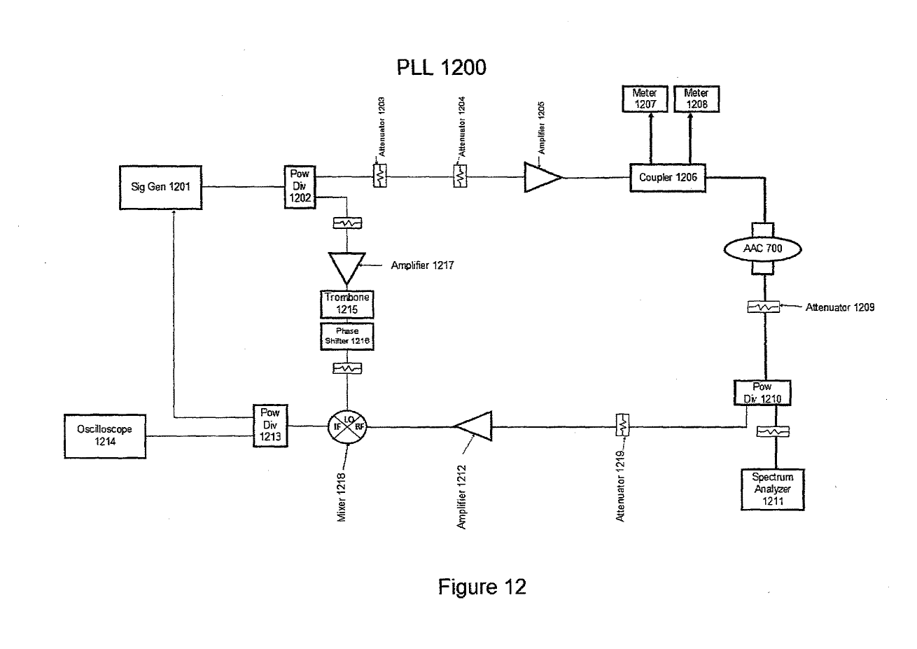

FIG. 12 depicts Phase Lock Loop Circuit 1200 (PLL 1200). PLL 1200 powers Resonating Cavity 700 with EM wave energy at the TM₀₁₀ operating frequency of Resonating Cavity 700. PLL 1200 maintains appropriate EM frequency during periods where Resonating Cavity 700 shifts in TM₀₁₀ frequency. PLL 1200 is capable of delivering up to 30 watts of power forward to Signal Cable 801. Signal Cable 801 is used to introduce EM wave energy into Resonating Cavity 700.

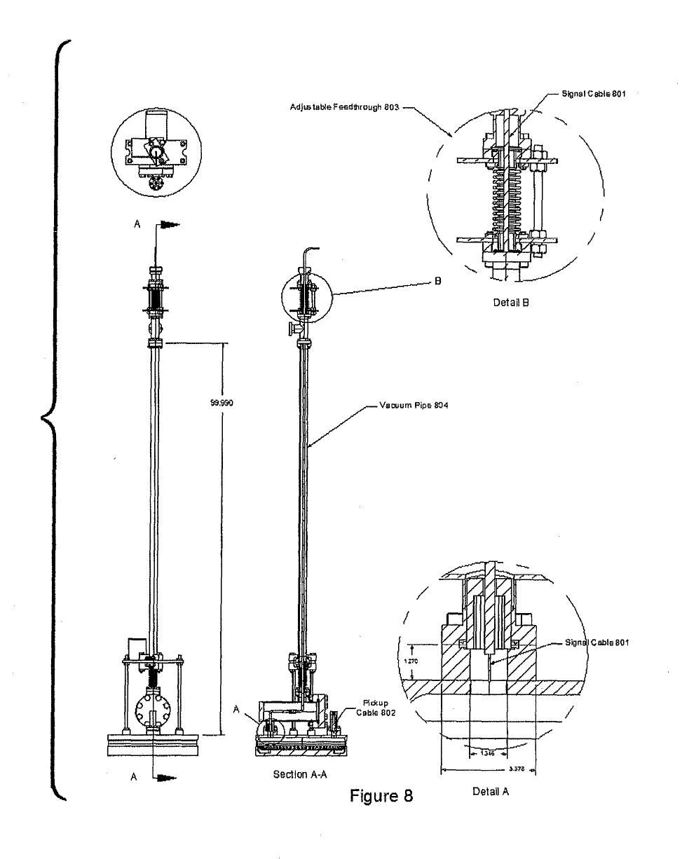

FIG. 8 depicts Resonating Cavity 700 attached to vacuum tubing, Signal Cable 801, and Pickup Cable 802. Signal Cable 801 is comprised of rigid coax cable. Signal Cable 801 is located at the axial center of Vacuum Pipe 804 and Signal Cable 801 passes through Adjustable Feedthrough 803.

Signal Cable 801 introduces EM wave energy into Resonating Cavity through Signal Port A 501. Adjustable Feedthrough 803 is compressed and expanded to control the position of Signal Cable 801 with respect to Resonating Cavity 700. Adjustments of the position of Signal Cable 801 are desirable during normal operation of Resonating Cavity 700 in order to break through multipacting barriers, and to position Signal Cable 801 at unity coupling or other desirable positions with respect to Resonating Cavity 700.

Pickup Cable 802 is attached to PLL 1200. Pickup Cable 802 is also coupled to Resonating Cavity 700 through Signal Port B 502. Pickup Cable 802 is weakly coupled to the EM fields that are present within Resonating Cavity 700 during normal operation.

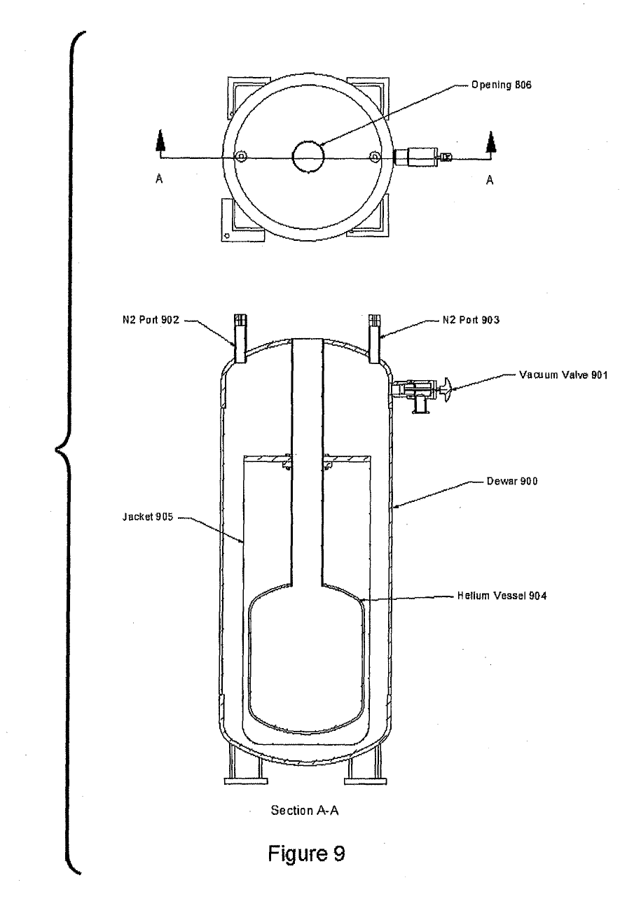

FIG. 9 depicts Dewar 900. Dewar 900 is capable of maintaining liquid helium within Helium Vessel 904. Heat transport into the helium bath contained within Helium Vessel 904 is approximately less than 2 watts. It is desirable to have zero heat transport into the helium bath through the walls and opening of Helium Vessel 904. Heat enters into the helium bath contained within Helium Vessel 904 during normal operation of Resonating Cavity 700 due to EM wave energy within Resonating Cavity 700 being dissipated as ohmic heating in the walls of Resonating Cavity 700. The heating in the walls of Resonating Cavity 700 is then transferred into the liquid helium bath contained within Helium Vessel 904.

Dewar 900 is comprised in part by Vacuum Valve 901. The volume located between the outer walls of Dewar 900 and the walls of Helium Vessel 904 is evacuated through Vacuum Valve 901 during normal operation of Resonating Cavity 700. Vacuum pressure within said volume during normal operation is approximately 0.003 Torre.

N2 Port 902 and N2 Port 903 are ports that allow liquid nitrogen to move through Jacket 905. Jacket 905 is a copper jacket that has copper piping welded to the copper sheeting of Jacket 905. Copper piping connects N2 Port 902 and N2 Port 903 to Jacket 905 and said copper piping is not depicted in FIG. 9.

Layers of cryogenic super insulation are wrapped around Helium Vessel 904 and said cryogenic super insulation is not depicted in FIG. 9.

Dewar designs with design features similar to Dewar 900 are known to those skilled in the art.

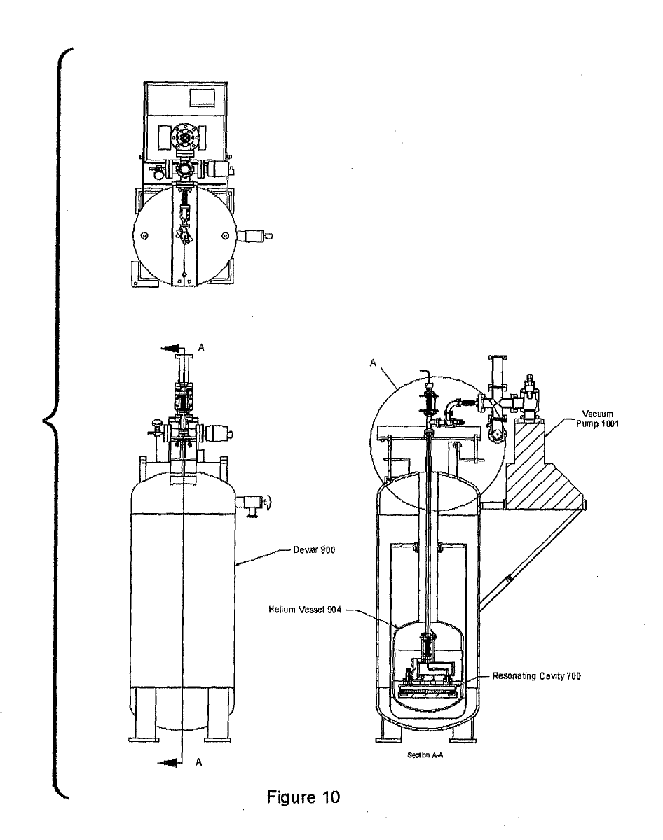

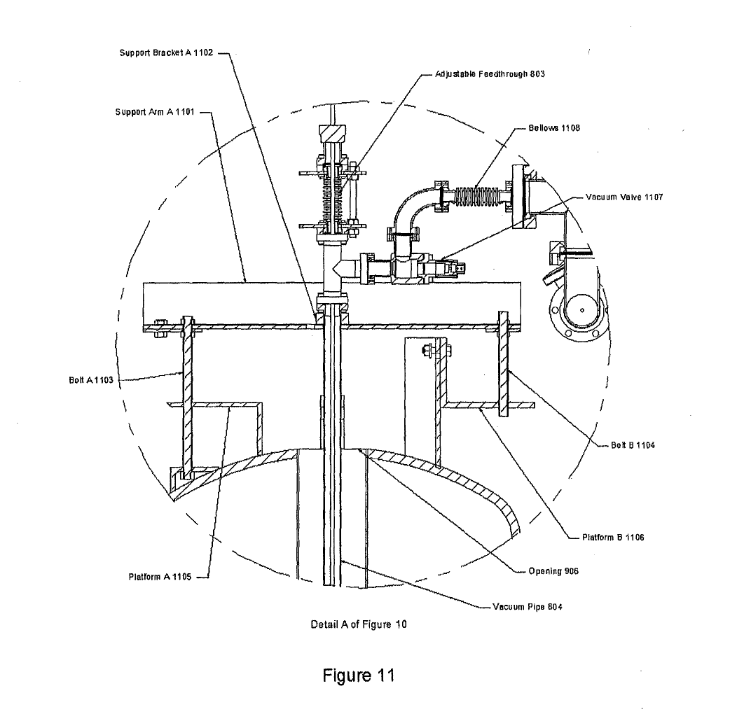

FIG. 10 depicts Resonating Cavity 700 and associated vacuum tubing and signal cables located within Dewar 900. FIG. 11 depicts a detail view of the top of Dewar 900 and parts associated with supporting Resonating Cavity 700 and attached vacuum piping.

Resonating Cavity 700 operates with a high vacuum that is typically in the range of approximately 1×10⁻⁸ Torre. Vacuum pump 1001 depicted in FIG. 10 is connected by vacuum piping to Resonating Cavity 700 and creates the high vacuum in Resonating Cavity 700.

Resonating Cavity 700 is comprised of Niobium and is operated below the critical superconducting temperature of Niobium. Liquid helium at atmospheric pressure has a temperature of 4.2 K. During experiments on Resonating Cavity 700, Opening 906 of Dewar 900 (Depicted in FIG. 11) is sealed with a clam-shell seal (not depicted in FIG. 11). With Opening 906 sealed, Helium Vessel 904 becomes vacuum sealed from atmospheric pressure. The pressure in Helium Vessel 904 is pumped down with a vacuum pump (not depicted). The reduction of pressure within Helium Vessel 904 causes helium to boil off of the liquid helium and causes the temperature of the liquid helium to drop.

Pressure in Helium Vessel 904 is approximately 50 Torre after pump down. Helium that remains in Helium Vessel 904 after vacuum pump down is cooler than 4.2 K. At 50 Torre, helium temperature in Helium Vessel 904 is approximately 2.3 K. After pump down to 50 Torre pressure in Helium Vessel 904, the clam-shell seal of Opening 906 is removed and atmospheric pressure returns to Helium Vessel 904. The helium remaining in Helium Vessel 904 remains at the 2.3 K and experiments are run on Resonating Cavity 700. Heat transfers from Resonating Cavity 700 to the liquid helium in Helium Vessel 904 does not create boiling of the liquid helium while the helium temperature within Helium Vessel 904 is below 4.2 K. Helium will not boil at atmospheric pressure until 4.2 K temperature is reached. Performance of the experiment with helium liquid at atmospheric pressure and below 4.2 K temperature prevents the effect of boiling helium from creating force changes on the load cells that support Resonating Cavity 700 and attached vacuum piping.

Support Arm 1101 of FIG. 11 supports Support Bracket A 1102. Support Bracket B 1102 is not depicted in FIG. 11 since it is not part of the Sectional View AA of FIG. 10. Support Brackets A 1102 and B 1102 support Vacuum Pipe 804. Vacuum Pipe 804 is connected to Resonating Cavity 700.

During normal operation of an experiment using Resonating Cavity 700, Support Arm 1101 is disconnected from Bolt A 1103 and from Bolt B 1104. Two identical load cells are placed to support Support Arm 1101. The load cells are not depicted in FIG. 10 or FIG. 11. One load cell is placed on Platform A 1105 and one load cell is placed on Platform B 1106.

During normal operation of an experiment using Resonating Cavity 700, Vacuum Valve 1107 is closed, sealing off the vacuum in Resonating Cavity 700. Bellows 1108 is disconnected from Turbopump Assembly 1001 and Bellows 1108 is disconnected from Vacuum Valve 1107.

With load cells in place on Platform A 1105 and Platform B 1106, the weight of Resonating Cavity 700 and attached vacuum piping is only supported by the load cells, and the liquid helium located in Helium Vessel 904. Signal Cable 801 and Pickup Cable 802 are mechanically connected to Resonating Cavity 700, but flexible portions of these cables (not depicted) are positioned so that negligible mechanical support is provided to Resonating Cavity 700.

The two load cells that support Support Arm 1101 are connected to a circuit that reads the load cell output. The load cells and the circuit that reads and stores load cell output is not depicted in the Figs. attached to the present application. The load cells and the circuit that reads and stores load cell output comprise the Force Measurement Circuit (FMC) of the present embodiment of the present invention.

The FMC measures the response of the weight of Resonating Cavity 700 to EM energy imparted to Resonating Cavity 700.

The Force Measurement Circuit is comprised of:

2 Cooper Instruments LFS 210-25 load Cells

1 Cooper Instruments XAA 911 Summing Unit

1 Cooper Instruments DCM 495 amplifier

1 Agilent 3411A 6 digit Multimeter

A laptop computer equipped with Microsoft Excel
1 2 Hz Filter
1 DC power supply
1 5000 uF capacitor.

The DC power coming from the DC power supply is sent through the 5000 uF capacitor to the amplifier. The summing unit sums the two signals coming from the two load cells. The amplifier sends the amplified signal from the summing unit to the multimeter. The multimeter sends time integrated readouts of the FMC to an Excel file where the FMC signal is charted and recorded.

Energy is injected through Signal Cable 801 into Resonating Cavity 700. A unidirectional force is created by the MFP mechanism on the embodiment of the present invention, Resonating Cavity 700. The unidirectional force generated by operation of a TM010 EM wave in Resonating Cavity 700 causes the pressure on the load cells of the FMC to be reduced. Said reduction in pressure is converted into a DC voltage reduction by the FMC, and that voltage reduction is charted and recorded in an Excel file.

The unidirectional force generated by operation of a TM₀₁₀ resonating EM wave in Resonating Cavity 700 reduces the voltage measured by the FMC. The PLL 1200 is operated in a pulsed mode during experiments on Resonating Cavity 700. EM energy is pulsed into Resonating Cavity 700 and this causes the unidirectional force generated by operation of the EM wave in Resonating Cavity 700 to be pulsed.

FIG. 12 depicts the Phase Lock Loop Circuit PLL 1200 that is used to power AAC 700 with EM energy. PLL 1200 controls input signal into AAC 700 and keeps the input signal locked to AAC 700's resonance frequency. The power level of the input signal is controlled using a variable voltage-controlled attenuator, Attenuator 1204.

PLL 1200 contains Sig Gen 1201 which is a radio frequency (RF) signal generator. Sig Gen 1201 which has an external frequency modulation (FM) input signal capability (approx. 1000 MHz). The RF signal generated by Sig Gen 1201 is split using a power divider, Pow Div 1202. One of the outputs created by Pow Div 1202 is sent through Attenuator 1203, Attenuator 1204 and then through Amplifier 1205. Amplifier 1205 is a 30 W amplifier. Attenuator 1204 is a voltage variable attenuator. Attenuator 1203 is a resistive attenuator.

The output from Amplifier 1205 is sent through Coupler 1206. Coupler 1206 is a dual directional coupler. A power meter is attached to each output of Coupler 1206. Power Meter 1207 reads power reflected from AAC 700 and Power Meter 1208 reads power forward into AAC 700. The difference of forward power minus reflected power represents the signal level into AAC 700.

The 2^{nd} output from Pow Div 1202 is a reference frequency signal used to detect the phase difference between the AAC 700 signal input level and AAC 700 signal output level. The corresponding output voltage is adjusted via the phase shifting network (Trombone Line 1215 and Phase Shifter 1216) until the Mixer 1218 output voltage is zero. Mixer 1218 voltage is zero when the input signal and output signal into AAC 700 are equal and the EM wave energy into AAC 700 is in phase lock with the resonant frequency of AAC 700.

The output signal of AAC 700 is split using Pow Div 1210 which is a power divider. Spectrum Analyzer 1211 is connected to one leg of Pow Div 1210 output. Pow Div 1210 is used to measure the output signal from AAC 700 in real time for cavity decay/Q measurements and for cavity output power measurement. The other Pow Div 1210 output provides the input signal to Mixer 1218 for frequency/phase error measurement. The input signal to Mixer 1218 is adjusted via Attenuator 1219 (a resistive attenuator) and/or Amplifier 1212 to ensure operation within Mixer 1218's linear range (typically ≦+3 dBm). The output of Mixer 1218 is split by Pow Div 1213. One output from Pow Div 1213 is monitored using Oscilloscope 1214. The other output of Pow Div 1213 is connected to the input of Sig Gen 1201 and provides fine-frequency control of Sig Gen 1201 output.

Oscilloscope 1214 is used to monitor PLL 1200 phase lock status, (AAC 700's input and output frequency are identical). Phase Shifter 1216 is adjusted until Oscilloscope 1214 reads zero voltage indicating phase lock of the input signal with the TM010 resonant frequency of AAC 700.

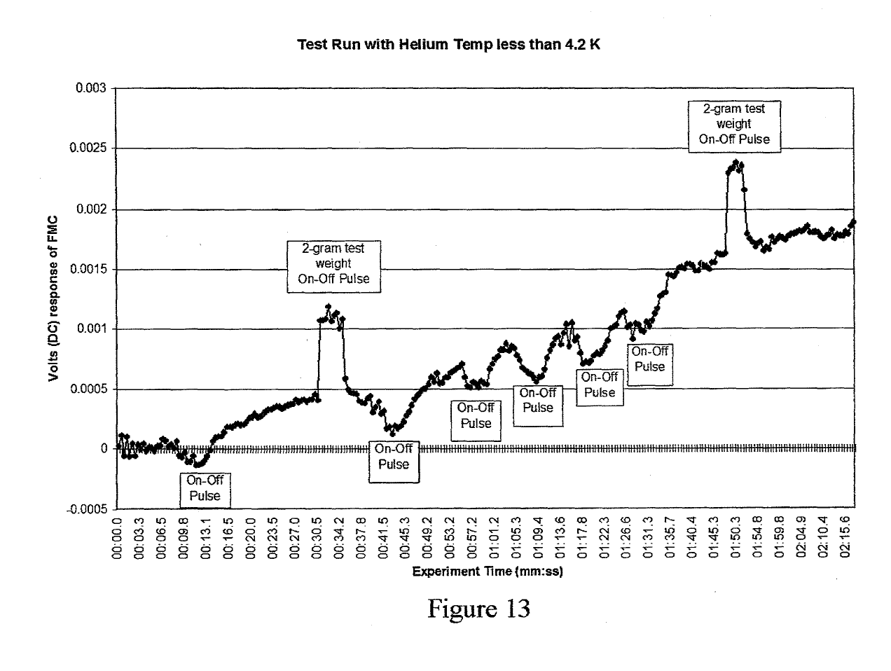

FIGS. 13, 14 and 15 are charts of the FMC output from 3 separate experiments on the embodiment of the present invention depicted in FIG. 7. Charts 13, 14, and 15 were generated on three separate test days. The output voltage of the multimeter is nulled prior to the creation of the charts depicted in FIGS. 13, 14, and 15. The null value is approximately 4.3 volts.

FIG. 13 depicts the output of an experiment on Resonating Cavity 700 in the experimental configuration of FIG. 10 with helium that was cooled below 4.2 K. Approximately 73 minutes after returning the helium in Helium Vessel 804 to atmospheric pressure from a vacuum pressure of 50 Torre, the chart of FIG. 13 was generated.

FIG. 13 depicts 6 power pulses of EM energy into Resonating Cavity 700 and 2 calibration pulses. The calibration pulses consist of adding a 2 gram calibrated weight to the top of Support Arm 1101 and then removing the weight from Support Arm 1101. The EM pulses consist of turning on PLL 1200 for approximately 4-5 seconds and then turning off PLL 1200. The power levels into Resonating Cavity during these pulses was approximately 10.5 watts.

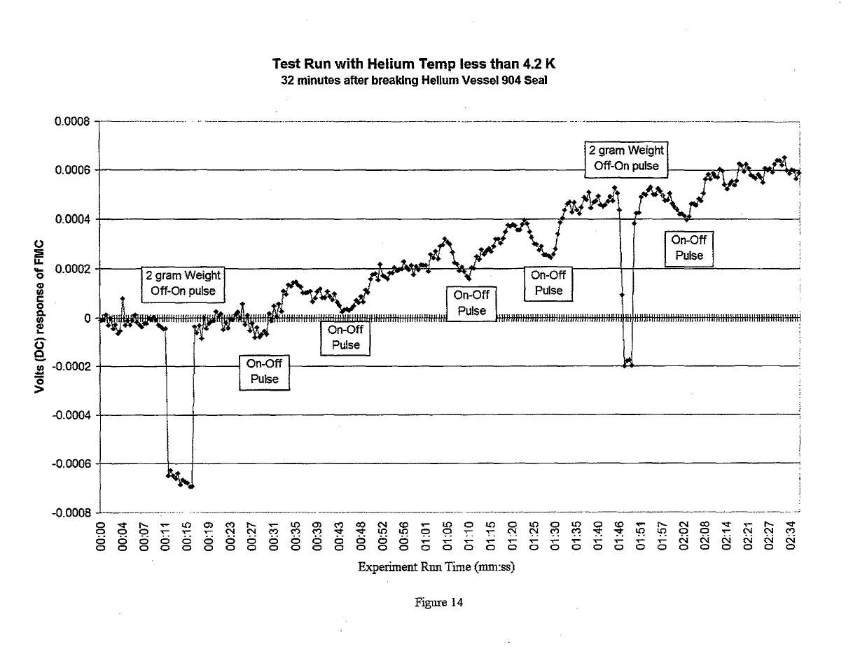

FIG. 14 depicts the output of an experiment on Resonating Cavity 700 in the experimental configuration of FIG. 10 with helium that was cooled below 4.2 K. Approximately 32 minutes after returning the helium in Helium Vessel 904 to atmospheric pressure from a vacuum pressure of 50 Torre, the chart of FIG. 14 was generated.

FIG. 14 depicts 5 power pulses of EM energy into Resonating Cavity 700 and 2 calibration pulses. The calibration pulses consist of removing a 2 gram calibrated weight from the top of Support Arm 1101 and then adding back the calibrated weight to Support Arm 1101. The EM pulses consist of turning on PLL 1200 for approximately 4-5 seconds and then turning off PLL 1200. The power levels into Resonating Cavity 700 during these pulses was approximately 11 watts.

The power pulse responses depicted in FIG. 14 are lower in magnitude than the power pulse responses depicted in FIG. 13. Prior to the experiment which generated FIG. 14, Resonating Cavity 700 was left for 2.5 days without Vacuum Pump 1001 attached. The test which generated the chart of FIG. 14 was done with higher vacuum pressure inside of Resonating Cavity 700.

After approximately 55 minutes from the time that the clam-shell seal was broken on Helium Vessel 904 (FIG. 14 created 32 minutes after breaking this seal) to bring Helium Vessel 904 up to atmospheric pressure, 11.5 watts of continuous EM wave energy was entered into Resonating Cavity 700. The purpose of this power was to demonstrate that the helium in Helium Vessel 904 was below 4.2 K temperature. 21 minutes of time elapsed with 11.5 watts of power dissipated in Resonating Cavity 700 prior to cloud being observed coming out of Opening 906 of Dewar 900. The appearance of cloud coming out of Opening 906 occurs when helium boils in Helium Vessel 904. The chart in FIG. 14 was created while the helium in Helium Vessel 804 was below 4.2 K.

The chart of FIG. 13 was generated on a separate day than the chart of FIG. 14. Both experiments were run under similar operating conditions. The chart of FIG. 13 was created at approximately 73 minutes after breaking of the clam-shell seal on Opening 906. Both tests were performed after the helium in Helium Vessel 904 was brought down to a pressure of 50 Torre. Because of the large amount of energy required to bring the helium of Helium Vessel 904 to boiling temperature on the test day when the chart of FIG. 14 was created, the chart of FIG. 13 was also created while the helium in Helium Vessel 904 was below 4.2 K.

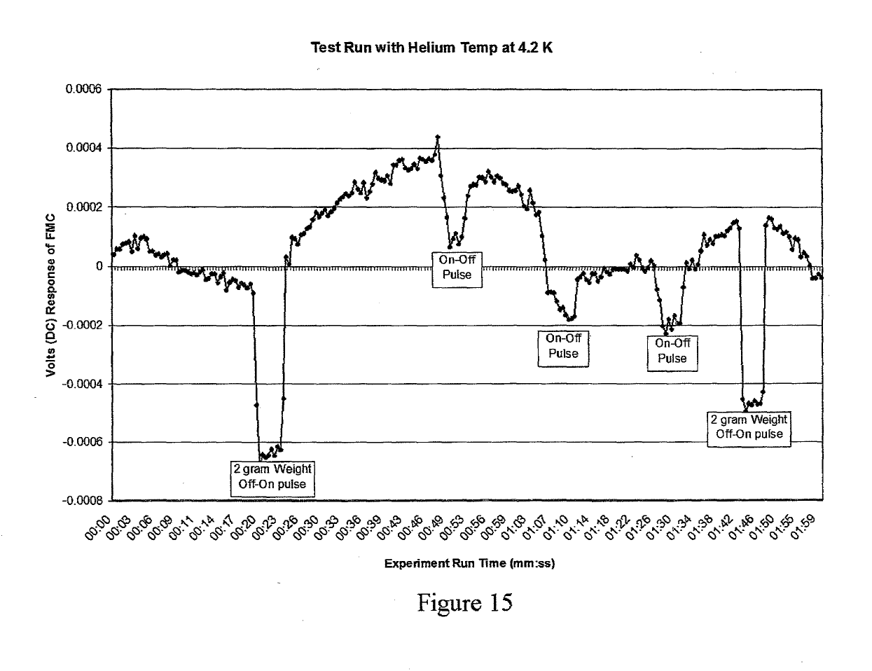

FIG. 15 depicts the output of an experiment on Resonating Cavity 700 in the experimental configuration of FIG. 10 with helium that was at 4.2 K.

FIG. 15 depicts 3 power pulses of EM energy into Resonating Cavity 700 and 2 calibration pulses. The calibration pulses consist of removing a 2 gram calibrated weight from the top of Support Arm 1101 and then adding back the calibrated weight to Support Arm 1101. The EM pulses consist of turning on PLL 1200 for approximately 4-5 seconds and then turning off PLL 1200. The power levels into Resonating Cavity 700 during these pulses was approximately 10.5 watts.

Additional experiments were run on the experimental apparatus including an experiment that sent approximately 25 watts of EM wave energy forward to Resonating Cavity 700. The EM wave energy was sent without proper phase lock. Almost all of the forward power was reflected, and almost zero power went into the fields of the EM wave inside of Resonating Cavity 700. No response from the FMC was recorded. This test was done to determine if any cross chatter was occurring between the FMC and PLL 1200.

Conclusion:

The charts of FIGS. 13, 14, and 15 demonstrate a removal of compressive force from the 2 load cells of the FMC. The pulse cycles of removal of compressive force from the FMC coincide with the introduction of EM wave energy into Resonating Cavity 700. The charts of FIGS. 13 and 14 were created while the helium in Helium Vessel 904 was below helium atmospheric boiling temperature of 4.2 K. Boiling helium did not create the FMC responses recorded in the charts of FIGS. 13 and 14. The charts in FIGS. 13, 14, and 15 demonstrate the creation of a linear unbalanced force by operation of a TM₀₁₀ resonating EM wave within Resonating Cavity 700.

### Numerical Analysis of AAC 700

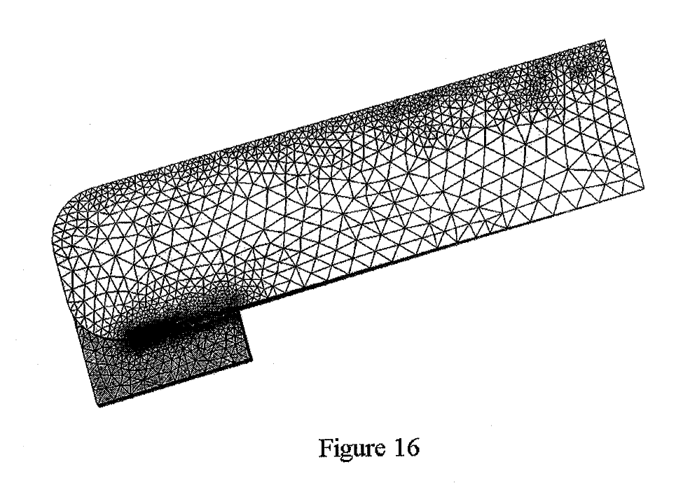

FIGS. 16, 17, 18, 19, 20, 21, 22, and 23 are generated from numerical and theoretical predictions about performance levels for Resonating Cavity 700. Two numerical method 3-D electromagnetic field modeling software programs were used to analyze the design of Resonating Cavity 700. Those programs are HFSS and Analyst.

FIG. 16 is a screen shot of the mesh from an analysis of Resonating Cavity 700 using the software program Analyst. The meshed shape in FIG. 16 represents 1/144 of Resonating Cavity 700. Analysis of this slice of the vacuum space within Resonating Cavity 700 was used to generate data on the theoretical performance levels of Resonating Cavity 700.

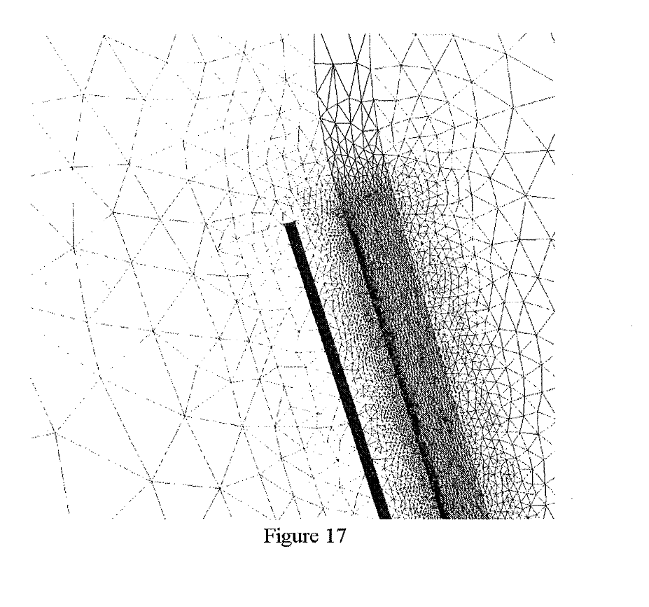

FIG. 17 is a close-up view of the area on FIG. 16 where a slot and bridge meet in the design of Resonating Cavity 700. The minimum mesh size on this view is 0.04 mm. Software analysis on this segment was also done with minimum mesh size of 0.02 mm, but these views could not be displayed by the video card on the computer used for the analysis work.

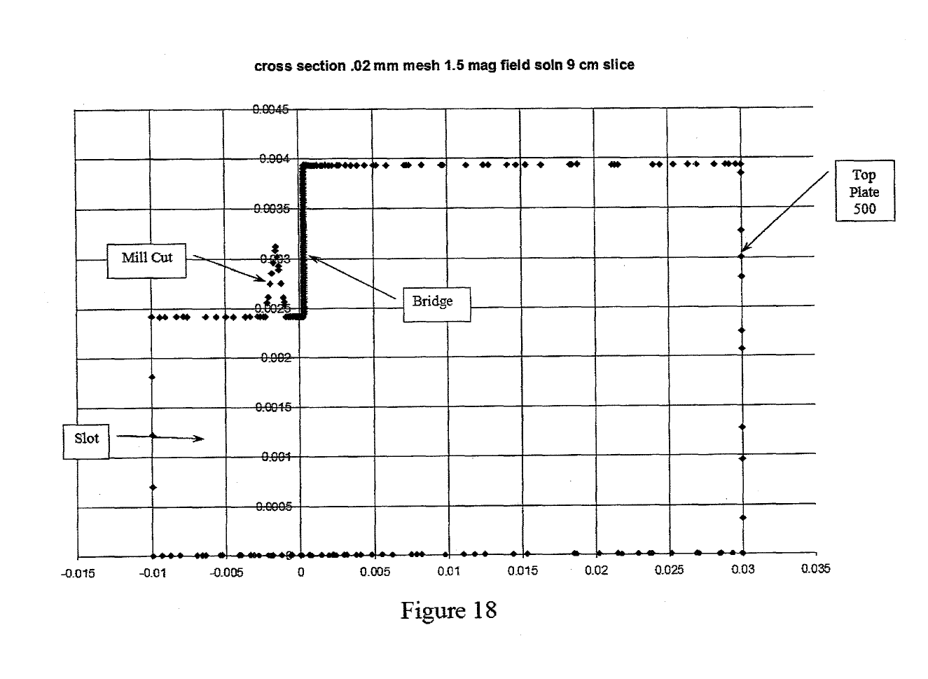

FIG. 18 is an Excel graph of the data points generated by a 0.02 mm mesh of the bridge of FIG. 17. FIG. 18 shows the tight meshing of data points on and near the bridge. Postprocessing of the data generated by Analyst was done in Microsoft Excel.

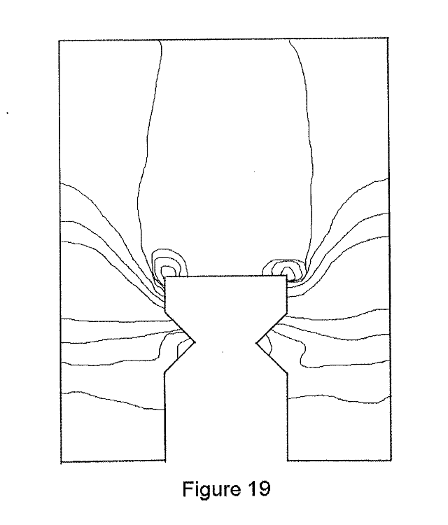

FIG. 19 depicts a planar cross-sectional view (at r=0.0875 m from axial center of Resonating Cavity 700) of a bridge of Resonating Cavity 700 along with ½ of two slots on either side of said bridge. The colored areas around the bridge depict the magnetic field strength in the vacuum area surrounding the bridge. Magnetic fields that interface with the niobium surfaces of Resonating Cavity 700 only create z-directed forces when said niobium surfaces have a component of the surface which is parallel to the x-y plane. FIG. 19 shows that some of the magnetic field energy of the EM wave that interacts with Bottom Plate 600 interacts with vertical wall surfaces and these interactions create no z-directed forces.

FIG. 19 also shows that some EM magnetic field energy interacts with Bottom Plate 600 to create positive z-directed forces. The positive z-directed forces on Bottom Plate 600 generated by the MFP mechanism occur on the upper portion of the mill cut that is present on the slot walls.

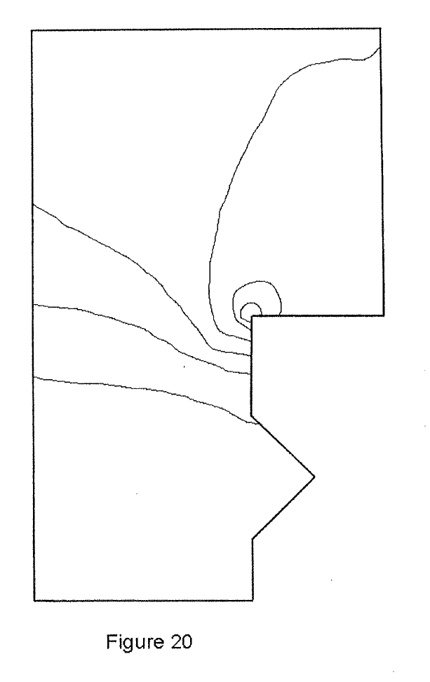

FIG. 20 depicts ½ of a bridge and ½ of a slot of Bottom Plate 600 at a planar cross section of Resonating Cavity 700. The plane is 0.09 m from the axial center of Resonating Cavity 700. Numerical analysis was performed on the ½ slot/½ bridge section to decrease the mesh size of the cavity section and increase the accuracy of the numerical analysis of Resonating Cavity 700. FIG. 20 also shows the magnetic field intensity of the EM wave at points in the vacuum space surrounding the ½ bridge section and the ½ slot section.

FIG. 20 shows that some EM magnetic field energy interacts with the walls of Bottom Plate 600 in a way that creates no z-directed forces. All EM magnetic field energy interacting with Top Plate 500 above the area of the bridges and slots of Resonating Cavity 700 creates positive z-directed forces (except for small non-z-directed forces on vertical walls inside of Signal Ports 501 A and 502 B).

A variety of numerical analyses were performed on the design of Resonating Cavity 700 using the software programs HFSS and Analyst. The results of the numerical analyses showed that the differential in the time-averaged-net z-directed pressure from the MFP mechanism acting in Resonating Cavity 700 is approximately 9-%. This means that for every 1 mN of force in the positive z-direction on Top Plate 500 (over the area of the slots and bridges on Bottom Plate 600) due to magnetic field EM energy, 0.89-0.91 mN exists in the negative z-direction on Bottom Plate 600 (in the area of Bottom Plate 600 at the slots and bridges). Net time averaged z-directed forces on Resonating Cavity 700 are approximately 0.09 mN for every mN of force exerted by the magnetic field of the EM wave on areas of Top Plate 500 over the area of the slot and bridges of Bottom Plate 600.

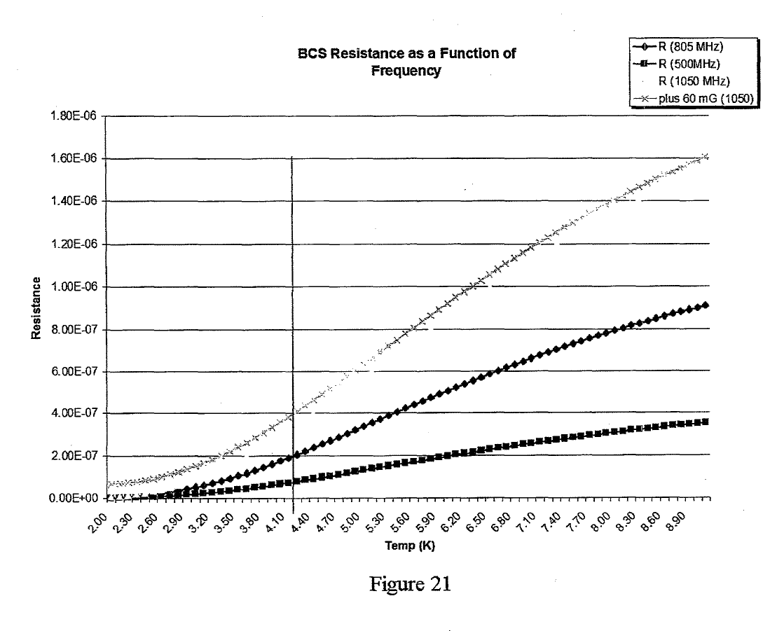

FIG. 21 depicts the superconducting niobium AC resistance at various temperatures for several AC EM wave operating frequencies. Resonating Cavity 700 has an operating frequency of approximately 1047 MHz. The triangular data points on FIG. 21 depict the AC superconducting resistance at 1050 MHz for niobium at various temperatures. The x data points of FIG. 21 depict the superconducting resistance at 1050 MHz for niobium at various temperatures with the addition of resistance effects due to the magnetic field of Earth interacting with the niobium. The test apparatus of Resonating Cavity 700 has no mu metal included in Dewar 900, so Resonating Cavity 700 is not shielded from the Earth's magnetic field.

FIG. 21 shows that at 4.2 K, the niobium of Resonating Cavity 700 has a calculated resistance of approximately 4 E-7 ohms. At 2.3 K the niobium of Resonating Cavity 700 has a calculated resistance of approximately 8 E-8 ohms.

FIG. 22 depicts the Q of Resonating Cavity 700 as a function of niobium resistance for Resonating Cavity 700 and as a function of the geometry factor of Resonating Cavity 700. Numerical analysis of Resonating Cavity 700 predict a geometry factor of approximately 100 ohms for Resonating Cavity 700. Numerical analysis of Resonating Cavity 700 was performed by modeling a 90 degree sharp corner at the interface of the bridges and slots of Bottom Plate 600. In the manufacture of Resonating Cavity 700, 2 chemical acid etches were done to remove approximately 100 microns of niobium per chemical etch. The chemical etch of Resonating Cavity 700 rounded the corners where the slots and bridges of Bottom Plate 600 meet. The actual geometry factor of Resonating Cavity 700 likely exceeds 100 ohms due to chemical etching and rounding of the slot/bridge edges.

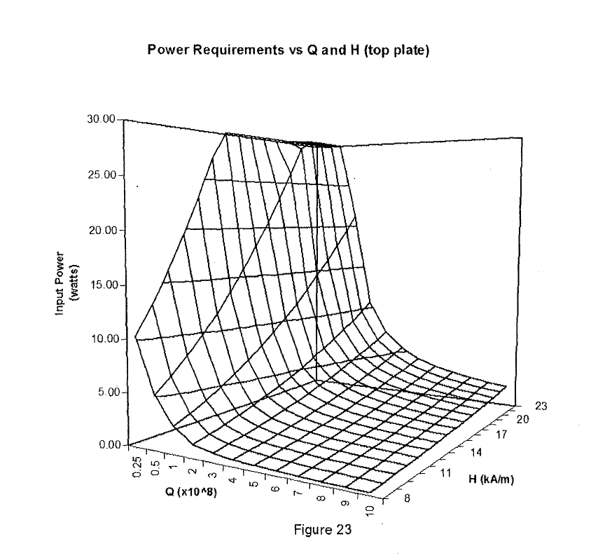

FIG. 23. depicts the power requirements of Resonating Cavity 700 as a function of Resonating Cavity 700 Q and desired surface current strength on Top Plate 500 (AC surface current strength is over the areas of the slots and bridges of Bottom Plate 600). The data used to create the chart of FIG. 23 is located in FIG. 24 which is a Microsoft Excel spreadsheet of predicted performance of Resonating Cavity 700 based on numerical analysis. Many of the data points of FIG. 24 are extrapolated.

### An Exemplary Embodiment

FIGS. 1, 2, 3, and 4 depict an exemplary embodiment of the present invention.

FIG. 1 is a top view and a sectional side view of AAC 100. AAC 100 is comprised of the union of Top Plate 102 and Bottom Plate 101.

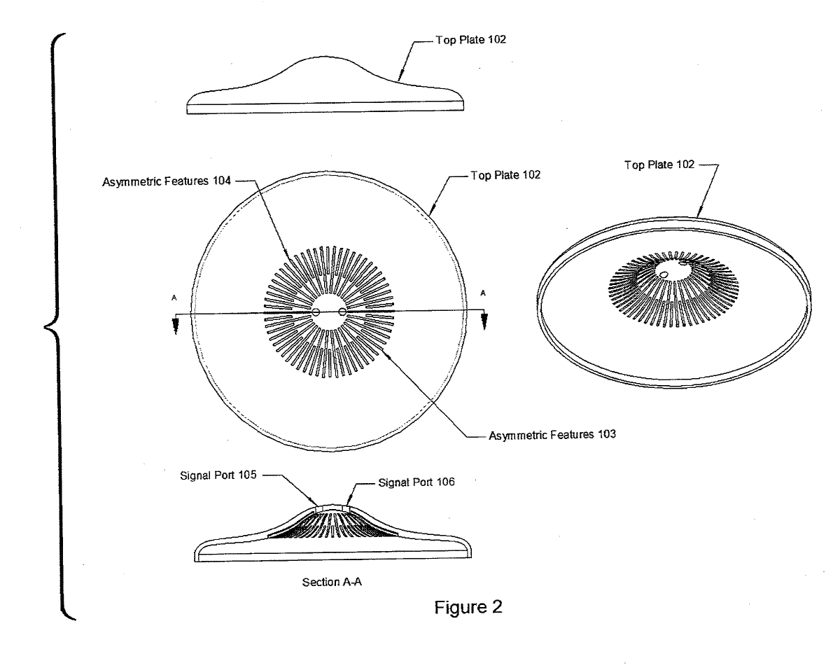

FIG. 2 depicts a bottom-view, a side-view, a perspective view, and a sectional-side view of Top Plate 102.

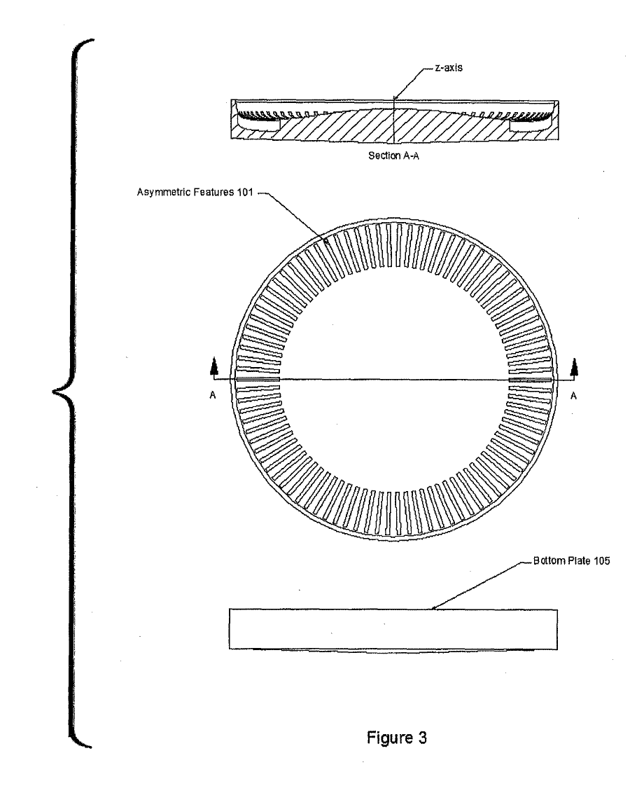

FIG. 3 depicts a top-view, a side-view, and a sectional-side view of Bottom Plate 101.

FIG. 4 depicts the configuration of the exemplary embodiment. In FIG. 4; Housing Unit 400 is connected to Power Unit 401. Power Unit 401 supplies power to Signal Unit 403, Central Control Unit 402, and Cooling Unit 405. Signal unit 403, Central Control Unit 402, and Cooling Unit 405 are connected to Housing 400. Signal Unit 403 provides EM wave energy to AAC 100. AAC 100 is contained within Cooling Unit 405 and Cooling Unit 405 is attached to Housing 400.

System Operation: Power Unit 401 provides power to Signal Unit 403. Signal Unit 403 creates a 200 MHz electromagnetic wave that is transferred through a signal cable to AAC 100. Within AAC 100, the EM wave energy provided by Signal Unit 403 establishes a TM₀₁₀ resonating EM wave with a 200 MHz frequency. Signal Unit 403 maintains resonant EM wave energy in AAC 100 by utilization of a phase lock loop circuit that is contained by Signal Unit 403. Signal Unit 403 modulates the power level of the EM wave energy sent into AAC 100

Cooling Unit 405 draws power from Power Unit 401. Cooling Unit 405 contains a cooling dewar which surrounds AAC 100. Cooling Unit 405 circulates liquid helium throughout the Cooling Unit 405 cooling dewar. Cooling Unit 405 maintains the temperature of AAC 100 at or below 5 K. Cooling Unit 405 also contains a refrigeration unit which expels heat from helium vapor for the purpose of converting helium vapor into helium liquid. Cooling Unit 405 also is comprised of a 3 axis gimbals assembly which reorients the orientation of the x-y plane of AAC 100 with respect to Housing 400.

Cooling Unit 405 is capable of maintaining heat transfer into the helium bath within Cooling Unit 405 at less than 1 watt. Cooling Unit 405 is capable of removing up to 20 watts of energy from the helium bath that surrounds AAC 100.

Central Control Unit 402 may contain an industry standard feedback control device that modulates Cooling Unit 405 operation and Signal Unit 403 operation. Central Control Unit 402 controls:
Temperature of AAC 100 by modulation of power to Cooling Unit 405.
Power levels from Signal Unit 403 to AAC 100 for the purpose of control of the magnitude of unbalanced force generation by EM wave energy interacting with AAC 100.
A Orientation of Cooling Unit 405 for the purpose of control of the direction of the unbalanced force vector generated by EM wave energy interacting with AAC 100.

Central Control Unit 402 also contains 3 laser gyroscopes. The laser gyroscopes are used to measure the accelerations of housing 400. Central Control Unit 402 utilizes a feedback control loop to control the position, orientation and thrust direction of Housing 400 and all parts attached to housing 400. The feedback control loop of Central Control Unit 402 uses the data provided by the three laser gyroscopes of Central Control Unit 402 to orient AAC 100 in a desirable direction (through control of Cooling Unit 405), and to power AAC 100 with EM energy sufficient to generate a desirable unbalanced force level (through control of Signal Unit 403).

### Superconducting Surfaces:

AAC 100 is operated at 5 K. The inner conducting surface of AAC 100 is comprised of a Niobium Tin alloy. The substrate Niobium Tin layer is located as a thin film on a niobium base. A variety of techniques of manufacture for resonating cavities comprised with Niobium Tin conducting surfaces are known to those skilled in the art.

A variety of other materials may be used for the superconductor layer, a buffer layer and, the substrate layer. For example, the superconducting layer may include a number of different materials such as HgBa₂Ca₂₂Cu₃0₈; niobium; Tl₂Ba₂CaCu₂O₈; NbSn alloys; Type I superconductors; or Type II superconductors, the buffer layer may include materials such as Ag on MgO; LaAlO₃; Gd₂O₃; or LSAT (a solid solution of LaAlO₃ and Sr₂AlTaO₆), and the substrate layer may include a number of materials such as copper; steel; aluminum; or titanium. These lists are not intended to be limiting and a number of other materials known to those skilled in the art may be used as well. Further it is noted that the use of the buffer layer and the substrate is not necessary when using a superconductor that may be manufactured without the need for a buffer layer or substrate layer. For example, resonating cavities and superconducting devices made of pure Niobium, or other Type I or Type II superconductors are known.

In this exemplary embodiment, AAC 100 is desirably a completely sealed cavity with an internal diameter along the wave resonating axis of approximately 0.68 meters giving AAC 100 a TM₀₁₀ operating frequency of 200 MHz. The inside surfaces of the cavity may be covered in Niobium Tin and the outside of the cavity is made of niobium. Heat transfer from AAC 100 to the liquid helium circulating within the cooling dewar of Cooling Unit 405 occurs at the niobium wall, helium liquid interface. AAC 100 is operated with a vacuum on the inside, and with a liquid helium blanket on the outside. The mechanical connections of Cooling Unit 405 to AAC 100 walls are desirably made of insulating materials to minimize heat migration into AAC 100. A variety of materials may be used and these materials are known to those skilled in the art.

Cooling Unit: During normal system operation, heat is generated in the walls of AAC 100. In order to provide continuous or pulsed thrusting, heat is desirably removed from AAC 100. A variety of techniques known to one skilled in the art are available to remove heat from the devices mentioned. In an exemplary embodiment, liquid helium may cool the outside walls of AAC 100.

A variety of other Cooling Unit 405 configurations are possible and are known to those skilled in the art. These alternative configurations for Cooling Unit 405 may be configured to remove heat from the system according to the specifications that the system maintains the operating temperature of all superconducting materials below the critical temperature of the superconductor. Some cooling systems that may also be used to maintain system operating temperatures include: a Peltier cooling element, a dilution refrigerator, a vapor-compression refrigerator, a reverse turbo-Brayton cooler, a sorption cooler, a cryogenic cooling element, a Stirling cooling element, a pulse tube cooling element, a Joule-Thompson cooling element, a reverse Brayton cooler, or a magnetic cooler.

Signal Unit 403: The system may desirably utilize a low noise high quality quartz master reference oscillator (MRO) as the frequency source. The inherent characteristics of the quartz crystal provide the high stability and precision frequency desired to maximize the efficiency of exemplary embodiments of the present invention. The MRO may provide a frequency output of 200 MHz at a power output level of 3 watts while consuming less than 30 W of DC power. The MRO may be packaged in an aluminum housing with a volume of approximately 100 in³ and weighing less than three pounds. The crystal may be housed within an oven to minimize frequency drift versus changes in temperature. Signal Unit 403 also utilizes a power amplifier which is capable of amplifying the signal from the MRO to a power level of 50 watts. Signal Unit 403 desirably provides all power conditioning necessary to maintain up to 50 watts of 200 MHz EM wave energy into AAC 100

Power Unit 401: The exemplary embodiment desirably uses power industry standard photovoltaic cells used in space applications. The total power requirement for operation of the exemplary embodiment is desirably less than 2000 watts at 160 Volts DC to operate both the Signal Unit 403 and the Cooling Unit 405. However it is noted that other power sources, such as nuclear power sources, fuel cells, and batteries, may be used as well.

AAC 100: Operation of a TM₀₁₀ EM wave within AAC 100 generates a linear time-averaged (over 180 degrees of wave cycle) unbalanced force in the positive z-direction. The EM wave interacting with AAC 100 utilizes both the EFP and MFP mechanisms of the present invention to generate an unbalanced Lorentz force. The embodiment depicted in FIG. 4 is used to generate unbalanced thrust. When deployed on a space vehicle, the embodiment of FIG. 4 is operated as a propulsion system which thrusts said space vehicle without the use of reaction mass.

Although the invention is illustrated and described herein with reference to specific embodiments, it is not intended to be limited to the details shown. Rather, various modifications may be made in the details within the scope and range of equivalents of the claims and without departing from the invention. In particular, one skilled in the art may understand that many features of the various specifically illustrated embodiments may be mixed to form additional exemplary thruster systems and methods also embodied by the present invention.

What is claimed:

1. An electromagnetic thrusting system comprising:
an axially-asymmetric resonant cavity including a conductive inner surface, the resonant cavity adapted to support a standing electromagnetic (EM) wave therein, the standing EM wave having an oscillating electric field vector defining a z-axis of the resonant cavity;
wherein the resonating cavity lacks 2nd-axis axial symmetry, and
wherein the standing EM wave induces a net unidirectional force on the resonant cavity.

2. An electromagnetic thrusting system according to claim 1, wherein the axially-asymmetric resonant cavity is equatorially asymmetric.

3. An electromagnetic thrusting system according to claim 1, wherein the axially-asymmetric resonant cavity is equatorially symmetric.

4. An electromagnetic thrusting system according to claim 1, further comprising one or more signal ports configured to receive signals from a signal generator.

5. An electromagnetic thrusting system according to claim 1, wherein the EM wave within the resonant cavity has an operating frequency that is greater than about 1 MHz and less than about 50 GHz.

6. An electromagnetic thrusting system according to claim 1, wherein the conductive inner surface of the resonant cavity includes at least one of Lithium, Sodium, Potassium, Beryllium, Magnesium, Calcium, Strontium, Barium, Radium, Zinc, Molybdenum, Cadmium, Titanium, Vanadium, Chromium, Manganese, Iron, Cobalt, Nickel, Copper, Yttrium, Zirconium, Niobium, Palladium, Silver, Tantalum, Tungsten, Rhenium, Osmium, Iridium, Platinum, Gold, Mercury, Aluminium, Gallium, Indium, Tin, Thallium, Lead, and Bismuth.

7. An electromagnetic thrusting system according to claim 1, wherein a cross-section of the conductive inner surface of the resonant cavity parallel to the x-y plane of the standing EM wave is substantially circular.

8. An electromagnetic thrusting system according to claim 7, wherein:
a lowest energy mode of the standing EM wave has only one electric field antinode in the x-y plane.

9. An electromagnetic thrusting system according to claim 1, wherein:
the standing EM wave has more than one electric field antinode in the x-y plane.

10. An electromagnetic thrusting system according to claim 1, wherein an interior volume of the resonant cavity is substantially evacuated.

11. An electromagnetic thrusting system according to claim 1, further comprising a cooling unit thermally coupled to the resonant cavity to maintain a temperature of the conductive inner surface of the resonant cavity below a predetermined temperature.

12) An electromagnetic thrusting system according to claim 11, wherein:
the conductive inner surface of the resonant cavity includes a superconducting material having a superconductor critical temperature T_{c}; and
the predetermined temperature is less than the superconductor critical temperature T_{c}.

13. An electromagnetic thrusting system according to claim 12, wherein the superconducting material comprises at least one of niobium, niobium titanium, MgB₂, YBCO, Bi₂Sr₂CuCu₂O₈, YaBaCuO, LaBaCuO, Nb₃Sn, TIBaCuO, La₂₋ₓBaₓCuO₄, La₂₋ₓSrₓCuO₄, PbMoS, V₃Ga, NbN, Nb₃Al, Nb₃(AlGe), Nb₃Ge, a type I superconductor, a type II superconductor, a ceramic superconductor, or a high temperature superconductor with T_{c} higher than 4 K degrees.

14. An electromagnetic thrusting system according to claim 11, wherein the cooling unit includes at least one of a radiative cooling element, a Peltier cooling element, a dilution refrigerator, a vapor-compression refrigerator, a reverse turbo-Brayton cooler, a sorption cooler, a cryogenic cooling element, a Stirling cooling element, a pulse tube cooling element, a Joule-Thompson cooling element, a reverse Brayton cooler, or a magnetic cooler.

15. An electromagnetic thrusting system according to claim 1, further comprising:
a housing mechanically coupled to the resonant cavity configured to hold and change an orientation of the resonant cavity; and
control circuitry electrically coupled to the housing to control the orientation of the z-axis of the resonant cavity.

16. An electromagnetic thrusting system according to claim 15, wherein the housing includes a 3-axis gimbal providing 6-axis control of the orientation of the z-axis of the resonant cavity.

17. An electromagnetic thrusting system according to claim 1, wherein:
the conductive inner surface comprises an adjustable surface, the adjustable surface being movable to change a shape of the axially-asymmetric resonant cavity.

18. An electromagnetic thrusting system according to claim 1:
wherein the net unidirectional force is substantially parallel to the z-axis.

19. An electromagnetic thrusting system according to claim 1:
wherein the net unidirectional force is substantially parallel to the x-y plane.

20. A method of generating an unbalanced force using an axially asymmetric resonating cavity, the resonant cavity including a conductive inner surface and having no 2nd-axis axial symmetry, the method comprising:
a) receiving an oscillating signal from a signal generator at the resonant cavity
b) generating a standing electromagnetic (EM) wave in the resonant cavity, the standing EM wave having an oscillating electric field vector defining a z-axis of the resonant cavity, wherein the standing EM wave induces a net unidirectional force on the resonant cavity.

21. A method according to claim 20, further comprising the step of generating the oscillating signal using the signal generator

22. A method according to claim 21, further comprising the steps of receiving a feedback signal from the resonant cavity and controlling the signal generator to maintain the standing EM wave at a desired level based on the feedback signal from the resonant cavity.

23. A method according to claim 20, further comprising the step of cooling the resonant cavity to a predetermined temperature.

24. A method according to claim 20, further comprising the step of changing the orientation of the resonant cavity.

25. A method according to claim 20, further comprising the step of changing the shape of the resonant cavity.

26. An electromagnetic thrusting system comprising:
a resonant cavity including a conductive inner surface, the resonant cavity adapted to support a standing electromagnetic (EM) wave therein, the standing EM wave having an oscillating electric field vector defining a z-axis of the resonant cavity;
the resonant cavity including one or more signal ports configured to receive signals from a signal generator, the signal ports having a shape and location on the resonant cavity such that the standing EM wave induces a net unidirectional force on the resonant cavity.
